(19) United States
(12) Patent Application Publication
(10) Pub. No.: US 2016/0011691 A1
(43) Pub. Date: Jan. 14, 2016

(54) SENSOR DEVICE, INPUT DEVICE, AND ELECTRONIC APPARATUS

(71) Applicant: SONY CORPORATION, Tokyo (JP)

(72) Inventors: Shogo Shinkai, Kanagawa (JP); Kei Tsukamoto, Kanagawa (JP); Tomoko Katsuhara, Kanagawa (JP); Hiroto Kawaguchi, Kanagawa (JP); Hayato Hasegawa, Kanagawa (JP); Fumihiko lida, Kanagawa (JP); Takayuki Tanaka, Kanagawa (JP); Tomoaki Suzuki, Kanagawa (JP); Taizo Nishimura, Kanagawa (JP); Hiroshi Mizuno, Kanagawa (JP); Yasuyuki Abe, Kanagawa (JP)

(73) Assignee: SONY CORPORATION, Tokyo (JP)

(21) Appl. No.: 14/771,918

(22) PCT Filed: Feb. 6, 2014
(86) PCT No.: PCT/JP2014/000628

§ 371 Date: Sep. 1, 2015

(30) Foreign Application Priority Data
Mar. 13, 2013 (JP) 2013-050859
Sep. 11, 2013 (JP) 2013-188830

(51) Int. Cl. G06F 3/044

(52) U.S. Cl. CPC G06F 3/044; G06F 2203/04102

(57) ABSTRACT

[Object] To provide a sensor device capable of detecting an operation position and pressing force with high accuracy.

[Solution] A sensor device includes a first conductor layer having flexibility, a second conductor layer, an electrode substrate that is provided between the first conductor layer and the second conductor layer and has flexibility, a plurality of first structural bodies that separate the first conductor layer and the electrode substrate, and a plurality of second structural bodies that separate the electrode substrate and the second conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

### TECHNICAL FIELD

The present disclosure relates to a sensor device, an input device and an electronic apparatus, which are capable of electrostatically detecting an input operation.

### BACKGROUND ART

As a sensor device for an electronic apparatus, a configuration including, for example, a capacity element that is capable of detecting an operation position and a pressing force of an operant with respect to an input operation surface is known (for example, refer to Patent Literature 1).

### CITATION LIST

### Patent Literature

Patent Literature 1: JP 2011-170659A

### SUMMARY OF INVENTION

### Technical Problem

In recent years, input methods having a high degree of freedom through gesture operations using finger movements have been used. Further, implementation of more diverse input operations can be expected when a pressing force applied to an operation surface can be stably detected with high accuracy.

In view of the circumstances described above, the present disclosure provides a sensor device, an input device and an electronic apparatus, which are capable of detecting an operation position and a pressing force with high accuracy.

### Solution to Problem

In order to the above-described problem, a first technique is a sensor device including: a first conductor layer having flexibility; a second conductor layer; an electrode substrate that is provided between the first conductor layer and the second conductor layer and has flexibility; a plurality of first structural bodies that separate the first conductor layer and the electrode substrate; and a plurality of second structural bodies that separate the electrode substrate and the second conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

In the first technique, when an input operation is performed from above the first conductor layer, the first conductor layer is deflected and the electrode substrate is deflected toward the second conductor layer through the first structural body. Accordingly, a relative distance between each of the first and second conductor layers and the electrode substrate is changed, and it is possible to electrostatically detect the input operation such as pressing based on the change in distances. Therefore, it is possible to increase an amount of change in electrostatic capacitance with respect to the input operation and increase detection sensitivity. In addition, accordingly, it is possible to detect not only an intentional press operation but also a minute pressing force when a contact operation is performed, and it can also be used as a touch sensor.

When the input operation is performed from above the first conductor layer to a position corresponding to a middle portion of the unit region, the first conductor layer is deflected and an electrode substrate is deflected toward the second conductor layer through two or more first structural bodies included in the unit region. Therefore, compared to a case in which one first structural body is included in the unit region (for example, a case in which one first structural body is arranged at a center position of the unit region), it is possible to further increase a range at which the electrode substrate is greatly deflected toward the second conductor layer when the input operation is performed. Accordingly, compared to the case in which one first structural body is included in the unit region, it is possible to further increase a capacitance change rate and operation sensitivity when the input operation is performed.

When the input operation is performed from above the first conductor layer to a position corresponding to a gap between the unit regions or the vicinity thereof, it is possible to suppress the first conductor layer from being greatly locally deflected toward the second conductor layer in the gap between the unit regions or in the vicinity thereof due to two or more first structural bodies included in the unit region. Therefore, it is possible to obtain a capacitance change rate distribution in a preferable shape.

The sensor device in the first technique can detect the input operation with high accuracy even when an operant such as a finger wearing a glove or a fine-tipped stylus is used to perform the input operation through the first conductor layer rather than a configuration in which the operant and each electrode line of the electrode substrate are directly capacitively coupled.

A second technique is an input device including: an operation member having flexibility; a conductor layer; an electrode substrate that is provided between the operation member and the conductor layer and has flexibility; a plurality of first structural bodies that separate the operation member and the electrode substrate; and a plurality of second structural bodies that separate the conductor layer and the electrode substrate. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

In the second technique, when the input operation is performed from above the operation member, the operation member is deflected and the electrode substrate is deflected toward a second conductor layer through the first structural body. Accordingly, a relative distance of each of the operation member and the conductor layer from the electrode substrate is changed, and it is possible to electrostatically detect the input operation such as pressing based on the change in distances. Therefore, it is possible to increase an amount of change in electrostatic capacitance with respect to the input operation, and increase detection sensitivity. In addition, accordingly, it is possible to detect not only an intentional press operation but also a minute pressing force when a contact operation is performed, and it can also be used as a touch sensor.

When the input operation is performed from above the operation member to a position corresponding to a middle portion of the unit region, the operation member is deflected and the electrode substrate is deflected toward the conductor layer through two or more first structural bodies included in the unit region. Therefore, compared to the case in which one first structural body is included in the unit region (for example, a case in which one first structural body is arranged at a center position of the unit region), it is possible to further increase a range at which the electrode substrate is greatly deflected toward the conductor layer when the input operation is performed. Accordingly, compared to the case in which one first structural body is included in the unit region, it is possible to further increase a capacitance change rate and operation sensitivity when the input operation is performed.

When the input operation is performed from above the operation member to a position corresponding to a gap between the unit regions or the vicinity thereof, it is possible to suppress the operation member from being greatly locally deflected toward the conductor layer in the gap between the unit regions or in the vicinity thereof due to two or more first structural bodies included in the unit region. Therefore, it is possible to obtain a preferable capacitance change rate distribution.

A third technique is an electronic apparatus including: an operation member having flexibility; a conductor layer; an electrode substrate that is provided between the operation member and the conductor layer and has flexibility; a plurality of first structural bodies that separate the operation member and the electrode substrate; a plurality of second structural bodies that separate the conductor layer and the electrode substrate; and a control unit configured to generate a signal according to an input operation with respect to the operation member based on a change in electrostatic capacitance of the electrode substrate. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

A fourth invention is a sensor device including: a first conductor layer having flexibility; a second conductor layer that is provided to face the first conductor layer; an electrode substrate that is provided between the first conductor layer and the second conductor layer and has flexibility; a plurality of first structural bodies that separate the first conductor layer and the electrode substrate; and a plurality of second structural bodies that separate the electrode substrate and the second conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies are included in each unit region.

A fifth invention is a sensor device including: a first layer having flexibility; a second layer; an electrode substrate that is provided between the first layer and the second layer and has flexibility; a plurality of first structural bodies that separate the first layer and the electrode substrate; and a plurality of second structural bodies that separate the electrode substrate and the second layer. At least one of the first layer and the second layer includes a conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

A sixth invention is an input device including: a first layer that includes an operation member and has flexibility; a second layer; an electrode substrate that is provided between the first layer and the second layer and has flexibility; a plurality of first structural bodies that separate the first layer and the electrode substrate; and a plurality of second structural bodies that separate the electrode substrate and the second layer. At least one of the first layer and the second layer includes a conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

A seventh invention is an electronic apparatus including: a first layer that includes an operation member and has flexibility; a second layer; an electrode substrate that is provided between the first layer and the second layer and has flexibility; a plurality of first structural bodies that separate the first layer and the electrode substrate; a plurality of second structural bodies that separate the second layer and the electrode substrate; and a control unit configured to generate a signal according to an input operation with respect to the operation member based on a change in electrostatic capacitance of the electrode substrate. At least one of the first layer and the second layer includes a conductor layer. The electrode substrate includes a plurality of first electrodes and a plurality of second electrodes that intersect the plurality of first electrodes. A plurality of unit regions are provided to correspond to respective intersections between the first electrodes and the second electrodes. At least two of the first structural bodies and/or at least two of the second structural bodies are included in each unit region.

An eighth invention is a sensor device including: a first layer having flexibility; a second layer; an electrode substrate that is provided between the first layer and the second layer and has flexibility; a plurality of first structural bodies that separate the first layer and the electrode substrate; and a plurality of second structural bodies that separate the electrode substrate and the second layer. At least one of the first layer and the second layer includes a conductor layer. The electrode substrate includes a plurality of first electrodes having a plurality of first unit electrode bodies and a plurality of second electrodes having a plurality of second unit electrode bodies. A detection unit is configured as a combination of the first electrode bodies and the second electrode bodies. A plurality of unit regions are provided to correspond to the detection unit. At least two of the first structural bodies and/or at least two of the second structural bodies are included in each unit region.

### Advantageous Effects of Invention

As described above, according to the present disclosure, it is possible to detect an operation position and a pressing force with high accuracy.

### BRIEF DESCRIPTION OF DRAWINGS

FIG. 1 is a schematic cross-sectional view illustrating one exemplary configuration of an input device according to a first embodiment of the present disclosure.

FIG. 2 is an exploded perspective view illustrating one exemplary configuration of the input device according to the first embodiment of the present disclosure.

FIG. 3 is a schematic cross-sectional view illustrating one exemplary configuration of a main part of the input device according to the first embodiment of the present disclosure.

FIG. 4 is a block diagram illustrating one exemplary configuration of an electronic apparatus using the input device according to the first embodiment of the present disclosure.

FIG. 5A is a schematic cross-sectional view illustrating an exemplary configuration of a conductor layer of the input device according to the first embodiment of the present disclosure. FIG. 5B is a schematic cross-sectional view illustrating a modification of the conductor layer. FIG. 5C is a schematic cross-sectional view illustrating a modification of the conductor layer. FIG. 5D is a schematic cross-sectional view illustrating a modification of the conductor layer. FIG. 5E is a schematic cross-sectional view illustrating a modification of the conductor layer.

FIG. 6A is a schematic cross-sectional view for describing a configuration of a detection unit of the input device according to the first embodiment of the present disclosure. FIG. 6B is a schematic cross-sectional view for describing a configuration of a modification of the detection unit.

FIG. 7A is a schematic cross-sectional view illustrating an exemplary method of forming a first support of the input device according to the first embodiment of the present disclosure. FIG. 7B is a schematic cross-sectional view illustrating an exemplary method of forming a first support. FIG. 7C is a schematic cross-sectional view illustrating an exemplary method of forming a first support.

FIG. 8 is a schematic cross-sectional view illustrating an exemplary method of forming a second support of the input device according to the first embodiment of the present disclosure.

FIG. 9A is a schematic cross-sectional view illustrating a modification of the method of forming the first or second support. FIG. 9B is a schematic cross-sectional view illustrating a modification of the method of forming the first or second support.

FIG. 10A is a schematic diagram illustrating an arrangement example of first and second electrode lines. FIG. 10B is a schematic diagram illustrating one exemplary configuration of first and second electrode lines. FIG. 10C is a schematic diagram for describing a unit detection region.

FIG. 11 is a schematic cross-sectional view illustrating a state of a force applied to first and second structural bodies when an operant presses a point at a first surface of an input device downward, i.e., in a Z-axis direction.

FIG. 12 is a schematic main part cross-sectional view illustrating an aspect of an input device when a point on a first structural body of a first surface receives an operation from an operant and is a diagram illustrating exemplary amounts of changes in capacitance of respective detection units at that time.

FIG. 13 is a schematic main part cross-sectional view illustrating an aspect of an input device when a point on a first space portion of a first surface receives an operation from an operant and is a diagram illustrating exemplary amounts of changes in capacitance of respective detection units at that time.

FIG. 14 is a schematic main part cross-sectional view illustrating an aspect of an input device when a first surface receives an operation from a stylus and is a diagram illustrating exemplary amounts of changes in capacitance of respective detection units at that time.

FIG. 15 is a schematic main part cross-sectional view illustrating an aspect of an input device when a first surface receives an operation from a finger and is a diagram illustrating exemplary amounts of changes in capacitance of respective detection units at that time.

FIG. 16 is a diagram illustrating a relation between a load position and an amount of change in capacitance in an input device in which one first structural body is included in a unit detection region.

FIG. 17 is a diagram illustrating a relation between a load position and an amount of change in capacitance in an input device in which one first structural body is included in a unit detection region.

FIG. 18 is a diagram illustrating a relation between a load position and an amount of change in capacitance in an input device in which one first structural body is included in a unit detection region.

FIG. 19A is a diagram illustrating an ideal capacitance change rate distribution. FIG. 19B is a diagram illustrating an actual capacitance change rate distribution.

FIGS. 20A and 20B are schematic cross-sectional views for describing a reason for which two split peaks occur in a capacitance change rate distribution.

FIGS. 21A and 21B are schematic cross-sectional views for describing a reason for which improvement in accuracy of coordinate calculation is possible when two or more first structural bodies are included in a unit detection region.

FIG. 22A is a schematic plan view illustrating a first arrangement example of first and second structural bodies, and a first electrode line (Y electrode) and a second electrode line (X electrode). FIG. 22B is a schematic plan view illustrating a second arrangement example of first and second structural bodies, and a first electrode line (Y electrode) and a second electrode line (X electrode).

FIG. 23A is a plan view illustrating a first example of a symmetrical arrangement. FIG. 23B is a plan view illustrating a second example of the symmetrical arrangement.

FIG. 24A is a plan view illustrating a third example of a symmetrical arrangement. FIG. 24B is a plan view illustrating a fourth example of the symmetrical arrangement.

FIG. 25A is a plan view illustrating a fifth example of a symmetrical arrangement. FIG. 25B is a plan view illustrating a sixth example of the symmetrical arrangement.

FIG. 26 is a plan view illustrating a ninth example of the symmetrical arrangement.

FIG. 27A is a schematic cross-sectional view illustrating an exemplary configuration of an input device in which first and second structural bodies are arranged to overlap when viewed in a Z-axis direction. FIG. 27B is a plan view illustrating an arrangement example in which first and second structural bodies are arranged to overlap when viewed in a Z-axis direction.

FIG. 28 is a plan view illustrating a first arrangement example of second structural bodies.

FIG. 29A is a perspective view illustrating an enlarged vicinity of a region R_{A} illustrated in FIG. 28. FIG. 29B is a perspective view illustrating an enlarged vicinity of a region R_{B} illustrated in FIG. 28. FIG. 29C is a perspective view illustrating an enlarged vicinity of a region R_{c} illustrated in FIG. 28.

FIG. 30A is a plan view illustrating a second arrangement example of second structural bodies. FIG. 30B is a plan view illustrating a third arrangement example of second structural bodies.

FIGS. 31A and 31B are schematic cross-sectional views for describing a reason for which improvement in load sensitivity is possible when two or more first structural bodies are included in a unit detection region.

FIG. 32A is a schematic cross-sectional view illustrating a first arrangement example. FIG. 32B is a schematic cross-sectional view illustrating a second arrangement example. FIG. 32C is a schematic cross-sectional view illustrating a third arrangement example.

FIGS. 33A to 33C are schematic cross-sectional views for describing distances Dx and Dy between first structural bodies.

FIG. 34 is a plan view for describing distances Dx and Dy between first structural bodies.

FIG. 35A is a schematic cross-sectional view for describing a drawing characteristic of an input device in which one first structural body is included in a unit detection region. FIG. 35B is a plan view for describing a drawing characteristic of an input device in which one first structural body is included in a unit detection region.

FIG. 36A is a plan view illustrating a region R in which slight sinking occurs in the arrangement example illustrated in FIG. 23B. FIG. 36B is a plan view illustrating a region R in which slight sinking occurs in the arrangement example illustrated in FIG. 25A.

FIG. 37A is a plan view illustrating a modification of the first electrode line. FIG. 37B is a plan view illustrating a modification of the second electrode line.

FIGS. 38(A) to 38(P) are schematic diagrams illustrating exemplary shapes of a unit electrode body.

FIG. 39A is a schematic cross-sectional view illustrating an example in which the input device according to the first embodiment of the present disclosure is implemented in an electronic apparatus. FIG. 39B is a schematic cross-sectional view illustrating a modification of the example in which the input device according to the first embodiment of the present disclosure is implemented in an electronic apparatus.

FIG. 40 is a schematic cross-sectional view illustrating one exemplary configuration of an input device according to a fourth embodiment of the present disclosure.

FIG. 41A is a schematic cross-sectional view illustrating one exemplary configuration of an operation member of the input device according to the fourth embodiment of the present disclosure. FIG. 41B is a schematic cross-sectional view illustrating a modification of the operation member.

FIG. 42 is a schematic cross-sectional view illustrating one exemplary configuration of an electronic apparatus in which an input device according to a fifth embodiment of the present disclosure is included.

FIG. 43 is a schematic diagram illustrating simulation conditions in Test Example 1.

FIGS. 44A to 44C are diagrams illustrating simulation results of Test Example 1-1.

FIGS. 45A to 45C are diagrams illustrating simulation results of Test Example 1-2.

FIGS. 46A to 46C are diagrams illustrating simulation results of Test Examples 2-1 and 2-2.

FIGS. 47A to 47C are diagrams illustrating simulation results of Test Examples 2-3 and 2-4.

FIGS. 48A to 48C are diagrams illustrating simulation results of Test Examples 2-5 and 2-6.

FIGS. 49A to 49C are diagrams illustrating simulation results of Test Examples 2-7 and 2-8.

FIGS. 50A to 50C are diagrams illustrating simulation results of Test Examples 2-9 and 2-10.

FIGS. 51A to 51C are diagrams illustrating simulation results of Test Examples 2-11 and 2-12.

FIG. 52 is a diagram illustrating simulation results of Test Examples 3-1 to 3-4.

FIG. 53 is a diagram illustrating simulation results of Test Examples 4-1 to 4-3.

FIG. 54A is a diagram illustrating simulation results of Test Examples 5-1 and 5-2. FIG. 54B is a diagram illustrating simulation results of Test Example 5-1. FIG. 54C is a diagram illustrating simulation results of Test Example 5-2.

FIG. 55A is a schematic cross-sectional view illustrating a modification of the input device according to the first embodiment of the present disclosure. FIG. 55B is a schematic main part cross-sectional view illustrating an aspect of the input device when a first surface receives an operation from a finger.

FIG. 56A is a plan view illustrating a first example of arrangement positions of a plurality of openings in a planar direction of the input device. FIG. 56B is a plan view illustrating a second example of the arrangement positions of the plurality of openings in the planar direction of the input device.

FIG. 57A is a schematic diagram illustrating a first example of a ground connection of the input device. FIG. 57B is a schematic diagram illustrating a second example of the ground connection of the input device.

FIG. 58A is a plan view illustrating a seventh example of the symmetrical arrangement. FIG. 58B is a plan view illustrating an eighth example of the symmetrical arrangement.

FIG. 59A is a plan view illustrating a tenth example of the symmetrical arrangement. FIG. 59B is a plan view illustrating an eleventh example of the symmetrical arrangement.

FIG. 60A is a perspective view illustrating an exemplary shape of an input device having a cylindrical shape. FIG. 60B is a cross-sectional view taken along the line A-A of FIG. 60A.

FIG. 61A is a perspective view illustrating an exemplary shape of an input device having a curved shape. FIG. 61B is a cross-sectional view taken along the line A-A of FIG. 61A.

FIG. 62A is a cross-sectional view illustrating an exemplary configuration of an input device according to a second embodiment of the present disclosure. FIG. 62B is a cross-sectional view illustrating an enlarged part of FIG. 62A.

FIG. 63A is a plan view illustrating an exemplary configuration of a Y electrode. FIG. 63B is a plan view illustrating an exemplary configuration of an X electrode.

FIG. 64A is a plan view illustrating an arrangement example of X electrodes and Y electrodes. FIG. 64B is a cross-sectional view taken along the line A-A of FIG. 64A.

FIG. 65A is a plan view illustrating a first example of a configuration of the X electrode. FIG. 65B is a plan view illustrating a first example of a configuration of the Y electrode.

FIG. 66A is a plan view illustrating a second example of the configuration of the X electrode. FIG. 66B is a plan view illustrating a second example of the configuration of the Y electrode.

FIG. 67A is a cross-sectional view illustrating a first example of a configuration of an input device according to a third embodiment of the present disclosure. FIG. 67B is a cross-sectional view illustrating a second example of the configuration of the input device according to the third embodiment of the present disclosure.

FIG. 68A is a plan view illustrating a first example of a configuration of X and Y electrodes in an input device according to a modification of the third embodiment of the present disclosure. FIG. 68B is a plan view illustrating a second example of the configuration of X and Y electrodes in the input device according to the modification of the third embodiment of the present disclosure.

FIG. 69A is a plan view illustrating an arrangement example of first electrode lines (Y electrodes). FIG. 69B is a plan view illustrating an arrangement example of second electrode lines (X electrodes).

FIG. 70A is a plan view illustrating an arrangement example of first structural bodies. FIG. 70B is a plan view illustrating an arrangement example of second structural bodies.

FIG. 71 is a plan view illustrating an arrangement relation between first and second electrode lines and first and second structural bodies.

FIG. 72 is a plan view illustrating an arrangement example of first and second structural bodies.

### DESCRIPTION OF EMBODIMENTS

In the present disclosure, a sensor device and an input device are appropriately applied to an electronic apparatus, for example, a notebook personal computer, a touch panel display, a tablet computer, a cellular phone (for example, a smartphone), a digital camera, a digital video camera, an audio device (for example, a portable audio player), and a game device.

In the present disclosure, a conductive layer having electrical conductivity is preferable. As the conductor layer, for example, an inorganic conductive layer including an inorganic conductive material, an organic conductive layer including an organic conductive material, and an organic-inorganic conductive layer including both the inorganic conductive material and the organic conductive material are preferably used.

Examples of the inorganic conductive material include a metal and a metal oxide. Here, metals are defined to include semimetals. Examples of the metal include a metal such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead or alloys thereof, but the present disclosure is not limited thereto. Examples of the metal oxide include indium tin oxide (ITO), zinc oxide, indium oxide, an antimony-doped tin oxide, a fluorine-doped tin oxide, aluminum-doped zinc oxide, gallium-doped zinc oxide, silicon-doped zinc oxide, zinc-tin oxide, indium-tin oxide, and zinc-indium-magnesium oxide, but the present disclosure is not limited thereto.

Examples of the organic conductive material include a carbon material and a conductive polymer. Examples of the carbon material include carbon black, carbon fibers, a fullerene, graphene, carbon nanotubes, carbon microcoils, and nanohorns, but the present disclosure is not limited thereto. Examples of the conductive polymer include a substituted or unsubstituted polyaniline, a polypyrrole, a polythiophene, and a (co)polymer including one or two selected therefrom, but the present disclosure is not limited thereto.

Embodiments of the present disclosure will be described in the following order.

1. First embodiment (example of input device)
2. Second embodiment (example of input device)
3. Third embodiment (example of input device)
4. Fourth embodiment (example of input device)
5. Fifth embodiment (example of electronic apparatus)

### 1 First Embodiment

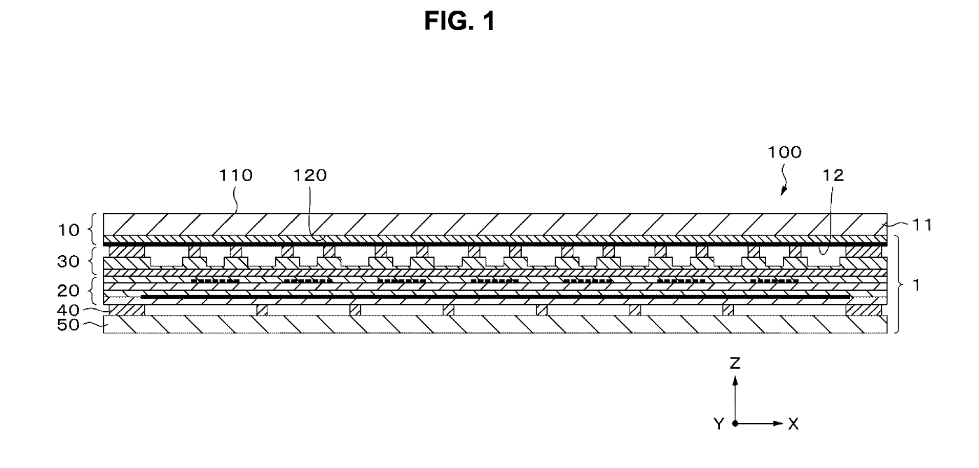

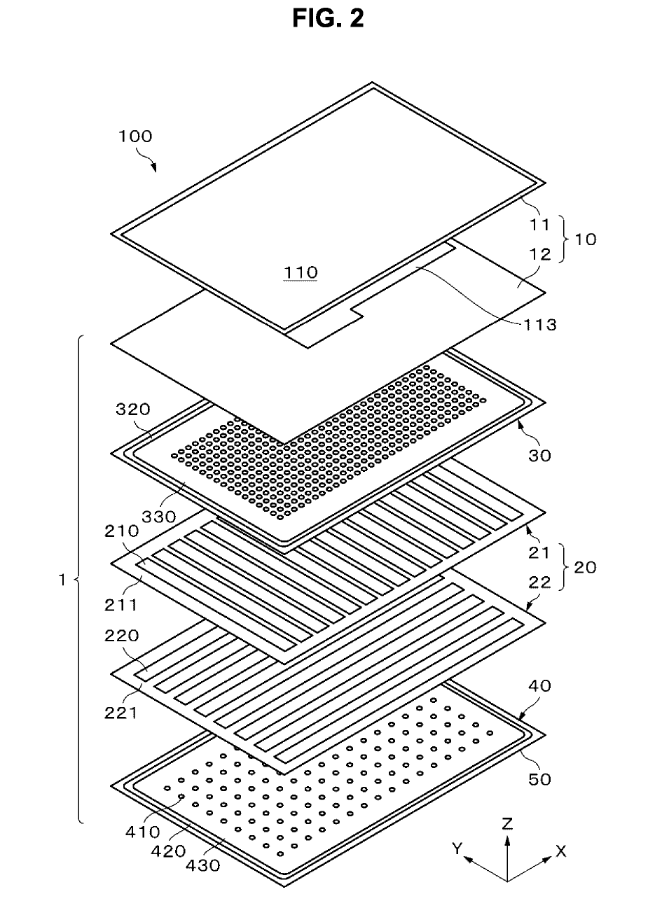

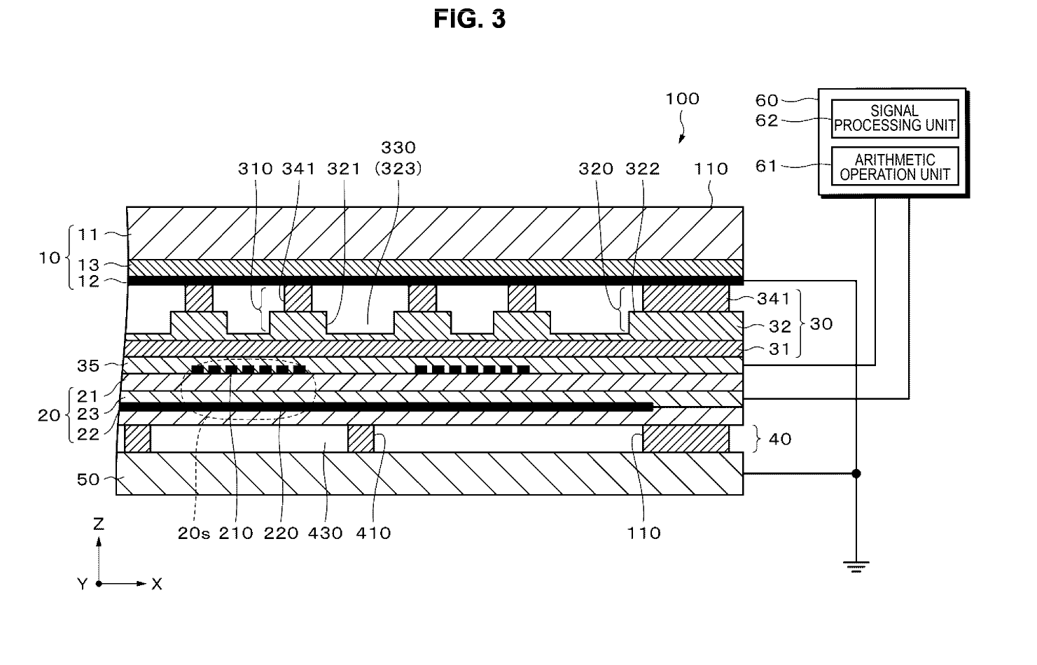

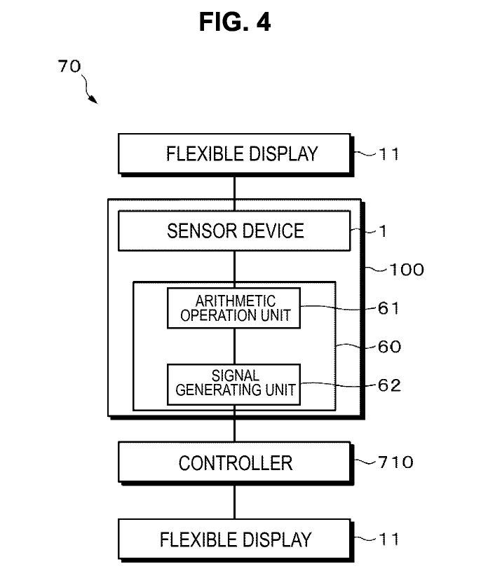

FIG. 1 is a schematic cross-sectional view illustrating one exemplary configuration of an input device 100 according to the first embodiment of the present disclosure. FIG. 2 is an exploded perspective view illustrating one exemplary configuration of the input device 100. FIG. 3 is a schematic cross-sectional view illustrating one exemplary configuration of a main part of the input device 100. FIG. 4 is a block diagram illustrating one exemplary configuration of an electronic apparatus 70 using the input device 100. Hereinafter, a configuration of the input device 100 of the present embodiment will be described. Also, in the drawing, an X axis (first direction) and a Y axis (second direction) indicate directions (planar directions of the input device 100) which are orthogonal to each other, and a Z axis indicates a direction (a thickness direction or a vertical direction of the input device 100) orthogonal to the X axis and the Y axis.

### [Input Device]

The input device 100 includes a flexible display (display unit) 11 configured to receive an operation from a user, and a sensor device 1 configured to detect the user operation. The input device 100 is configured as, for example, a flexible touch panel display, and embedded in the electronic apparatus 70 to be described below. The sensor device 1 and the flexible display 11 have a planar shape that extends in a direction perpendicular to the Z axis.

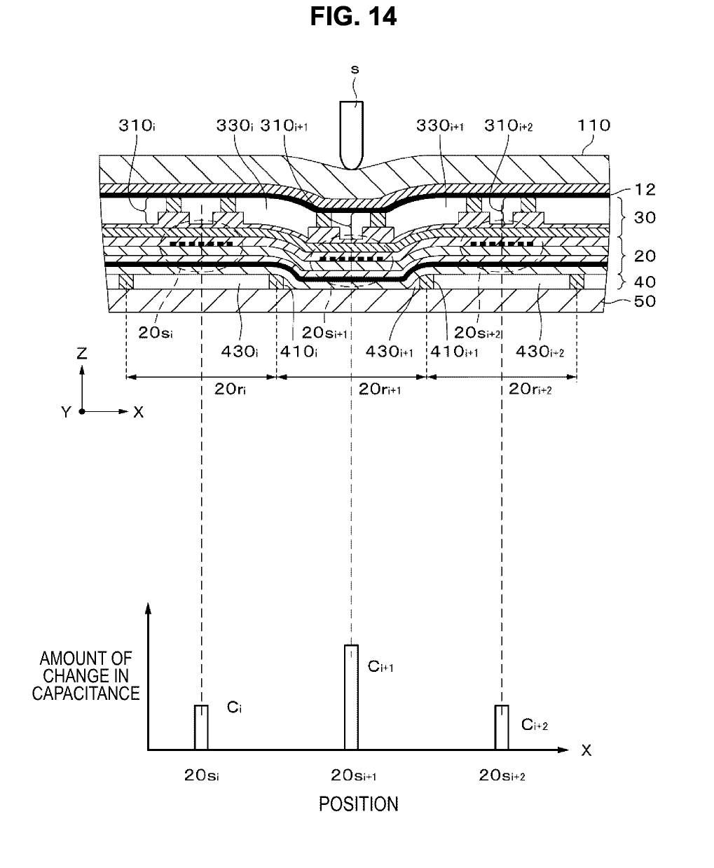

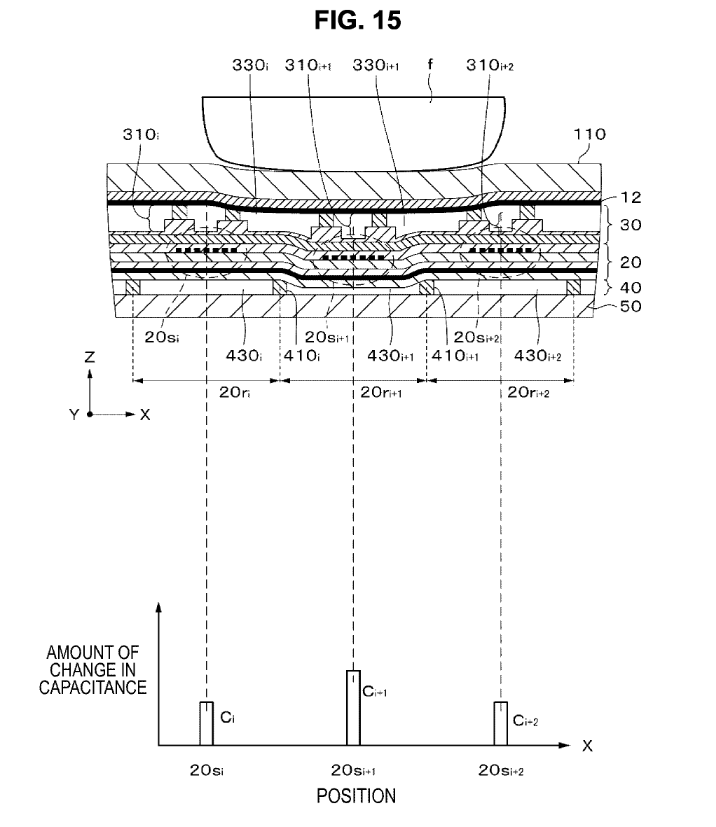

The flexible display 11 includes a first surface 110 and a second surface 120 opposite to the first surface 110. The flexible display 11 has both a function as an input operation unit in the input device 100 and a function as a display unit. That is, the flexible display 11 enables the first surface 110 to function as an input operation surface and a display surface, and displays an image corresponding to the user operation from the first surface 110 upward, i.e., a Z-axis direction. For example, an image corresponding to a keyboard or a graphical user interface (GUI) is displayed on the first surface 110. An operant that performs an operation with respect to the flexible display 11 includes, for example, a finger f illustrated in FIG. 15 or a stylus s illustrated in FIG. 14.

A specific configuration of the flexible display 11 is not particularly limited. As the flexible display 11, for example, a so-called electronic paper, an organic electroluminescent (EL) panel, an inorganic EL panel, or a liquid crystal panel can be used. In addition, a thickness of the flexible display 11 is not particularly limited, and is, for example, 0.1 mm to 1 mm.

The sensor device 1 includes a metal film (first conductor layer (conductive layer)) 12, a conductor layer (second conductor layer (conductive layer)) 50, an electrode substrate 20, a first support 30, and a second support 40. The sensor device 1 is arranged on the second surface 120 of the flexible display 11.

The metal film 12 has flexibility, and is configured in, for example, a deformable sheet shape. The conductor layer 50 is arranged to face the metal film 12. The electrode substrate 20 has flexibility, and includes a plurality of first electrode lines 210 and a plurality of second electrode lines 220 that are arranged to face the plurality of first electrode lines 210 and intersect the plurality of first electrode lines 210. The electrode substrate 20 is deformable and arranged between the metal film 12 and the conductor layer 50, and is able to electrostatically detect a change in a distance from each of the metal film 12 and the conductor layer 50. The first support 30 includes, for example, a plurality of first structural bodies 310 connecting the metal film 12 and the electrode substrate 20 and a first space portion 330 formed between the plurality of first structural bodies 310. The metal film 12 and the electrode substrate 20 are separated by the plurality of first structural bodies 310. The second support 40 includes, for example, a plurality of second structural bodies 410 that are arranged between the plurality of adjacent first structural bodies 310 and connect the conductor layer 50 and the electrode substrate 20, and a second space portion 430 formed between the plurality of second structural bodies 410. The conductor layer 50 and the electrode substrate 20 are separated by the plurality of second structural bodies 410. The first space portion 330 and the second space portion 430 may be filled with a medium such as a liquid or gel. In addition, a gas other than air may be filled therein.

The sensor device 1 (the input device 100) according to the present embodiment electrostatically detects a change in distances between the metal film 12 and the electrode substrate 20 and between the conductor layer 50 and the electrode substrate 20 according to an input operation onto the first surface 110 of the flexible display 11, and thus detects the input operation. The input operation is not limited to an intentional press (push) operation on the first surface 110, but may include a contact (touch) operation. That is, as will be described below, since the input device 100 can also detect a minute pressing force (for example, about several tens of g) applied by a general touch operation, it is configured such that the same touch operation as a general touch sensor is possible.

The input device 100 includes a control unit 60. The control unit 60 includes an arithmetic operation unit 61 and a signal generating unit 62. The arithmetic operation unit 61 detects the user operation based on a change in electrostatic capacitance of a detection unit 20s. The signal generating unit 62 generates an operation signal based on the detection result of the arithmetic operation unit 61.

The electronic apparatus 70 illustrated in FIG. 4 includes a controller 710 configured to perform a process based on an operation signal that is generated from the signal generating unit 62 of the input device 100. The operation signal processed by the controller 710 is output to the flexible display 11 as, for example, an image signal. The flexible display 11 is connected to a drive circuit mounted in the controller 710 through a flexible wiring substrate 113 (refer to FIG. 2). The drive circuit may also be mounted on the wiring substrate 113.

In the present embodiment, the flexible display 11 is configured as a part of an operation member 10 of the input device 100. That is, the input device 100 includes the operation member 10, the electrode substrate 20, the first support 30, the second support 40, and the conductor layer 50. Hereinafter, these components will be described.

### (Operation Member)

The operation member 10 has a structure in which the flexible display 11 having the first surface 110 and the second surface 120 and the metal film 12 are laminated. That is, the operation member 10 includes the first surface 110 receiving the user operation and the second surface 120 in which the metal film 12 is formed and that is opposite to the first surface 110, and is configured in a deformable sheet shape. The metal film 12 is provided in the second surface 120 facing the conductor layer 50.

The metal film 12 is configured in a sheet shape that is deformable according to deformation of the flexible display 11, and is configured as a metallic foil such as copper (Cu), aluminum (Al), or stainless steel (SUS), or a mesh material. In addition, the metal film 12 may be configured as a vapor deposited film or a sputtering film of a conductor formed on a base material of a sheet shape, or a coating film such as a conductive paste. Also, the metal film 12 may function as the conductive layer and may also be an oxide conductor such as indium tin oxide (ITO) or an organic conductor such as carbon nanotubes. A thickness of the metal film 12 is not particularly limited, and is, for example, several tens of nm to several tens of μm. The metal film 12 is connected to, for example, a ground potential. Accordingly, the metal film 12 functions as an electromagnetic shielding layer when it is implemented in the electronic apparatus 70. That is, for example, introduction of electromagnetic waves from the flexible display 11 or introduction of electromagnetic waves from other electronic components implemented in the electronic apparatus 70 and leakage of electromagnetic waves from the input device 100 are suppressed, which can contribute to stable operations of the electronic apparatus 70. In addition, in order to enhance the function as such an electromagnetic shielding layer, a plurality of metal films 12 may be provided.

As illustrated in FIG. 3, the metal film 12 is formed by, for example, attaching an adhesive layer 13 such as a pressure sensitive adhesive resin film in which a metallic foil is formed to the flexible display 11. Alternatively, the metal film 12 may be configured as a vapor deposited film or a sputtering film directly formed on the flexible display 11, or a coating film such as a conductive paste printed on a surface of the flexible display 11. In addition, a non-conductive film may be formed on a surface opposite to the flexible display 11 of the metal film 12. As the non-conductive film, for example, a scratch-resistant hard coat layer or a corrosion resistant anti-oxidation film can be formed.

### (Conductor Layer)

The conductor layer 50 configures the lowermost portion of the input device 100, and is arranged to face the metal film 12 in the Z-axis direction. The conductor layer 50 also functions as, for example, a support plate of the input device 100, and is configured to have, for example, higher flexural rigidity than the operation member 10 and the electrode substrate 20. The conductor layer 50 may be configured as a metal plate including, for example, an Al alloy, a magnesium (Mg) alloy or other metal materials, or a conductor plate such as a carbon-fiber-reinforced plastic. Alternatively, the conductor layer 50 may have a laminated structure in which a conductive film such as a plating film, a vapor deposited film, a sputtering film or a metallic foil is formed on an insulator layer such as a plastic material. In addition, a thickness of the conductor layer 50 is not particularly limited, and is, for example, about 0.3 mm.

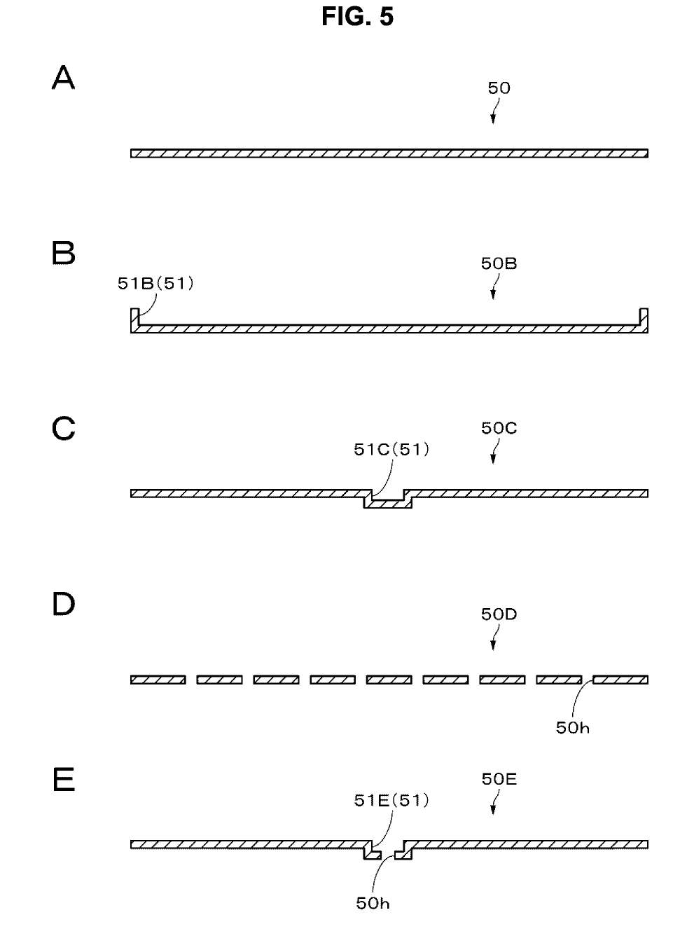

FIGS. 5A to 5E are schematic cross-sectional views illustrating exemplary configurations of the conductor layer 50. The conductor layer 50 is not limited to an example configured in a flat plate shape as illustrated in FIG. 5A, but may include a step portion 51 illustrated in FIGS. 5B, 5C, and 5E. Alternatively, the conductor layer 50 may also be configured in a mesh shape as illustrated in FIG. 5D.

For example, a conductor layer 50B illustrated in FIG. 5B includes a step portion 51B that is formed by bending a circumference portion upward, i.e., in a Z-axis direction. Conductor layers 50C and 50E illustrated in FIGS. 5C and 5E have step portions 51C and 51E, respectively, each are formed at a middle portion and recessed downward. According to the step portion 51, it is possible to increase flexural rigidity of the conductor layer 50 in the Z-axis direction.

In addition, a conductor layer 50D illustrated in FIG. 5D is formed in a mesh shape. In this manner, when the conductor layer 50 is formed in the mesh shape, it is possible to increase heat dissipation while rigidity is maintained, suppress failure of the input device 100, and increase reliability.

In addition, one or a plurality of openings 50h are provided in the conductor layers 50D and 50E illustrated in FIGS. 5D and 5E. When the opening 50h is provided in the conductor layer 50 in this manner, it is possible to increase heat dissipation while maintaining rigidity, suppress failure of the input device 100, and increase reliability. In addition, as described above, when the opening 50h is provided in the conductor layer 50, it is possible to decrease a volume of the conductor layer 50 and decrease a weight of the input device 100. Further, as described above, when the opening 50h is provided in the conductor layer 50, air flow becomes easy when a volume of the second space portion 430 is changed due to deformation, and a response time of the electrode substrate 20 decreases. Here, the response time indicates a time from when a weight of the operation member 10 is changed until a capacity of the sensor device 1 is actually changed.

As a shape of the opening 50h, a polygonal shape such as a triangle or a rectangle, a circular shape, an elliptical shape, an oval shape, an irregular shape and a slit shape are exemplified. These shapes may be used alone or in combinations of two or more shapes. When the plurality of openings 50h are provided in the conductor layer 50, the plurality of openings 50h are arranged in a regular or irregular pattern, and the regular pattern is preferable from the viewpoint of uniformity of sensor sensitivity. This arrangement may be either a 1D arrangement or a 2D arrangement. In addition, when the plurality of openings 50h are provided in the conductor layer 50, the entire conductor layer 50 having the plurality of openings 50h may have a mesh shape or a stripe shape as a whole, and the plurality of openings 50h may form a geometric pattern as a whole.

When the opening 50h is provided in the conductor layer 50, the opening 50h is preferably provided at a position or a region that does not face the second structural body 410 and the second structural body 410 constituting a group. That is, the opening 50h and the second structural body 410 are preferably provided to be shifted in a planar direction (within the XY plane) such that they do not overlap in the Z-axis direction (that is, a thickness direction of the input device 100). Therefore, the electrode substrate 20 and the conductor layer 50 are stably connected in the second structural body 410.

In addition, a preferable position of the opening 50h in the conductor layer 50 is a position that does not face intersecting regions (the detection units 20s) between a plurality of electrode groups 21w and a plurality of electrode groups 22w, which will be described below. That is, the opening 50h and the detection unit 20s are preferably provided to be shifted in the planar direction (within the XY plane) such that they do not overlap in the Z-axis direction (that is, the thickness direction of the input device 100). When the opening 50h of the conductor layer 50 is arranged at a position facing the detection unit 20s, an initial capacitance or a capacitance change rate of the detection unit 20s is changed and sensor sensitivity in the input device 100 becomes nonuniform, compared with when the opening 50h of the conductor layer 50 is not arranged at a position facing the detection unit 20s.

It is preferable that an arrangement position of the opening 50h be the same position in all detection regions 20r. However, the unit detection regions 20r of the outermost circumference and in the vicinity of the outermost circumference of the input device 100 are excluded. Therefore, nonuniform sensor sensitivity in the input device 100 as described above is prevented. Also, the unit detection region 20r will be described in detail below. In order to prevent sensor sensitivity from becoming nonuniform, it is preferable that the opening 50h be arranged symmetrically with respect to a center of the detection unit (intersecting region) 20s. More specifically, the opening 50h is preferably arranged in linear symmetry with respect to a center line of each of the first and second electrode lines 210 and 220.

FIGS. 56A and 56B are plan views illustrating arrangement position examples of the plurality of openings 50h in the planar direction (within the XY plane) of the input device 100. FIG. 56A illustrates an example in which the opening 50h has an oval shape. FIG. 56B illustrates an example in which the opening 50h has a circular shape. The example illustrates that the plurality of openings 50h are arranged on an outer circumference (circumference) of the unit detection region 20r, and the opening 50h, the second structural body 410 and the detection unit 20s are provided to be shifted in the planar direction (within the XY plane) without overlapping the second structural body 410 or the detection unit 20s in the Z-axis direction when viewed in the Z-axis direction (that is, the thickness direction of the input device 100).

The conductor layer 50 is connected to, for example, a ground potential. Accordingly, the conductor layer 50 functions as an electromagnetic shielding layer when it is implemented in the electronic apparatus 70. That is, for example, introduction of electromagnetic waves from other electronic components implemented in the electronic apparatus 70 and leakage of electromagnetic waves from the input device 100 are suppressed, which can contribute to stable operations of the electronic apparatus 70.

In order to enhance the function as the electromagnetic shielding layer, and particularly, in order to prevent electromagnetic waves from being introduced from the flexible display 11, a ground potential connecting method of the metal film 12 and the conductor layer 50 is preferably as follows.

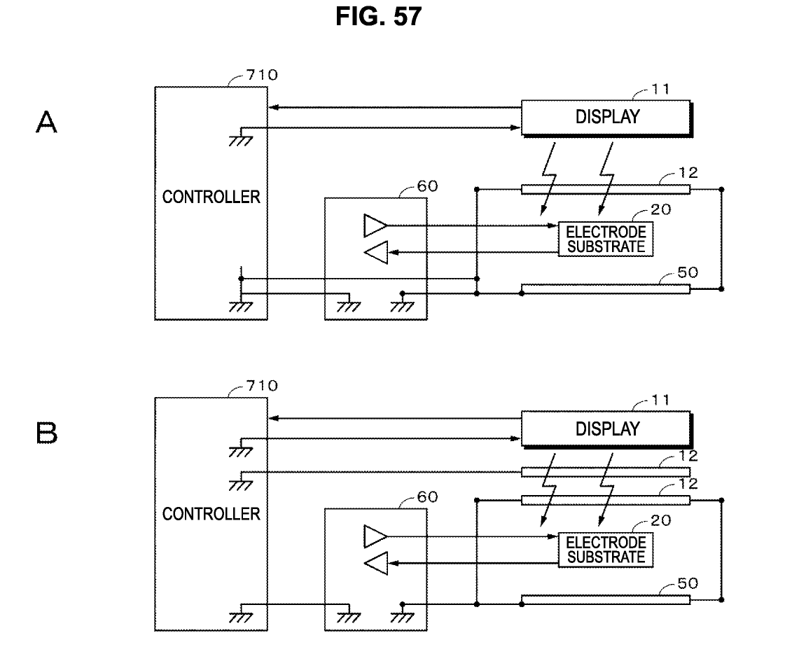

As illustrated in FIG. 57A, it is preferable that the metal film 12 and the conductor layer 50 be connected to not only a ground of the control unit 60 but also a ground of the controller 710. The flexible display 11 is connected to the controller 710 and is directly connected to a noise source. Therefore, it is possible to increase a shielding effect of the metal film 12. Moreover, when the metal film 12 and the conductor layer 50 are connected at many contact points, the effect increases.

In addition, as illustrated in FIG. 57B, a ground connection of the conductor layer 50 is in the control unit 60 and a plurality of metal films 12 are arranged. Among these metal films 12, the metal film 12 provided closest to the flexible display 11 may be connected to the controller 710. Further, a ground connection of the metal film 12 provided closest to the electrode substrate 20 among these metal films 12 may be connected to both the control unit 60 and the controller 710. Also, FIG. 57B illustrates an example in which two metal films 12 are provided.

### (Adhesive Layer)

The adhesive layer 13 may also be provided between the flexible display 11 and the metal film 12. The adhesive layer 13 is configured as, for example, an adhesive or a pressure sensitive adhesive tape having an insulating property. As the adhesive, for example, one or more selected from the group consisting of an acrylic adhesive, a silicone-based adhesive and a urethane-based adhesive may be used. In the present disclosure, pressure sensitive adhesion is defined as a type of adhesion. According to this definition, a pressure sensitive adhesive layer is considered to be a type of adhesive layer.

Entire surfaces of the flexible display 11 and the metal film 12 may be adhered by the adhesive layer 13. In this case, strong adhesion and uniform sensitivity are obtained in an entire planar surface of the flexible display 11 and the metal film 12.

In addition, only outer circumference portions of the flexible display 11 and the metal film 12 may be adhered by the adhesive layer 13, and particularly preferably, both are adhered only at a part above the first frame 320. A part of the first frame 320 has a stronger adhesive force than a part of the first structural body 310, and when an upward peeling force is applied to the flexible display 11, it is possible to suppress destruction of the part of the first structural body 310, peeling of the metal film 12 and the first structural body 310, and peeling of the electrode substrate 20 and the first structural body 310.

In addition, only a display area (effective area) of the flexible display 11 may be adhered by the adhesive layer 13. When a wire, an FPC, a driver and the like are attached to the outer circumference portion of the flexible display 11, it is possible to prevent the flexible display 11 from being damaged. When a step of the outer circumference portion of the flexible display 11 is adhered, it is possible to prevent abnormality in sensitivity of a vicinity sensor from occurring. When the step of the outer circumference portion of the flexible display 11 is large or a warp is large, bonding may only be performed further inside than the display area (effective area).

In addition, as the adhesive layer 13, for example, an adhesive layer that has a substantially uniform thickness and is continuously provided between the flexible display 11 and the metal film 12, or an adhesive layer that has a predetermined pattern in a planar direction of the flexible display 11 and the metal film 12 may be used. A pattern of the adhesive layer 13 may be either a 1D pattern in which a predetermined adhesive pattern is repeated in one direction or a 2D pattern in which a predetermined adhesive pattern is repeated in two directions. As a specific pattern shape, a columnar shape, a stripe shape, a grid shape and the like are exemplified, but the present disclosure is not limited thereto. When the adhesive layer 13 has the pattern described above, it is possible to suppress air bubbles from being mixed into in the adhesive layer 13 and increase a yield rate when the flexible display 11 is laminated. When the adhesive layer 13 has the pattern described above, it is preferable that a thickness of the adhesive layer 13 be smaller than a thickness of the metal film 12. Moreover, it is preferable that the adhesive layer 13 have higher definition than the first structural body 310. That is, it is preferable that a size of the pattern of the adhesive layer 13 be smaller than a size of the first structural body 310. In this case, it is preferable that the size of the pattern of the adhesive layer 13 be 1/10 or less the size of the first structural body 310. When the adhesive layer 13 has higher definition than the first structural body 310, it is possible to suppress occurrence of nonuniformity in sensitivity and occurrence of periodicity in sensitivity due to interference between the pattern of the adhesive layer 13 and the pattern of the first structural body 310. Also, without the adhesive layer 13, only the flexible display 11 may be placed on the metal film 12.

### (Electrode Substrate)

The electrode substrate 20 is configured as a body in which a first wiring substrate 21 including the first electrode line 210 and a second wiring substrate 22 including the second electrode line 220 are laminated.

The first wiring substrate 21 includes a first base material 211 (refer to FIG. 2), and a plurality of first electrode lines (Y electrodes) 210. The first base material 211 is configured as, for example, a sheet material having flexibility, and specifically, configured as an electrically insulating plastic sheet (film) such as PET, PEN, PC, PMMA, or polyimide. A thickness of the first base material 211 is not particularly limited, and is, for example, several tens of μm to several 100 μm.

The plurality of first electrode lines 210 are integrally provided on one surface of the first base material 211. The plurality of first electrode lines 210 are arranged in an X-axis direction at predetermined intervals, and substantially linearly formed in a Y-axis direction. Each of the first electrode lines 210 is drawn to an edge or the like of the first base material 211 and connected to a different terminal. In addition, each of the first electrode lines 210 is electrically connected to the control unit 60 through these terminals.

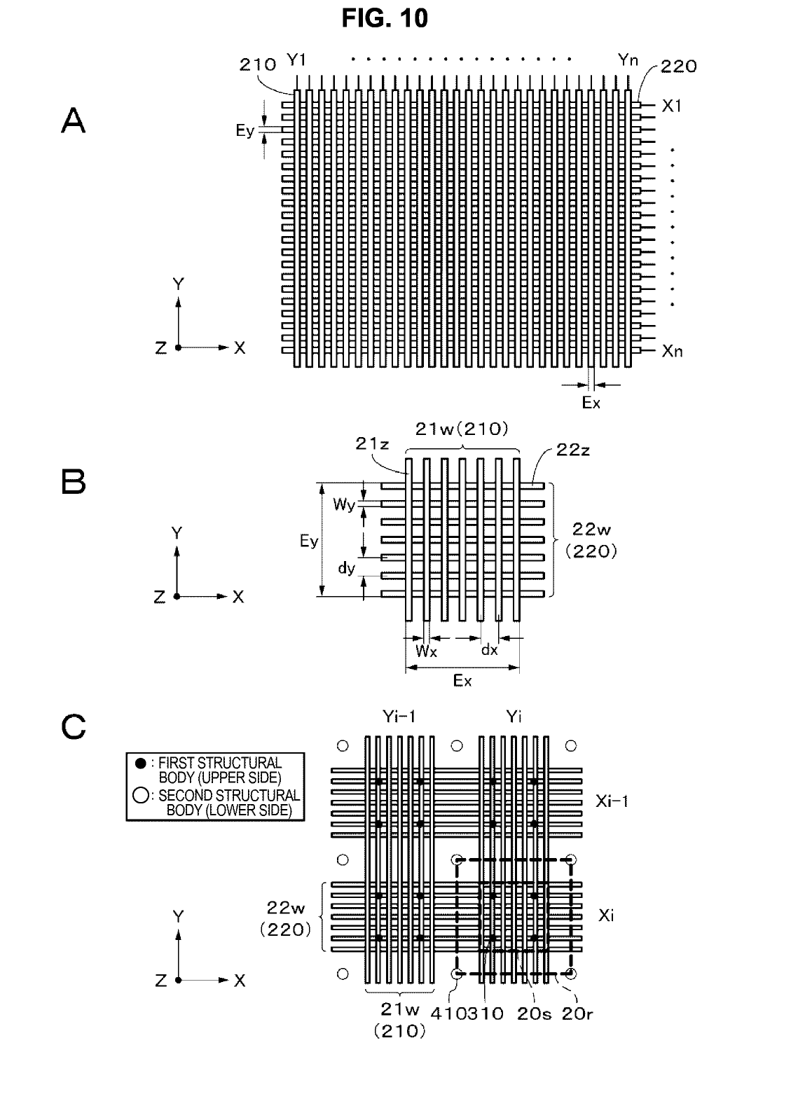

Also, each of the plurality of first electrode lines 210 may be configured as a single electrode line, or configured as the plurality of electrode groups 21w (refer to FIG. 10) arranged in the X-axis direction. In addition, the plurality of electrode lines constituting each of the electrode groups 21w may be connected to a common terminal, or separately connected to two or more different terminals.

On the other hand, the second wiring substrate 22 includes a second base material 221 (refer to FIG. 2), and a plurality of second electrode lines (X electrodes) 220. Similar to the first base material 211, the second base material 221 is configured as, for example, a sheet material having flexibility, and specifically, configured as an electrically insulating plastic sheet (film) such as PET, PEN, PC, PMMA, or polyimide. A thickness of the second base material 221 is not particularly limited, and is, for example, several tens of μm to several 100 μm. The second wiring substrate 22 is arranged to face the first wiring substrate 21.

The plurality of second electrode lines 220 are configured similarly to the plurality of first electrode lines 210. That is, the plurality of second electrode lines 220 are integrally provided on one surface of the second base material 221, arranged in the Y-axis direction at predetermined intervals, and substantially linearly formed in the X-axis direction. In addition, each of the plurality of second electrode lines 220 may be configured as a single electrode line, or configured as the plurality of electrode groups 22w (refer to FIG. 10) arranged in the Y-axis direction.

Each of the second electrode lines 220 is drawn to an edge or the like of the second base material 221 and connected to a different terminal. The plurality of electrode lines constituting each of the electrode groups 22w may be connected to a common terminal or separately connected to two or more different terminals. In addition, each of the second electrode lines 210 is electrically connected to the control unit 60 through these terminals.

The first and second electrode lines 210 and 220 may be formed by a printing method such as screen printing, gravure offset printing, or ink jet printing using a conductive paste, or may be formed by a patterning method using a photolithography technique of a metallic foil or a metal layer. In addition, when both of the first and second base materials 211 and 221 are configured as a sheet having flexibility, the entire electrode substrate 20 can have flexibility.

As illustrated in FIG. 3, the electrode substrate 20 includes an adhesive layer 23 that bonds the first wiring substrate 21 and the second wiring substrate 22 to each other. The adhesive layer 23 has an electrically insulating property, and is configured as, for example, a cured material of an adhesive, or a pressure sensitive adhesive material such as a pressure sensitive adhesive tape.

The electrode substrate 20 includes the plurality of detection units 20s that are formed in regions in which the first electrode line 210 and the second electrode line 220 intersect and have a capacity that is changed according to a relative distance to each of the metal film (first conductor layer) 12 and the conductor layer (second conductor layer) 50. The plurality of first structural bodies 310 may form a group associated with each of the detection units 20s. In addition, the plurality of second structural bodies 410 may form a group associated with each of the detection units 20s. The plurality of first and second structural bodies 310 and 410 constituting each group may also be arranged symmetrically with respect to a center of the detection unit (intersecting region) 20s. More specifically, the first and second electrode lines 210 and 220 may also be arranged in linear symmetry with respect to respective center lines.

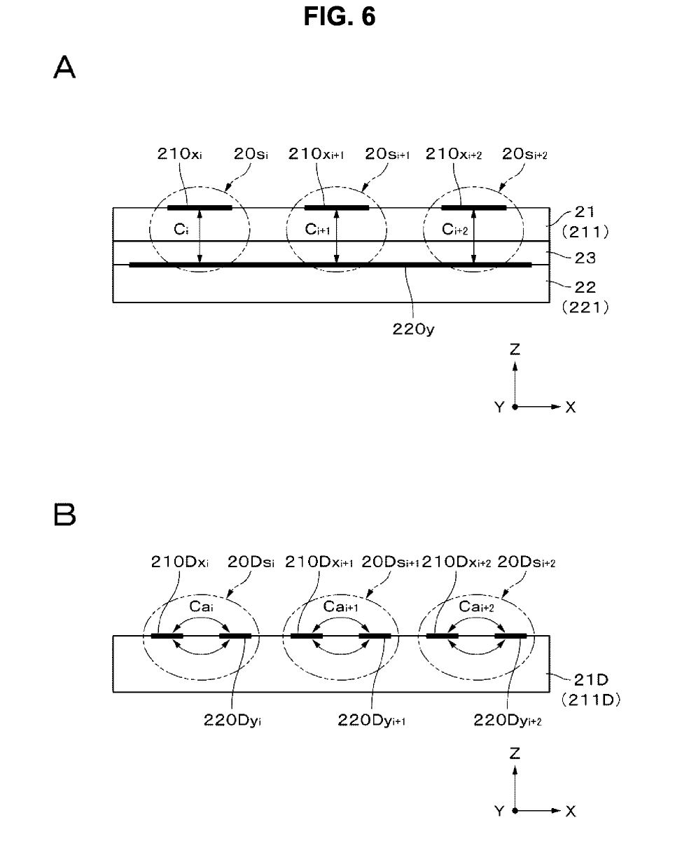

FIG. 6A is a schematic cross-sectional view for describing a configuration of the detection unit 20s. The detection unit 20s includes the first electrode line 210, the second electrode line 220 facing the first electrode line 210, and a capacity element that has a dielectric layer provided between the first and second electrode lines 210 and 220 and uses a mutual capacitance method. Also, it is described in FIGS. 6A and 6B that each of the first and second electrode lines 210 and 220 is configured as a single electrode line.

FIG. 6A illustrates an example in which the first electrode lines 210 (210xᵢ, 210xᵢ₊₁, and 210xᵢ₊₂) and the second electrode line 220 (220y) are arranged to face each other in the Z-axis direction. In the example illustrated in FIG. 6A, the first wiring substrate 21 and the second wiring substrate 22 are bonded to each other by the adhesive layer 23, and the first base material 211 of the first wiring substrate 21 and the adhesive layer 23 constitute the dielectric layer. In this case, the detection units 20sᵢ, 20sᵢ₊₁, and 20sᵢ₊₂ are configured to be formed in intersecting regions in which each of the first electrode lines 210xᵢ, 210xᵢ₊₁, and 210xᵢ₊₂ and the second electrode line 220y are capacitively coupled, and these electrostatic capacitances Cᵢ, Cᵢ₊₁, and Cᵢ₊₂ are changed according to capacitive coupling of each of the metal film 12 and the conductor layer 50 and the first electrode lines 210xᵢ, 210xᵢ₊₁, and 210xᵢ₊₂, and the second electrode line 220y. Also, an initial capacitance of the detection unit 20s is set by, for example, a facing area between the first and second electrode lines 210 and 220, a facing distance between the first and second electrode lines 210 and 220, and a dielectric constant of the adhesive layer 23.

In addition, FIG. 6B illustrates a modification of the configuration of the detection unit 20s and illustrates an example in which first electrode lines 210D (210Dxᵢ, 210Dxᵢ₊₁, and 210Dxᵢ₊₂) and the second electrode line 220D (220Dyᵢ, 220Dyᵢ₊₁, and 220Dyᵢ₊₂) are arranged inside the same plane on the first base material 211D and capacitively coupled inside the XY plane. In this case, for example, the first base material 211D forms a dielectric layer of detection units 20Ds (20Dsᵢ, 20Dsᵢ₊₁, and 20Dsᵢ₊₂). Even such an arrangement is configured such that electrostatic capacitances Caᵢ, Caᵢ₊₁, and Caᵢ₊₂ of the detection units 20Dsᵢ, 20Dsᵢ₊₁, and 20Dsᵢ₊₂ are changed according to capacitive coupling of each of the metal film 12 and the conductor layer 50 and the first and second electrode lines 210Dx and 220Dy. In addition, in the above configuration, the second base material 221 and the adhesive layer 23 are unnecessary, which can contribute to decreasing a thickness of the input device 100.

In the present embodiment, each of the plurality of detection units 20s may be arranged to face the first structural body 310 or the group including the first structural bodies 310 in the Z-axis direction, and alternatively, may be arranged to face the second structural body 410 or the group including the second structural bodies 410 in the Z-axis direction. In addition, in the present embodiment, while the first wiring substrate 21 is laminated to be above the second wiring substrate 22, the present disclosure is not limited thereto, but the second wiring substrate 22 may be laminated to be above the first wiring substrate 21.

### (Control Unit)

The control unit 60 is electrically connected to the electrode substrate 20. More specifically, the control unit 60 is connected to each of the plurality of first and second electrode lines 210 and 220 through a terminal. The control unit 60 includes a signal processing circuit capable of generating information (a signal) about an input operation with respect to the first surface 110 based on outputs of the plurality of detection units 20s. The control unit 60 obtains an amount of changes in capacitance of each of the detection units 20s while each of the plurality of detection units 20s is scanned at predetermined periods, and generates information (a signal) about the input operation based on the amount of change in capacitance.

Typically, the control unit 60 is configured as a computer including a CPU/MPU, a memory and the like. The control unit 60 may be configured as a single chip component or may be configured as a plurality of circuit components. The control unit 60 may also be mounted in the input device 100, or mounted in the electronic apparatus 70 in which the input device 100 is embedded. In the former case, for example, the control unit 60 is implemented on a flexible wiring substrate connected to the electrode substrate 20. In the latter case, the control unit 60 may be integrally formed with the controller 710 configured to control the electronic apparatus 70.

As described above, the control unit 60 includes the arithmetic operation unit 61 and the signal generating unit 62, and executes various functions according to a program stored in a storage unit (not illustrated). The arithmetic operation unit 61 computes an operation position in an XY coordinate system on the first surface 110 based on an electrical signal (input signal) output from each of the first and second electrode lines 210 and 220 of the electrode substrate 20. The signal generating unit 62 generates an operation signal based on the results. Accordingly, an image based on the input operation on the first surface 110 can be displayed on the flexible display 11.

The arithmetic operation unit 61 illustrated in FIGS. 3 and 4 computes XY coordinates of an operation position on the first surface 110 by an operant based on outputs from each of the detection units 20s to which unique XY coordinates are assigned. Specifically, the arithmetic operation unit 61 computes an amount of changes in electrostatic capacitance in each of the detection units 20s formed in each intersecting region between the X electrode 210 and the Y electrode 220 based on the amount of change in electrostatic capacitance obtained from each of the X electrode 210 and the Y electrode 220. According to a ratio of amounts of changes in electrostatic capacitance of the detection units 20s, it is possible to compute XY coordinates of the operation position by the operant.

In addition, the arithmetic operation unit 61 can determine whether the first surface 110 receives an operation. Specifically, for example, when an amount of changes in electrostatic capacitances of all of the detection units 20s or an amount of change in electrostatic capacitance of each of the detection units 20s is equal to or greater than a predetermined threshold value, it is possible to determine that the first surface 110 is receiving an operation. In addition, when two or more threshold values are provided, it is possible to distinguish, for example, a touch operation and an (intentional) push operation. Moreover, it is possible to compute a pressing force based on the amount of change in electrostatic capacitance of the detection unit 20s.

The arithmetic operation unit 61 can output these computation results to the signal generating unit 62.

The signal generating unit 62 generates a predetermined operation signal based on the computation result of the arithmetic operation unit 61. The operation signal may be, for example, an image control signal for generating a display image to be output to the flexible display 11, an operation signal corresponding to a key of a keyboard image to be displayed at an operation position on the flexible display 11, or an operation signal related to an operation corresponding to a graphical user interface (GUI).

Here, the input device 100 includes the first and second supports 30 and 40 as a configuration that causes a change in distances of each of the metal film 12 and the conductor layer 50 from the electrode substrate 20 (the detection unit 20s) according to an operation on the first surface 110. Hereinafter, the first and second supports 30 and 40 will be described.

### (Basic Configuration of First and Second Supports)

The first support 30 is arranged between the operation member 10 and the electrode substrate 20. The first support 30 includes the plurality of first structural bodies 310, the first frame 320, and the first space portion 330. In the present embodiment, the first support 30 is bonded on the electrode substrate 20 through an adhesive layer 35 (refer to FIG. 3). The adhesive layer 35 may be an adhesive, and may be configured as a pressure sensitive adhesive material such as a pressure sensitive adhesive tape.

As illustrated in FIG. 3, the first support 30 according to the present embodiment has a structure in which a base material 31, a structure layer 32 provided on a surface (upper surface) of the base material 31, and a plurality of bonding units 341 formed at predetermined positions on the structure layer 32 are laminated. The base material 31 is configured as an electrically insulating plastic sheet such as PET, PEN, or PC. A thickness of the base material 31 is not particularly limited, and is, for example, several μm to several 100 μm.

The structure layer 32 is made of a resin material having an electrically insulating property such as a UV resin, and a plurality of first convex portions 321, second convex portions 322, and concave portions 323 are formed on the base material 31. The first convex portions 321 have a shape that protrudes in the Z-axis direction, for example, a columnar shape, a prismatic shape, or a truncated cone shape, and are arranged on the base material 31 at predetermined intervals. The second convex portions 322 are formed to surround the periphery of the base material 31 at predetermined widths.

In addition, the structure layer 32 is made of a material that has relatively high rigidity at which the electrode substrate 20 is deformable according to an input operation on the first surface 110, or may be made of an elastic material that is deformable together with the operation member 10 when the input operation is performed. That is, a modulus of elasticity of the structure layer 32 is not particularly limited, but is appropriately selected in a range in which a desired operation feeling or detection sensitivity is obtained.

The concave portion 323 is configured as a flat surface formed between the first and second convex portions 321 and 322. That is, a space region on the concave portion 323 forms the first space portion 330. In addition, an adhesion prevention layer made of a UV resin having low pressure sensitive adhesion or the like may be formed on the concave portion 323 (not illustrated in FIG. 3). A shape of the adhesion prevention layer is not particularly limited, but it may be formed in an island shape and formed as a flat film on the concave portion 323.

Further, the bonding unit 341 made of a resin material having pressure sensitive adhesion or the like is formed on each of the first and second convex portions 321 and 322. That is, each of the first structural bodies 310 is configured as a laminated body of the first convex portion 321 and the bonding unit 341 formed thereon. Each of the first frames 320 is configured as a laminated body of the second convex portion 322 and the bonding unit 341 formed thereon. Accordingly, the first structural body 310 and the first frame 320 have substantially the same thickness (height), for example, several μm to several 100 μm in the present embodiment. Also, the height of the adhesion prevention layer is not particularly limited as long as it is smaller than the height of the first structural body 310 and the first frame 320, and is, for example, smaller than the first and second convex portions 321 and 322.

The plurality of first structural bodies 310 are arranged, for example, to correspond to the arrangement of the detection unit 20s or the unit detection region to be described below. In the present embodiment, the plurality of first structural bodies 310 are arranged to face, for example, the plurality of detection units 20s or the unit detection region to be described below in the Z-axis direction.

On the other hand, the first frame 320 is formed to surround the periphery of the first support 30 along a circumference of the electrode substrate 20. A length of the first frame 320 in a lateral direction, that is, a width, is not particularly limited as long as strength of the first support 30 and the entire input device 100 can be sufficiently ensured.

Meanwhile, the second support 40 is arranged between the electrode substrate 20 and the conductor layer 50. The second support 40 includes the plurality of second structural bodies 410, a second frame 420, and the second space portion 430.

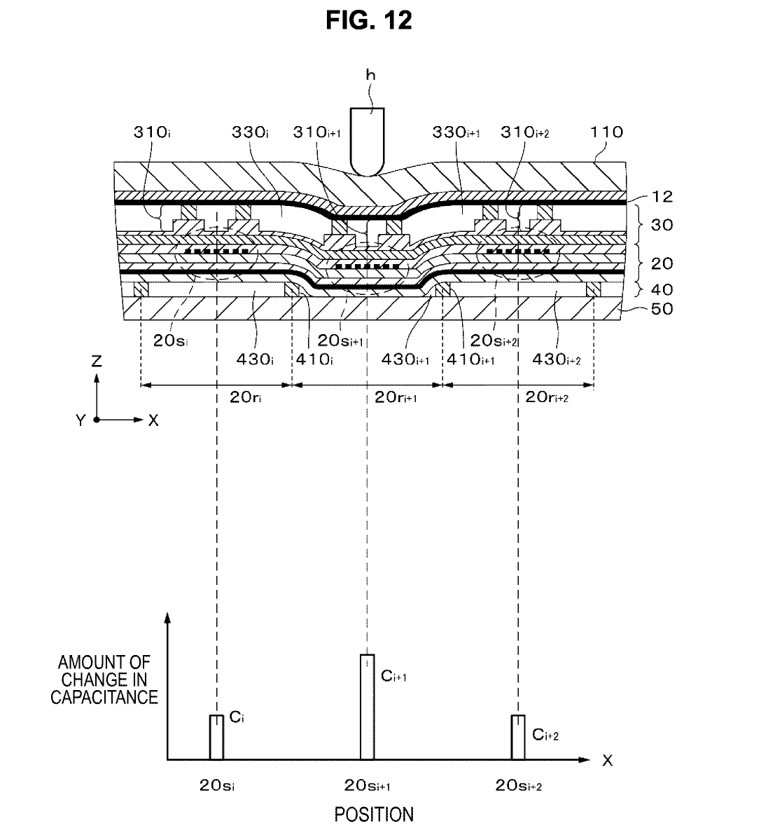

As illustrated in FIG. 3, the second support 40 according to the present embodiment includes the second structural body 410 and the second frame 420, which are directly formed on the conductor layer 50. The second structural body 410 and the second frame 420 are made of, for example, an insulating resin material having pressure sensitive adhesion, and also function as a bonding unit configured to bond the conductor layer 50 and the electrode substrate 20. A thickness of the second structural body 410 and the second frame 420 is not particularly limited, and is, for example, several μm to several 100 μm. Also, it is preferable that the thickness of the second structural body 410 be smaller than the thickness of the first structural body 310. Therefore, the electrode substrate 20 is deformed to be closer to the bottom of the conductor layer 50 and a great amount of change in capacitance is obtained, as illustrated in FIG. 12 below.

The second structural body 410 is arranged to correspond to the arrangement of each of the detection units 20s, and is arranged, for example, between the adjacent detection units 20s. The second structural body 410 may be arranged between the adjacent first structural bodies 310. On the other hand, the second frame 420 is formed to surround the periphery of the second support 40 along a circumference of the conductor layer 50. A width of the second frame 420 is not particularly limited as long as it can sufficiently ensure strength of the second support 40 and the entire input device 100, and is, for example, substantially the same as the width of the first frame 320.

In addition, similar to the structure layer 32 forming the first structural body 310, a modulus of elasticity of the second structural body 410 is not particularly limited. That is, the modulus of elasticity is appropriately selected in a range in which a desired operation feeling or detection sensitivity is obtained, and the second structural body 410 may be made of an elastic material that is deformable together with the electrode substrate 20 when the input operation is performed.

In addition, the second space portion 430 is formed between the second structural bodies 410 and forms a space region of peripheries of the second structural body 410 and the second frame 420. The second space portion 430 accommodates each of the detection units 20s and at least a part of the first structural body 310, for example, when viewed in the Z-axis direction.

The first and second supports 30 and 40 having the configuration described above are formed as follows.

### (Method of Forming First and Second Supports)

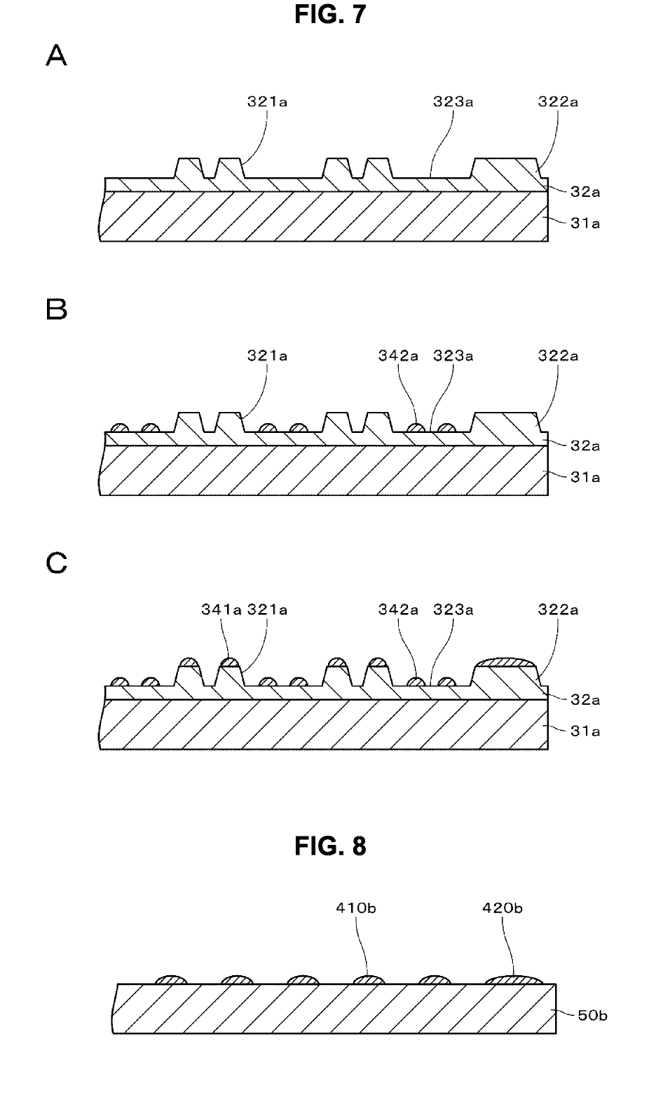

FIGS. 7A, 7B, and 7C are schematic cross-sectional views illustrating exemplary methods of forming the first support 30. First, a UV resin is arranged on the base material 31a, and a predetermined pattern is formed in the resin. Accordingly, as illustrated in FIG. 7A, the structure layer 32a including a plurality of first and second convex portions 321a and 322a and concave portions 323a is formed. As the UV resin, a solid sheet material or a liquid UV curable material may be used. In addition, a method of forming a pattern is not particularly limited. For example, a method in which an uneven shape pattern of a mold is transferred to the UV resin by a roll-shaped mold in which a pattern of a predetermined uneven shape is formed, UV light is radiated from the base material 31a side, and the UV resin is cured may be applied. In addition, other than the formation using the UV resin, the pattern may be formed by, for example, general thermoforming (for example, press molding or injection molding), or discharging a resin material using a dispenser or the like.

Next, as illustrated in FIG. 7B, a low adhesion UV resin or the like is applied on the concave portion 323a in a predetermined pattern by, for example, a screen printing method, and an adhesion prevention layer 342a is formed. Accordingly, for example, when a resin material forming the structure layer 32a has high adhesiveness, it is possible to prevent the metal film 12 and the concave portion 323 arranged on the first support 30 from being adhered. Also, when a resin material forming the structure layer 32a has low adhesiveness, no adhesion prevention layer 342a may be formed.

Next, as illustrated in FIG. 7C, the bonding unit 341a made of a high adhesion UV resin is formed on the convex portion 321a by, for example, a screen printing method. The first support 30 and the metal film 12 are bonded by the bonding unit 341a. By the above forming method, it is possible to form the first structural body 310 and the first frame 320 having a desired shape.

On the other hand, FIG. 8 is a schematic cross-sectional view illustrating an exemplary method of forming the second support 40. In FIG. 8, a high adhesion UV resin is directly applied on the conductor layer 50b in a predetermined pattern by, for example, a screen printing method, and the second structural body 410b and the second frame 420b are formed. Accordingly, it is possible to significantly decrease the number of processes and increase productivity.

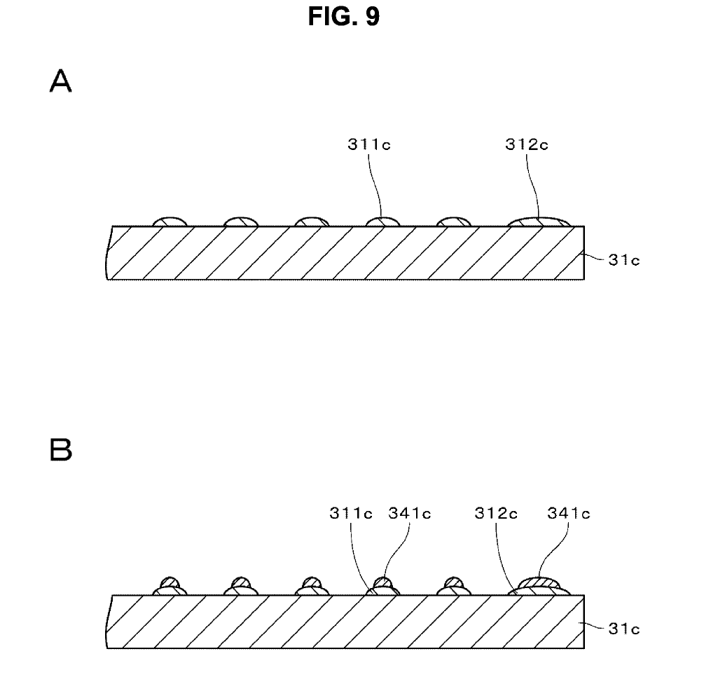

The above forming method is an example. For example, the first support 30 may be formed by the method illustrated in FIG. 8, and the second support 40 may be formed by the method illustrated in FIG. 7. In addition, the first and second supports 30 and 40 may be formed by the following method illustrated in FIG. 9.

FIGS. 9A and 9B are schematic cross-sectional views illustrating modifications of the method of forming the first and second supports 30 and 40. Also, description of FIG. 9 will refer to reference numerals of the first support 30. In FIG. 9A, the UV resin or the like is applied onto the base material 31C or the like in a predetermined pattern by, for example, a screen printing method, and a first convex portion 311c and a second convex portion 312c are formed. Further, the bonding unit 341c made of a high adhesion UV resin or the like is formed on the first convex portion 311c and the second convex portion 312c by, for example, a screen printing method. Accordingly, it is possible to form the first structural body 310 (the second structural body 410) including the first convex portion 311c and the bonding unit 341c and the first frame 320 (or the second frame 420) including the second convex portion 312c and the bonding unit 341c.

### (First and Second Electrode Lines)

FIG. 10A is a schematic diagram illustrating an arrangement example of the first and second electrode lines 210 and 220. The first electrode line 210 is a Y electrode that extends in the Y-axis direction and is provided in a stripe shape. The second electrode line 220 is an X electrode that extends in the X-axis direction and is provided in a stripe shape. The first electrode line 210 and the second electrode line 220 are arranged orthogonally to each other.

FIG. 10B is a schematic diagram illustrating one exemplary configuration of the first and second electrode lines 210 and 220. The first electrode line 210 may be configured as the electrode group 21w that includes a group of a plurality of first electrode elements 21z. The first electrode element 21z is a linear conductive member (sub-electrode) that extends in, for example, the Y-axis direction. The second electrode line 220 may be configured as the electrode group 22w that includes a group of a plurality of second electrode elements 22z. The second electrode element 22z is a linear conductive member (sub-electrode) that extends in, for example, the X-axis direction.

FIG. 10C is a schematic diagram describing the unit detection region 20r. The plurality of unit detection regions 20r are provided to correspond to respective intersecting sections between the first and second electrode lines 210 and 220. The plurality of unit detection regions 20r are two-dimensionally packed and arranged in, for example, the X-axis direction (first direction) and the Y-axis direction (second direction). The unit detection region 20r has, for example, a square shape or a rectangular shape that has a pair of sides extending in the X-axis direction and a pair of sides extending in the Y-axis direction. When the unit detection region 20r has the square shape or the rectangular shape, the packing arrangement of the plurality of unit detection regions 20r is a packing arrangement in a grid shape (matrix form).

The plurality of second structural bodies 410 are arranged, for example, between the adjacent unit detection regions 20r. That is, the plurality of second structural bodies 410 are arranged on, for example, the outer circumference (circumference) of the unit detection region 20r. In addition, the plurality of second structural bodies 410 are arranged, for example, symmetrically with respect to a center of the unit detection region 20r. When the unit detection region 20r has the square shape or the rectangular shape, an arrangement position of the second structural body 410 is preferably a midpoint of each side forming the unit detection region 20r and both positions of each vertex (corner) of the unit detection region 20r, more preferably a position of a midpoint of each side forming the unit detection region 20r, and most preferably a position of each vertex (corner) of the unit detection region 20r. Therefore, according to this arrangement position, it is possible to increase detection sensitivity of the input operation. FIG. 10C illustrates an example in which the second structural bodies 410 are arranged at respective vertices (corners) of the unit detection region 20r.

Two or more first structural bodies 310 are included in the unit detection region 20r. In the present disclosure, the description that “the first structural body 310 is included” is not limited to a case in which the entire first structural body 310 is included but also includes partial inclusion of the first structural body 310. For example, when the first structural body 310 is arranged on the outer circumference (circumference) of the unit detection region 20r, a part (for example, halves or quarters) of the single first structural body 310 arranged on the outer circumference inside the focusing unit detection region 20r with respect to the outer circumference as a boundary is counted as the number of first structural bodies 310. Also, descriptions such as “including the first structural body 310” are used with the same meaning.

### (Operation of First and Second Supports)

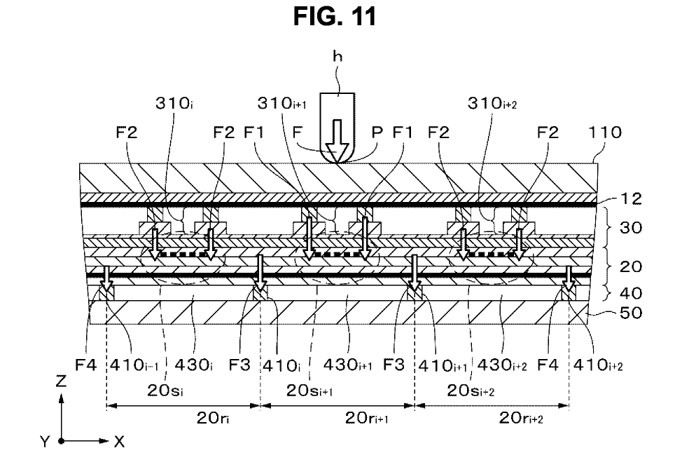

FIG. 11 is a schematic cross-sectional view illustrating a state of a force applied to the first and second structural bodies 310 and 410 when an operant h presses a point P on the first surface 110 downward, i.e., in a Z-axis direction. A white arrow in the drawing schematically indicates a magnitude of a downward force in the Z-axis direction (hereinafter simply referred to as “downward”). Aspects of deflection of the metal film 12 and the electrode substrate 20 and elastic deformation of the first and second structural bodies 310 and 410 are not illustrated in FIG. 11. Also, in the following description, even when the user performs a touch operation with no awareness that he or she is applying pressure, since a minute pressing force is actually applied, such input operations are collectively described as “pressing.”

For example, when a position P1 corresponding to the center of the unit detection region 20r within the first surface 110 is pressed downward with a force F of the operant h, the metal film 12 directly below the point P is deflected downward. According to this deflection, the first structural body 310ᵢ₊₁ arranged in the unit detection region 20r receives a force F1 and is elastically deformed in the Z-axis direction, and the thickness thereof slightly decreases. In addition, according to the deflection of the metal film 12, the first structural bodies 310ᵢ and 310ᵢ₊₂ adjacent to the first structural body 310ᵢ₊₁ also receive a force F2 that is smaller than F1. Moreover, due to the forces F1 and F2, a force is also applied to the electrode substrate 20, and the detection unit 20sᵢ₊₁ directly below the first structural body 310ᵢ₊₁ is displaced downward. Accordingly, the detection unit 20sᵢ₊₁ and the conductor layer 50 become closer or come in contact. In addition, the second structural body 410ᵢ arranged between the first structural bodies 310ᵢ and 310ᵢ₊₁ and the second structural body 410ᵢ₊₁ arranged between the first structural bodies 310ᵢ₊₁ and 310ᵢ₊₂ also receive a force F3 that is smaller than F1 and are elastically deformed in the Z-axis direction, and the thicknesses thereof slightly decrease. In addition, the second structural body 410ᵢ₋₁ adjacent to the second structural body 410ᵢ through the second space portion 430ᵢ and the second structural body 410ᵢ₊₂ adjacent to the second structural body 410ᵢ₊₁ through the second space portion 430ᵢ₊₂ receive F4 that is smaller than F3.

In this manner, it is possible to transmit a force in a thickness direction with the first and second structural bodies 310 and 410, and easily deform the electrode substrate 20. In addition, when the metal film 12 and the electrode substrate 20 are deflected and an influence of the pressing force is provided in the planar direction (a direction parallel to the X-axis direction and the Y-axis direction), it is possible to apply a force to not only a region directly below the operant h but also the first and second structural bodies 310 and 410 in the vicinity thereof.

In addition, the metal film 12 and the electrode substrate 20 can be easily deformed by the first and second space portions 330 and 430. Further, because the first and second structural bodies 310 and 410 have a columnar body or the like, it is possible to apply a high pressure to the electrode substrate 20 according to the pressing force of the operant h and efficiently deflect the electrode substrate 20.

Moreover, when the first and second structural bodies 310 and 410 are arranged such that they do not overlap when viewed in the Z-axis direction, the first structural body 310 can easily deflect the electrode substrate 20 toward the conductor layer 50 through the second space portion 430 therebelow.

Hereinafter, exemplary amounts of changes in electrostatic capacitance of the detection unit 20s when a specific operation is performed will be described.

### Output Example of Detection Unit

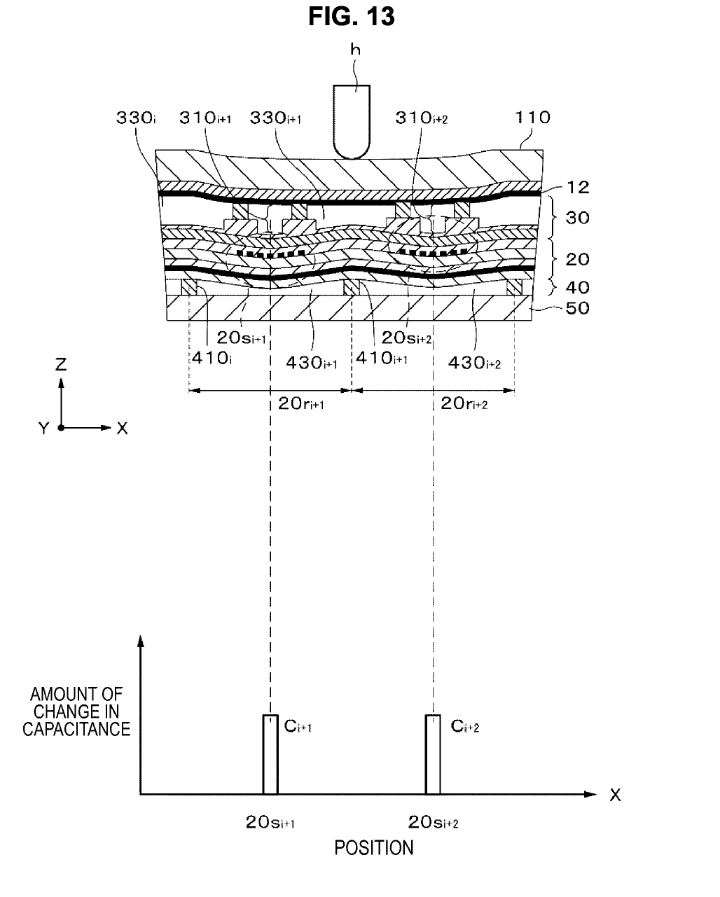

FIGS. 12 and 13 are schematic main part cross-sectional views illustrating aspects of the input device 100 when the first surface 110 receives an operation from the operant h, and are diagrams illustrating exemplary amounts of changes in capacitance of the respective detection units 20s at that time. Bar graphs illustrated along the X axis in FIGS. 12 and 13 schematically illustrate amounts of changes in electrostatic capacitance from a reference value in the respective detection units 20s. In addition, FIG. 12 illustrates an aspect when the operant h presses a position corresponding to the center of the unit detection region 20r. FIG. 13 illustrates an aspect when a position corresponding to a middle point between the unit detection region 20r and the adjacent unit detection region 20r is pressed.

In FIG. 12, the first structural body 310ᵢ₊₁ arranged in the unit detection region 20r directly below the operation position receives the greatest force, and the first structural body 310ᵢ₊₁ itself is elastically deformed and displaced downward. According to this displacement, the detection unit 20sᵢ₊₁ directly below the first structural body 310ᵢ₊₁ is displaced downward. Accordingly, the detection unit 20sᵢ₊₁ and the conductor layer 50 become closer or come in contact through the second space portion 430ᵢ₊₁. That is, a distance between the detection unit 20sᵢ₊₁ and the metal film 12 is slightly changed, a distance between the detection unit 20sᵢ₊₁ and the conductor layer 50 is greatly changed, and thus an amount of change in electrostatic capacitance Cᵢ₊₁ is obtained. On the other hand, according to an influence of deflection of the metal film 12, the first structural bodies 310ᵢ and 310ᵢ₊₂ are also slightly displaced downward, and amounts of changes in electrostatic capacitance in the detection units 20sᵢ and 20sᵢ₊₂ are Cᵢ and Cᵢ₊₂, respectively.

In the example illustrated in FIG. 12, Cᵢ₊₁ is the greatest, and Cᵢ and Cᵢ₊₂ are substantially the same and smaller than Cᵢ₊₁. That is, as illustrated in FIG. 12, amounts of changes in electrostatic capacitances Cᵢ, Cᵢ₊₁, and Cᵢ₊₂ illustrate a mountain-shaped distribution having Cᵢ₊₁ as an apex. In this case, the arithmetic operation unit 61 can compute a center of gravity based on a ratio of Cᵢ, Cᵢ₊₁, and Cᵢ₊₂, and compute XY coordinates on the detection unit 20sᵢ₊₁ as the operation position.

On the other hand, in FIG. 13, according to deflection of the metal film 12, the first structural bodies 310ᵢ₊₁ and 310ᵢ₊₂ in the vicinity of the operation position are slightly elastically deformed and displaced downward. According to this displacement, the electrode substrate 20 is deflected, and the detection units 20sᵢ₊₁ and 20sᵢ₊₂ directly below the first structural bodies 310ᵢ₊₁ and 310ᵢ₊₂ are displaced downward. Accordingly, the detection units 20sᵢ₊₁ and 20sᵢ₊₂ and the conductor layer 50 become closer or come in contact through the second space portions 430ᵢ₊₁ and 430ᵢ₊₂. That is, a distance between the detection units 20sᵢ₊₁ and 20sᵢ₊₂ and the metal film 12 is slightly changed, a distance between the detection units 20sᵢ₊₁ and 20sᵢ₊₂ and the conductor layer 50 is relatively greatly changed, and thus amounts of changes in electrostatic capacitances Cᵢ₊₁ and Cᵢ₊₂ are obtained.

In the example illustrated in FIG. 13, Cᵢ₊₁ and Cᵢ₊₂ are substantially the same. Accordingly, the arithmetic operation unit 61 can compute XY coordinates between the detection units 20sᵢ₊₁ and 20sᵢ₊₂ as the operation position.

In this manner, according to the present embodiment, since both thicknesses of the detection unit 20s and the metal film 12, and the detection unit 20s and the conductor layer 50 are variable according to the pressing force, it is possible to further increase the amount of change in electrostatic capacitance in the detection unit 20s. Accordingly, it is possible to increase detection sensitivity of the input operation.

In addition, regardless of whether the operation position on the flexible display 11 is on the first structural body 310 or the first space portion 330, it is possible to compute XY coordinates of the operation position. That is, when the metal film 12 spreads an influence of the pressing force in the planar direction, it is possible to cause a change in electrostatic capacitance in not only the detection unit 20s directly below the operation position but also in the detection unit 20s in the vicinity of the operation position when viewed in the Z-axis direction. Accordingly, it is possible to suppress a variation of detection accuracy in the first surface 110 and maintain high detection accuracy in the entire surface of the first surface 110.

Here, as an object that is commonly used as the operant, a finger, a stylus and the like are exemplified. Both have the following characteristics. Since the finger has a larger contact area than the stylus, when the same load (the same pressing force) is applied, the finger has a smaller pressure (hereinafter referred to as an “operation pressure”) with respect to the pressing force. On the other hand, the stylus has a smaller contact area and has a problem in that, for example, in an electrostatic capacitance sensor using a general mutual capacitance method, capacitive coupling with a sensor element decreases and detection sensitivity decreases. According to the present embodiment, regardless of which of these operants is used, it is possible to detect the input operation with high accuracy. Hereinafter, descriptions will be provided with reference to FIGS. 14 and 15.

FIGS. 14 and 15 are schematic main part cross-sectional views illustrating aspects of the input device 100 when the first surface 110 receives an operation from the stylus or the finger and are diagrams illustrating exemplary amounts of changes in capacitance in the respective detection units 20s at that time. FIG. 14 illustrates a case in which the operant is the stylus s. FIG. 15 illustrates a case in which the operant is the finger f. In addition, similar to FIGS. 12 and 13, bar graphs illustrated along the X axis in FIGS. 14 and 15 schematically illustrate amounts of changes in electrostatic capacitance from a reference value in the respective detection units 20s.

As illustrated in FIG. 14, the stylus s deforms the metal film 12 and applies the pressing force to the first structural body 310ᵢ₊₁ directly below the operation position. Here, since the stylus s has a small contact area, it is possible to apply a high operation pressure to the metal film 12 and the first structural body 310ᵢ₊₁. Therefore, the metal film 12 can be greatly deformed. As a result, as illustrated in the amount of change in the electrostatic capacitance Cᵢ₊₁ of the detection unit 20sᵢ₊₁, it is possible to cause a great amount of change in electrostatic capacitance. Accordingly, amounts of changes in electrostatic capacitances Cᵢ, Cᵢ₊₁, and Cᵢ₊₂ of the detection units 20sᵢ, 20s₊₁, and 20sᵢ₊₂ form a mountain-shaped distribution having Cᵢ₊₁ as an apex.

In this manner, the input device 100 according to the present embodiment can detect an amount of change in electrostatic capacitance based on a planar distribution of the operation pressure. This is because the input device 100 does not detect an amount of change in electrostatic capacitance by direct capacitive coupling with the operant but detects an amount of change in electrostatic capacitance through the deformable metal film 12 and the electrode substrate 20. Therefore, even when the operant such as the stylus s having a small contact area is used, it is possible to detect the operation position and the pressing force with high accuracy.

On the other hand, as illustrated in FIG. 15, since the finger f has a large contact area and thus the operation pressure decreases, the finger f can directly deform a wider range of the metal film 12 than the stylus s. Accordingly, the first structural bodies 310ᵢ, 310ᵢ₊₁, and 310ᵢ₊₂ are displaced downward, and amounts of changes in the electrostatic capacitances Cᵢ, Cᵢ₊₁ and Cᵢ₊₂ of the detection units 20sᵢ, 20sᵢ₊₁, and 20sᵢ₊₂ can be generated, respectively. Cᵢ, Cᵢ₊₁, and Cᵢ₊₂ form a gentler mountain-shaped distribution than Cᵢ, Cᵢ₊₁, and Cᵢ₊₂ in FIG. 14.

(Reason for which Two or More First Structural Bodies are Included in the Unit Detection Region)

In the input device 100 according to the present embodiment, two or more first structural bodies 310 are included in the unit detection region 20r. Hereinafter, the reason for which the two or more first structural bodies 310 are included in the unit detection region 20r will be described.

Here, when the first structural body 310 is arranged on the outer circumference (circumference) of the unit detection region 20r, a part of the single first structural body 310 inside the focusing unit detection region 20r with respect to the outer circumference as a boundary is counted as the number of first structural bodies 310. Specifically, for example, when the first structural bodies 310 are arranged to be divided into two on a side of the unit detection region 20r, the number of first structural bodies 310 is defined as “½.” In addition, when the first structural body 310 is arranged in a vertex (corner) of the unit detection region 20r having a square shape or a rectangular shape, the number of first structural bodies 310 is defined as “¼.”

### (Relation Between Load Position and Amount of Change in Capacitance)

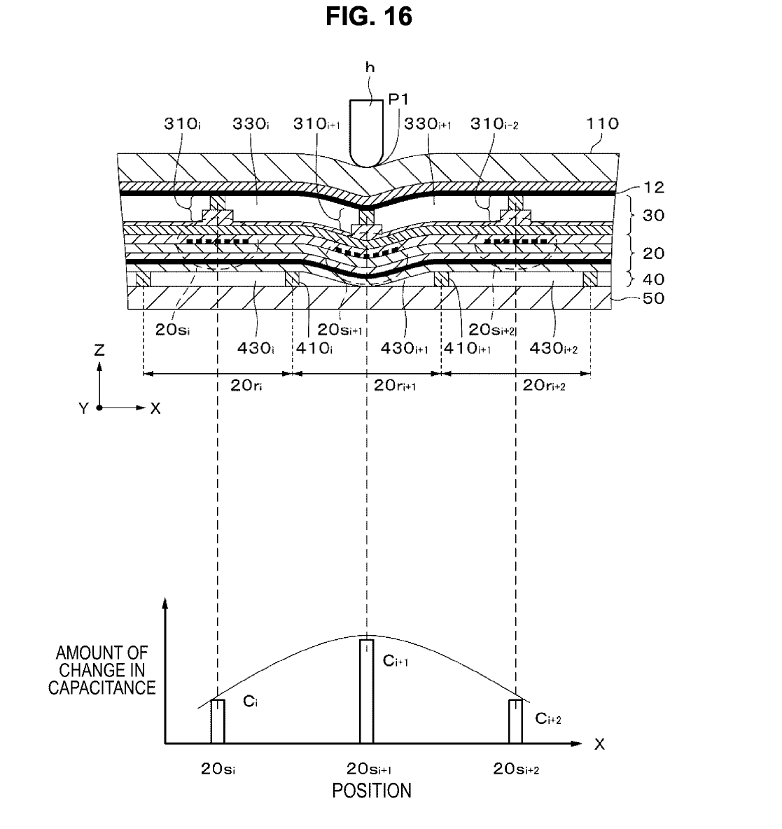

Hereinafter, a relation between a load position and an amount of change in capacitance in the input device 100 in which the one first structural body 310 is included in the unit detection region 20r will be described with reference to FIGS. 16 to 18.

First, as illustrated in FIG. 16, when a position P1 corresponding to a center of the unit detection region 20rᵢ₊₁ within the first surface 110 is pressed by the operant h, an increase in the amount of change in the capacitance Cᵢ₊₁ is greatest, and amounts of changes in the capacitance Cᵢ and Cᵢ₊₂ increase substantially equally.

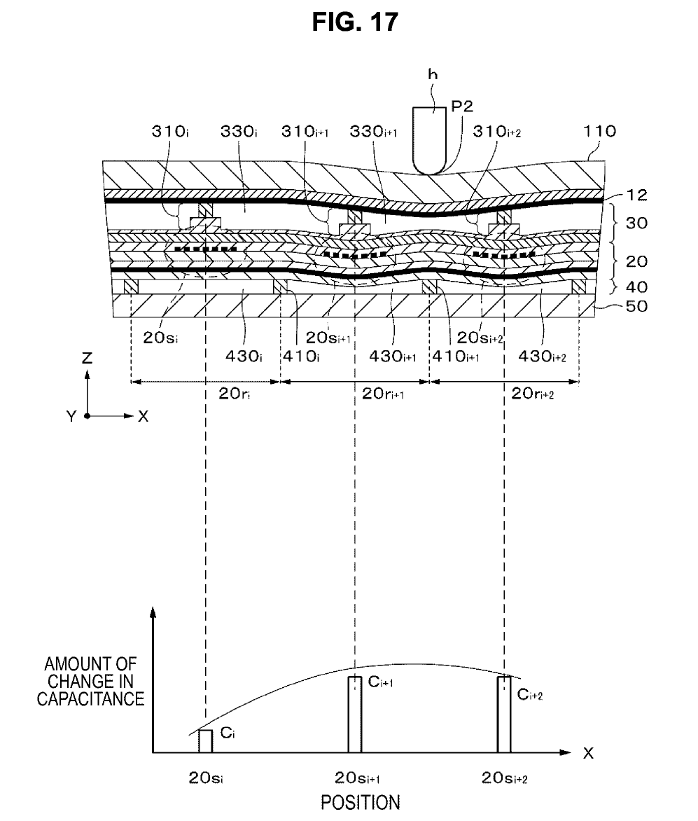

Next, as illustrated in FIG. 17, when the operant h (that is, a load) moves from the position P1 to a position P2 in the vicinity between the unit detection regions 20rᵢ₊₁ and 20rᵢ₊₂, the amounts of changes in the capacitances Cᵢ, and Cᵢ₊₁ decrease, and the amount of change in the capacitance Cᵢ₊₂ increases. Accordingly, the amounts of changes in the capacitances Cᵢ₊₁ and Cᵢ₊₂ are about the same.

Next, as illustrated in FIG. 18, when the operant h (that is, a load) moves from the position P2 to a position P3 corresponding to a center of the unit detection region 20rᵢ₊₂, the amount of change in the capacitance Cᵢ₊₂ further increases, whereas the amounts of changes in the capacitances Cᵢ and Cᵢ₊₁ further decrease. Accordingly, the amount of change in the capacitance Cᵢ₊₂ is greatest, the amount of change in the capacitance Cᵢ among Cᵢ, Cᵢ₊₁, and Cᵢ₊₂ is smallest, and the amount of change in the capacitance Cᵢ₊₁ is an intermediate value of these amounts of changes in the capacitances Cᵢ and Cᵢ₊₂.

### (Occurrence of Deviation of Coordinate Calculation and Reason Therefor)

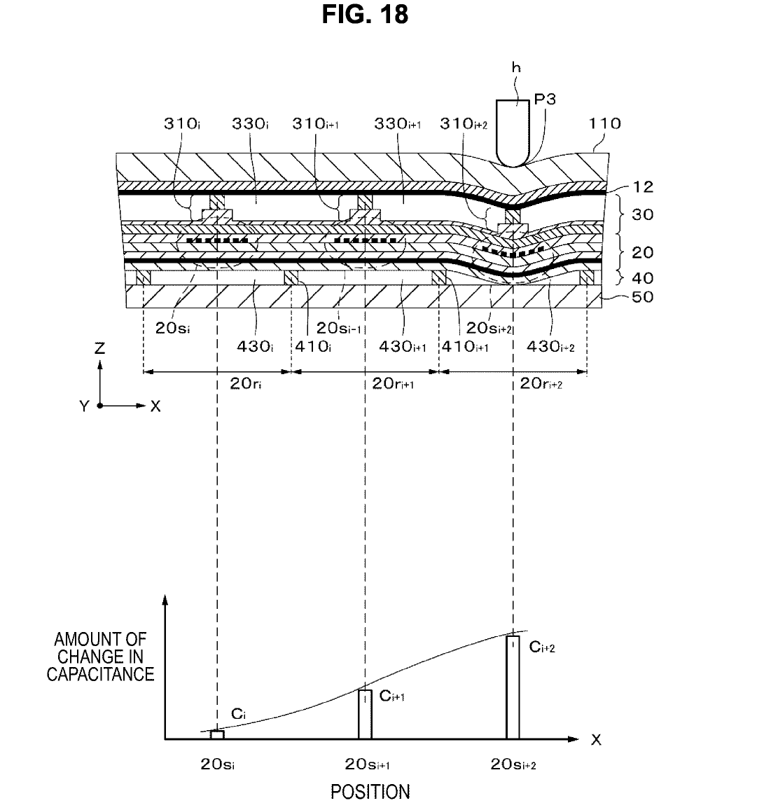

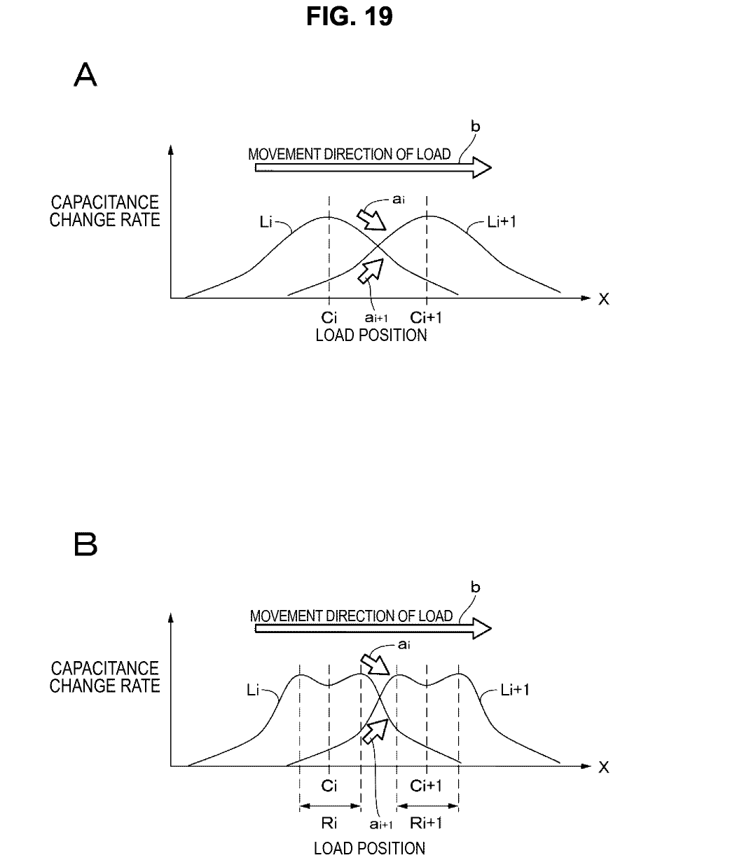

FIG. 19A is a diagram illustrating an ideal capacitance change rate distribution. In FIG. 19A, Cᵢ, and Cᵢ₊₁ indicate center positions of the unit detection regions 20rᵢ and 20rᵢ₊₁ (the detection units 20sᵢ and 20sᵢ₊₁), respectively. In addition, Lᵢ and Lᵢ₊₁ indicate capacitance change rate distributions of the unit detection regions 20rᵢ and 20rᵢ₊₁ (the detection units 20sᵢ and 20sᵢ₊₁) in the X-axis direction, respectively.

As indicated by an arrow b of FIG. 19A, when a load applied to the first surface 110 of the input device 100 is moved from a center position Cᵢ to a center position Cᵢ₊₁ (refer to FIGS. 16 to 18), the following tendency is ideal. That is, the tendency in which a capacitance change rate of the detection unit 20sᵢ₊₁ monotonically increases as indicated by an arrow aᵢ₊₁ whereas a capacitance change rate of the detection unit 20sᵢ monotonically decreases as indicated by an arrow aᵢ is ideal.

However, in the input device 100 in which the one first structural body 310 is included in the unit detection region 20r, a capacitance change rate distribution does not have the ideal distribution illustrated in FIG. 19A but has a distribution illustrated in FIG. 19B. That is, in the center positions Cᵢ and Cᵢ₊₁ of the unit detection regions 20rᵢ and 20rᵢ₊₁, two split peaks are shown around the center positions Cᵢ and Cᵢ₊₁, rather than one peak shown in the capacitance change rate distribution. In this manner, regions Rᵢ and Rᵢ₊₁ between two split peaks cause a deviation of coordinate calculation.

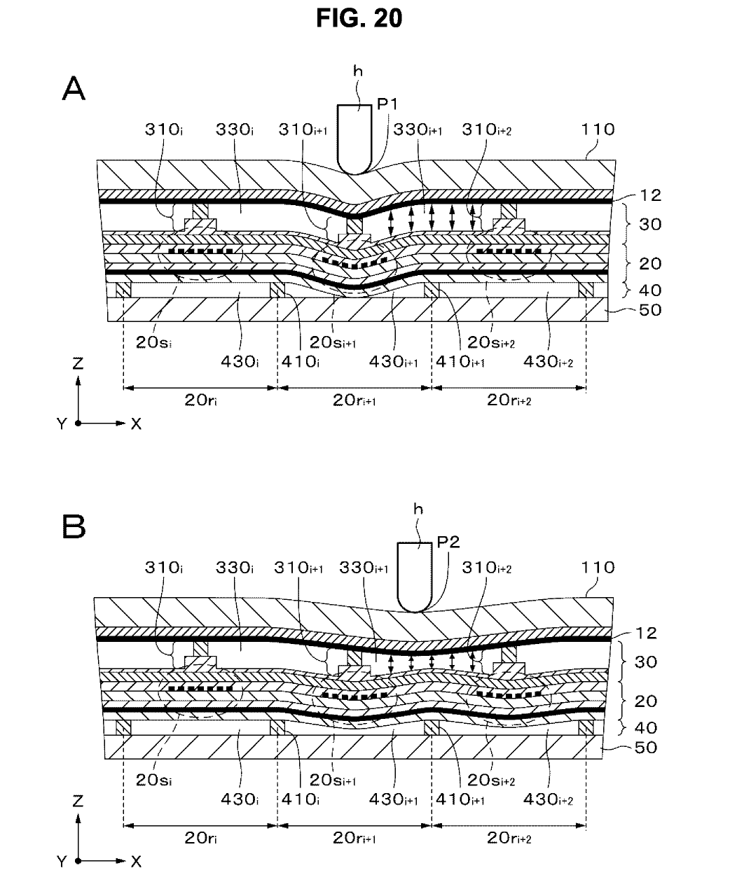

Here, a reason for which the above-described two split peaks occur will be described below with reference to FIGS. 20A and 20B. As illustrated in FIG. 20A, when the position P1 corresponding to the center of the unit detection region 20rᵢ₊₁ within the first surface 110 is pressed by the operant h, the metal film 12 and the electrode substrate 20 are deformed in substantially the same shape. Accordingly, even when pressed, a distance between the metal film 12 and the electrode substrate 20 is substantially constant. On the other hand, as illustrated in FIG. 20B, when the position P2 in the vicinity between the unit detection regions 20rᵢ₊₁ and 20rᵢ₊₂ within the first surface 110 is pressed by the operant h, only the metal film 12 in the vicinity of the pressed position P2 is greatly deformed. Accordingly, when pressed, only a distance between the metal film 12 and the electrode substrate 20 in the vicinity of the pressed position P2 is greatly changed. As a result, in the capacitance change rate distribution, as described above, one peak occurs at both sides of the center position Cᵢ of the detection unit 20sᵢ.

### (Improvement of Accuracy of Coordinate Calculation)

In the input device 100 according to the present embodiment, in order to prevent the above-described two split peaks from occurring, the plurality of first structural bodies 310 are arranged in the unit detection region 20r.

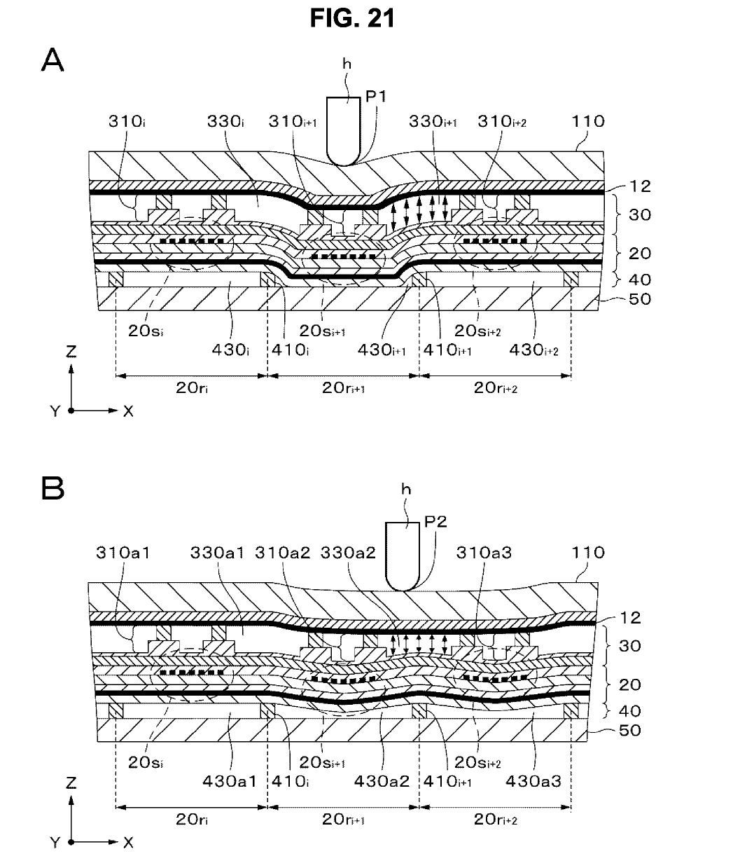

Here, the reason for which improvement in accuracy of coordinate calculation is possible when the plurality of first structural bodies 310 are arranged in the unit detection region 20r will be described with reference to FIGS. 21A and 21B. As illustrated in FIG. 21A, when the position P1 corresponding to the center of the unit detection region 20rᵢ₊₁ within the first surface 110 is pressed by the operant h, the metal film 12 and the electrode substrate 20 are deformed in substantially the same shape. Accordingly, even when pressed, a distance between the metal film 12 and the electrode substrate 20 is substantially constant. On the other hand, as illustrated in FIG. 21B, when the position P2 in the vicinity between the unit detection regions 20rᵢ₊₁ and 20rᵢ₊₂ within the first surface 110 is pressed by the operant h, the metal film 12 in the vicinity of the pressed position P2 is deformed only slightly downward. Accordingly, even when pressed, a great amount of change in only a distance between the metal film 12 and the electrode substrate 20 in the vicinity of the pressed position P2 is suppressed. This is because deformation of the metal film 12 in the vicinity of the pressed position P2 is suppressed due to an influence of the plurality of first structural bodies 310ᵢ₊₁, 310ᵢ₊₂ arranged in the unit detection regions 20rᵢ₊₁ and 20rᵢ₊₂. A great amount of change in a local distance is suppressed in this manner. As a result, an ideal capacitance change rate distribution in which the rate monotonically decreases from the center of the unit detection region 20r is obtained, as illustrated in FIG. 19A.

### Arrangement Example of First and Second Structural Bodies

Next, a planar arrangement of the first and second structural bodies 310 and 410 will be described.

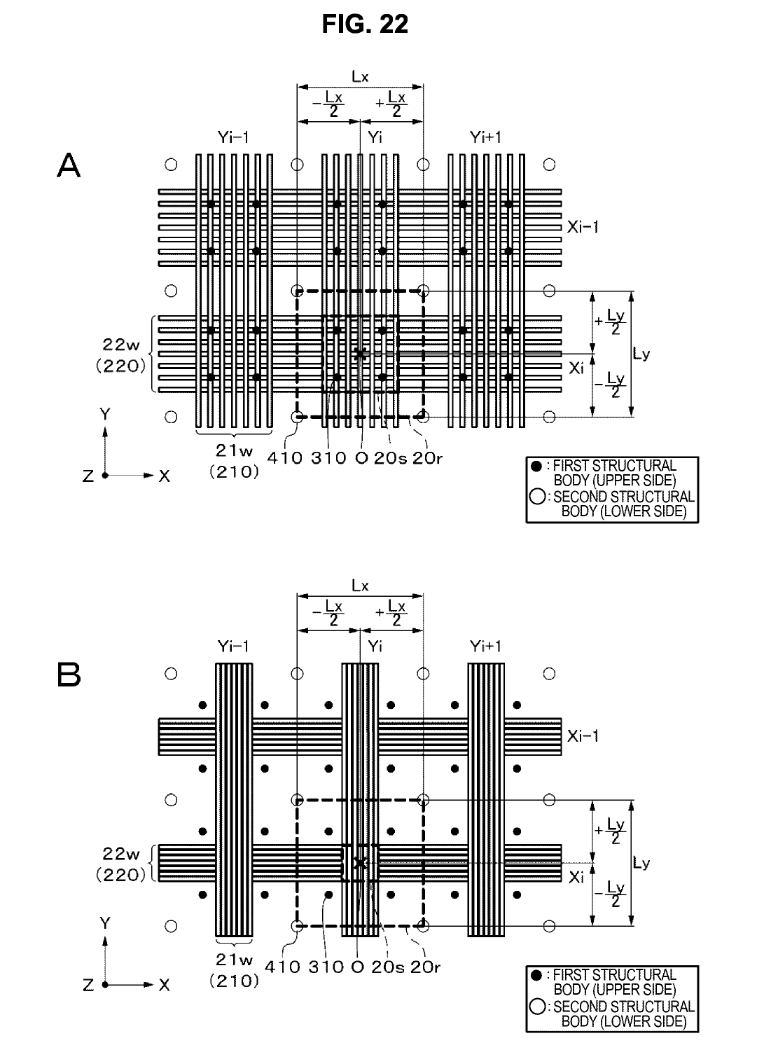

FIGS. 22A and 22B are schematic plan views illustrating arrangement examples of the first and second structural bodies 310 and 410, the first electrode line (Y electrode) 210 and the second electrode line (X electrode) 220. FIG. 22 illustrates an example in which the X electrodes 210 and the Y electrodes 220 have the electrode groups 21w and 22w, respectively. In addition, as described above, the respective detection units 20s are formed in intersecting sections between the X electrodes 210 and the Y electrodes 220. Also, in FIG. 22, a black circle indicates the first structural body 310 and a white circle indicates the second structural body 410.

The unit detection region (unit sensor region) 20r is provided to correspond to the intersecting section between the X electrode 210 and the Y electrode 220. The detection unit 20s is provided in the unit detection region 20r. The plurality of second structural bodies 410 are arranged on the outer circumference of the unit detection region 20r. The unit detection region 20r refers to a region obtained by equally dividing a principal surface of the input device 100 to correspond to the intersecting section between the X electrode 210 and the Y electrode 220. Typically, the unit detection region 20r is defined by the following (A) or (B).

(A) A region defined by the plurality of second structural bodies 410 that are provided to correspond to the intersecting sections between the X electrodes 210 and the Y electrodes 220.

Here, a position of each side (for example, a midpoint of each side) and/or each vertex (corner) of the unit detection region 20r is defined by the second structural body 410.

(B) A region satisfying the following two formulae when each intersecting point between a center line of the X electrode 210 and a center line of the Y electrode 220 is set as an origin point O

−Lx/2≦X<+Lx/2

−Ly/2≦X<+Ly/2

(where, in the formulae, Lx: a center-to-center interval of the X electrodes 210, and Ly: a center-to-center interval of the Y electrodes 220)

As a positional relation among an outer circumference Cr of the unit detection region 20r, an outer circumference Cs of the detection unit (intersecting section) 20s, and an arrangement position of the first structural body 310 included in the unit detection region 20r, for example, the following positional relations (a) and (b) are exemplified. The positional relation (b) is preferable from the viewpoint of increasing characteristics such as a capacitance change rate. However, these positional relations refer to a positional relation when the input device 100 is viewed in the Z-axis direction (that is, a direction perpendicular to the first surface 110).

(a) The outer circumference Cs of the detection unit 20s is inside the outer circumference Cr of the unit detection region 20r and the first structural body 310 is arranged inside the outer circumference Cs of the detection unit 20s (refer to FIG. 22A).
(b) The outer circumference Cs of the detection unit 20s is inside the outer circumference Cr of the unit detection region 20r, and the first structural body 310 is arranged between the outer circumference Cs of the detection unit 20s and the outer circumference Cr of the unit detection region 20r (refer to FIG. 22B).

The two or more first structural bodies 310 are included in the unit detection region 20r. Accordingly, it is possible to increase accuracy of coordinate calculation of the input device 100. In addition, it is possible to increase weighted sensitivity of the input device 100. The first and second structural bodies 310 and 410 are preferably arranged symmetrically (in linear symmetry with respect to lines parallel to two arrangement directions of the unit detection region 20r that pass the center of the unit detection region 20r) with respect to the center of the unit detection region 20r. However, configurations such as the plurality of first structural bodies 310, the plurality of second structural bodies 410, the plurality of first electrode elements 21z, and the plurality of second electrode elements 22z inside the unit detection region 20r in the outermost circumference or in the vicinity of the outermost circumference of the detection unit 20s may be asymmetrical with respect to the center of the unit detection region 20r.

### Symmetrical Arrangement Example of First and Second Structural Bodies

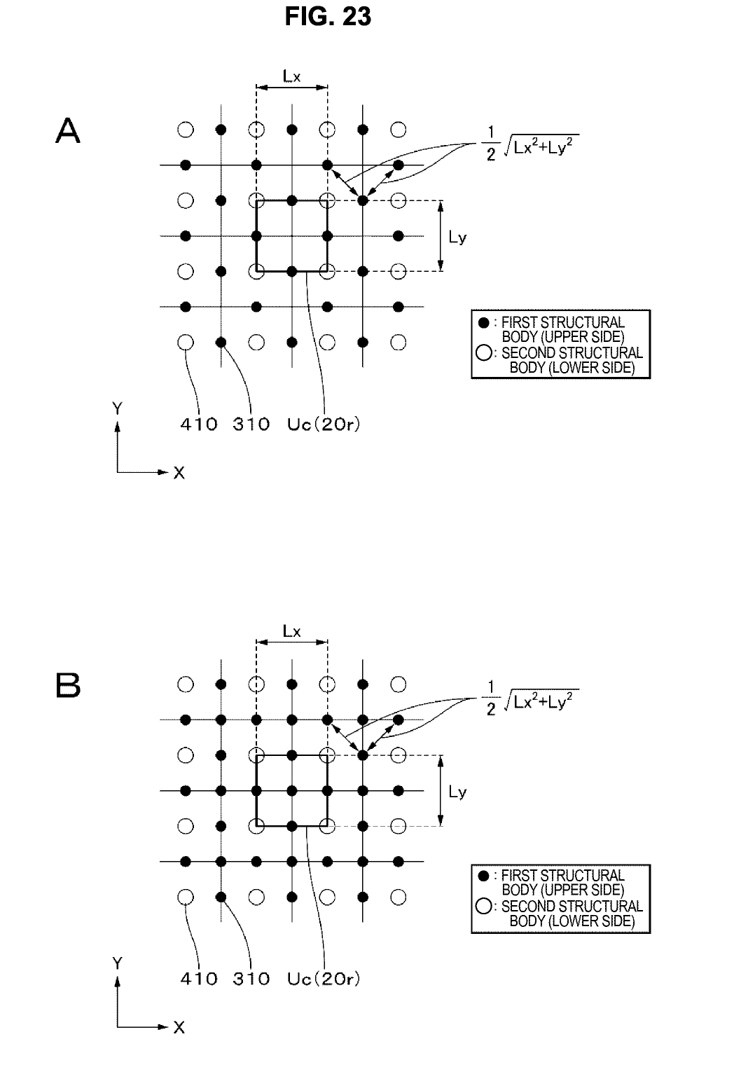

Hereinafter, an example in which the plurality of first and second structural bodies 310 and 410 are arranged symmetrically with respect to the center of the unit detection region 20r will be described with reference to FIGS. 23A to 25B, 26, and 58A to 59B. More specifically, an example in which the plurality of first and second structural bodies 310 and 410 are arranged in linear symmetry with respect to center lines (that is, the X axis and the Y axis) of the first and second electrode lines 210 and 220 will be described. Also, line segments shown in FIGS. 23A to 25B, 26, 58, and 58A to 59B indicate center lines of the X electrode 210 and the Y electrode 220.

### First Arrangement Example

FIG. 23A is a plan view illustrating a first example of a symmetrical arrangement. The first example is a symmetrical arrangement example in which a total of two of the first structural bodies 310 are included in the unit detection region 20r, and a total of one of the second structural bodies 410 is included in the unit detection region 20r.

The second structural body 410 is arranged at a position of each vertex (each grid point) of a unit cell Uc having a rectangular shape whose side in the X-axis direction has a length Lx and whose side in the Y-axis direction has a length Ly. That is, the second structural body 410 is arranged in the X-axis direction at an arrangement pitch (period) of the length Lx and arranged in the Y-axis direction at an arrangement pitch (period) of the length Ly. Here, the unit cell Uc is virtually set in order to describe the arrangement of the first structural body 310 and the second structural body 410.

A region of the unit cell Uc matches the unit detection region 20r. In addition, the center position of the unit detection region 20r matches a center position of the intersecting section between the X electrode 210 and the Y electrode 220. Here, an example in which the unit cell Uc has a rectangular shape is described, but the unit cell Uc is not limited to this example. For example, a tetragonal grid, a rhombic grid, a diamond grid, a rectangular grid, an isosceles triangular grid, an oblong grid, a hexagonal grid or an equilateral triangular grid may be used.

The unit cell Uc includes (¼) units of the second structural body 410 arranged in respective vertices. In addition, the region of the unit cell Uc matches the unit detection region 20r, and thus a total of one unit (=(¼) [units]×4) of the second structural body 410 is included in the one unit detection region 20r.

The first structural body 310 is arranged at a midpoint of each side of the unit cell Uc. In a diagonal direction of the unit cell Uc, a distance (an arrangement pitch) between the first structural bodies 310 is (½)×√(Lx²+Ly²). Here, √/Lx²+Ly²) refers to the square root of (Lx²+Ly²).

The unit cell Uc includes (½) units of the first structural body 310 arranged at a midpoint of each side. In addition, the region of the unit cell Uc matches the unit detection region 20r, and thus a total of 2 units (=(½) [units]×4) of the first structural body 310 are included in the one unit detection region 20r.

### Second Arrangement Example

FIG. 23B is a plan view illustrating the second example of the symmetrical arrangement. The second example is a symmetrical arrangement example in which a total of three of the first structural bodies 310 are included in the unit detection region 20r and a total of one of the second structural bodies 410 is included in the unit detection region 20r. The second example is different from the first example in that the one first structural body 310 is further arranged at a center of the unit cell Uc.

The unit cell Uc includes (½) units of the first structural body 310 arranged at a midpoint of each side, and includes the one first structural body 310 arranged at the center. In addition, the region of the unit cell Uc matches the unit detection region 20r, and thus a total of 3 units (=(½) [units]×4+1[unit]) of the first structural bodies 310 are included in the one unit detection region 20r.

### Third Arrangement Example

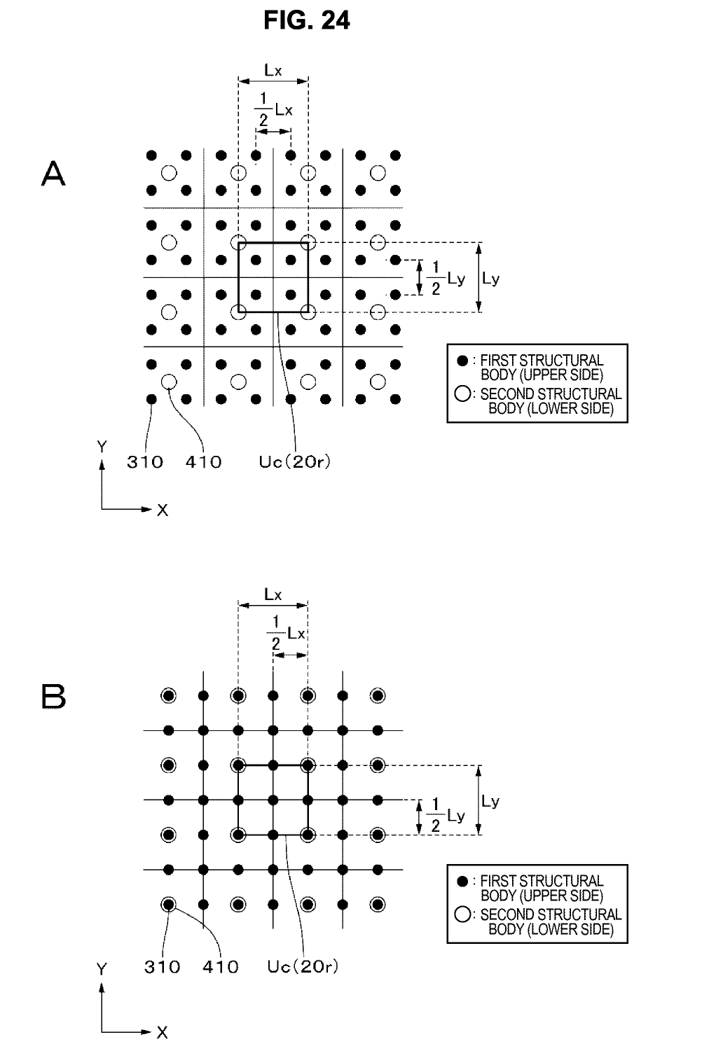

FIG. 24A is a plan view illustrating a third example of a symmetrical arrangement. The third example is a symmetrical arrangement example in which a total of four of the first structural bodies 310 are included in the unit detection region 20r, and a total of one of the second structural bodies 410 is included in the unit detection region 20r. Since the arrangement of the second structural bodies 410 is the same as the first example of the symmetrical arrangement, explanation is omitted.

The first structural bodies 310 are arranged one by one at a position between the center position of the unit cell Uc and each vertex. Here, the position between the center position of the unit cell Uc and each vertex is, for example, a midpoint between the center position of the unit cell Uc and each vertex. A distance (an arrangement pitch) between the first structural bodies 310 in the X-axis direction is Lx/2, and a distance (an arrangement pitch) between the first structural bodies 310 in the Y-axis direction is Ly/2.

### Fourth Arrangement Example

FIG. 24B is a plan view illustrating the fourth example of the symmetrical arrangement. The fourth example is a symmetrical arrangement example in which a total of four of the first structural bodies 310 are included in the unit detection region 20r and a total of one of the second structural bodies 410 is included in the unit detection region 20r. The fourth example is different from the second example in that the first structural bodies 310 are further arranged at a position of each vertex (each grid point) of the unit cell Uc.

The unit cell Uc includes (¼) units of the first structural body 310 arranged in each vertex and (½) units of the first structural body 310 arranged at a midpoint of each side, and also includes the one first structural body 310 arranged at the center. In addition, the region of the unit cell Uc matches the unit detection region 20r, and thus a total of 4 units (=(¼) [units]×4+(½) [units]×4+1[unit]) of the first structural body 310 are included in the one unit detection region 20r.

### Fifth Arrangement Example

FIG. 25A is a plan view illustrating a fifth example of a symmetrical arrangement. The fifth example is a symmetrical arrangement example in which a total of four of the first structural bodies 310 are included in the unit detection region 20r, and a total of one of the second structural bodies 410 is included in the unit detection region 20r. Since the arrangement of the second structural bodies 410 is the same as the first example of the symmetrical arrangement, explanation is omitted.

The first structural bodies 310 are arranged one by one at a position between the center position of the unit cell Uc and a midpoint of each side. Here, the position between the center position of the unit cell Uc and a midpoint of each side is, for example, a midpoint between the center position of the unit cell Uc and a midpoint of each side. A distance (an arrangement pitch) between the first structural bodies 310 in the X-axis direction is Lx/2, and a distance (an arrangement pitch) between the first structural bodies 310 in the Y-axis direction is Ly/2.

### Second Arrangement Example

FIG. 25B is a plan view illustrating the sixth example of the symmetrical arrangement. The sixth example is a symmetrical arrangement example in which a total of five of the first structural bodies 310 are included in the unit detection region 20r and a total of one of the second structural bodies 410 is included in the unit detection region 20r. The sixth example is different from the third example in that the one first structural body 310 is further arranged at a center of the unit cell Uc.

### Seventh Arrangement Example

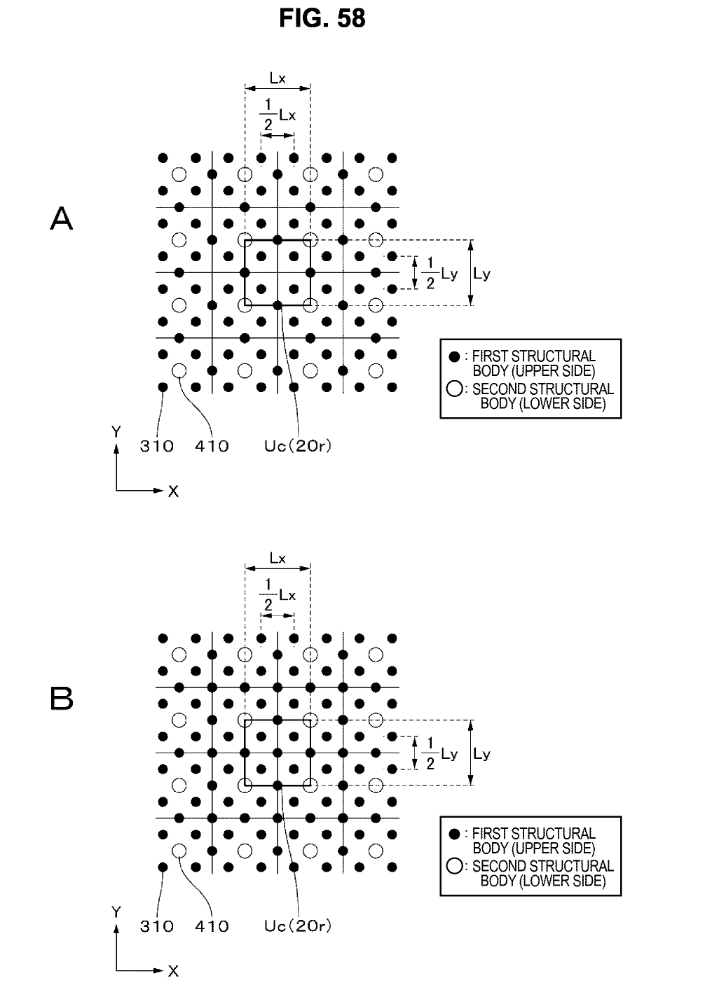

FIG. 58A is a plan view illustrating the seventh example of the symmetrical arrangement. The seventh example is a symmetrical arrangement example in which a total of six of the first structural bodies 310 are included in the unit detection region 20r and a total of one of the second structural bodies 410 is included in the unit detection region 20r. The seventh example is different from the third example in that the first structural body 310 is further arranged at a midpoint of each side of the unit cell Uc. When a very soft display is used as the flexible display 11, the seventh arrangement example is particularly effective in suppressing local deformation thereof.

### Eighth Arrangement Example

FIG. 58B is a plan view illustrating the eighth example of the symmetrical arrangement. The eighth example is a symmetrical arrangement example in which a total of seven of the first structural bodies 310 are included in the unit detection region 20r and a total of one of the second structural bodies 410 is included in the unit detection region 20r. The seventh example is different from the sixth example in that the first structural body 310 is further arranged at a midpoint of each side of the unit cell Uc. When a very soft display is used as the flexible display 11, the seventh arrangement example is particularly effective in suppressing local deformation thereof.

### Ninth Arrangement Example

FIG. 26 is a plan view illustrating the ninth example of the symmetrical arrangement. The ninth example is a symmetrical arrangement example in which a total of one of the first structural bodies 310 is included in the unit detection region 20r and a total of one of the second structural bodies 410 is included in the unit detection region 20r. In this manner, a total of one of the first structural bodies 310 may be included in the unit detection region 20r. The first structural body 310 is arranged at the center of the unit cell Uc.

When the number and the arrangement (pitch) of the first and second structural bodies 310 and 410 are adjusted, it is possible to adjust an amount of change in a distance of each of the metal film 12 and the conductor layer 50 from the detection unit 20s with respect to the pressing force such that a desired operation feeling or detection sensitivity is obtained. Deformation of the operation member 10 decreases by about a square of a distance between the adjacent first structural bodies 310. When the four first structural bodies 310 are arranged in the unit detection region 20r, deformation of the operation member 10 is about ¼.

### Tenth Arrangement Example

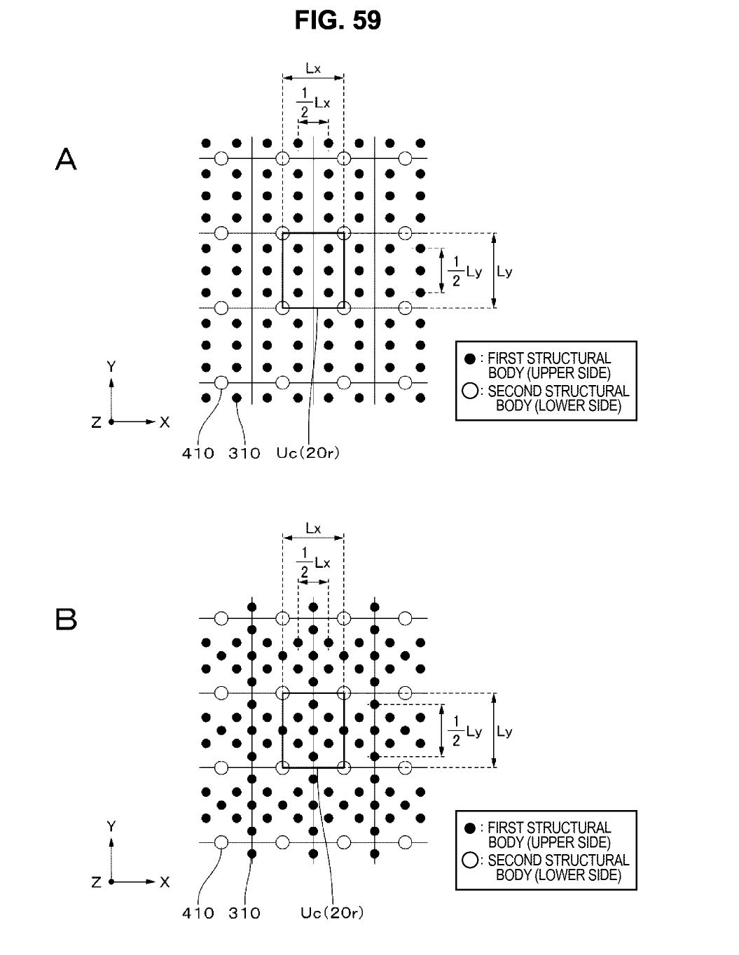

FIG. 59A is a plan view illustrating the tenth example of the symmetrical arrangement. In the tenth example, the unit detection region 20r has a rectangular shape whose side in the X-axis direction has a length Lx and whose side in the Y-axis direction has a length Ly, which have different values. When the length Lx of the side in the X-axis direction and the length Ly of the side in the Y-axis direction are different, linear symmetry with respect to a center line of the first electrode line 210 and linear symmetry with respect to a center line of the second electrode line 220 may be different. In the ninth example, a total of six of the first structural bodies 310 are arranged in the unit detection region 20r and a total of one of the second structural bodies 410 is arranged.

### Eleventh Arrangement Example

FIG. 59B is a plan view illustrating the eleventh example of the symmetrical arrangement. The eleventh example is different from the ninth example in that a total of eight of the first structural bodies 310 are arranged in the unit detection region 20r and a total of one of the second structural bodies 410 is arranged in the unit detection region 20r.

### (Exemplary Arrangement Relation Between First and Second Structural Bodies)

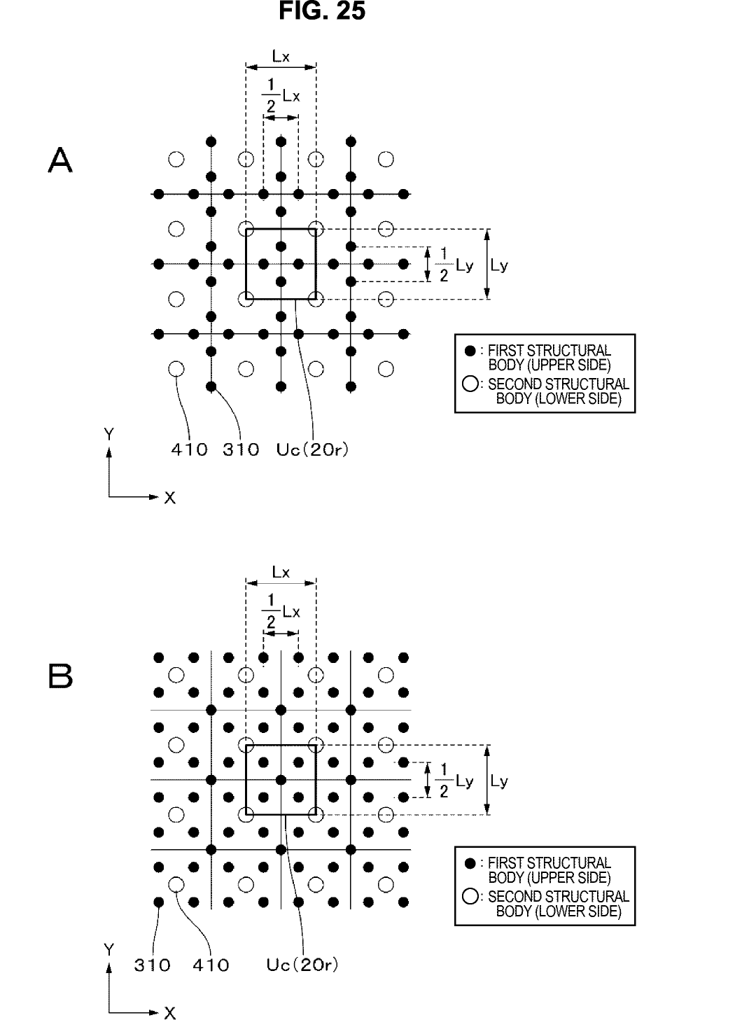

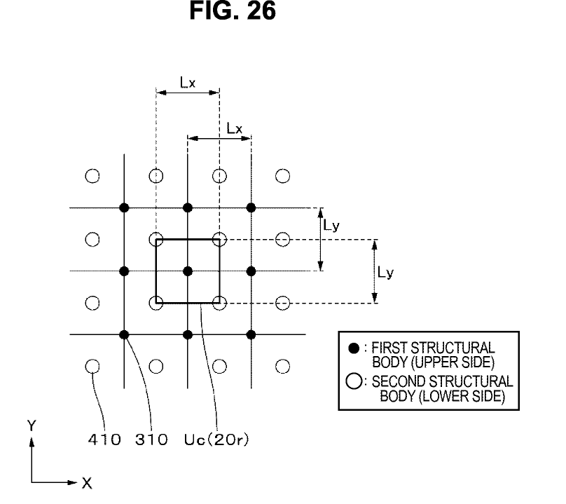

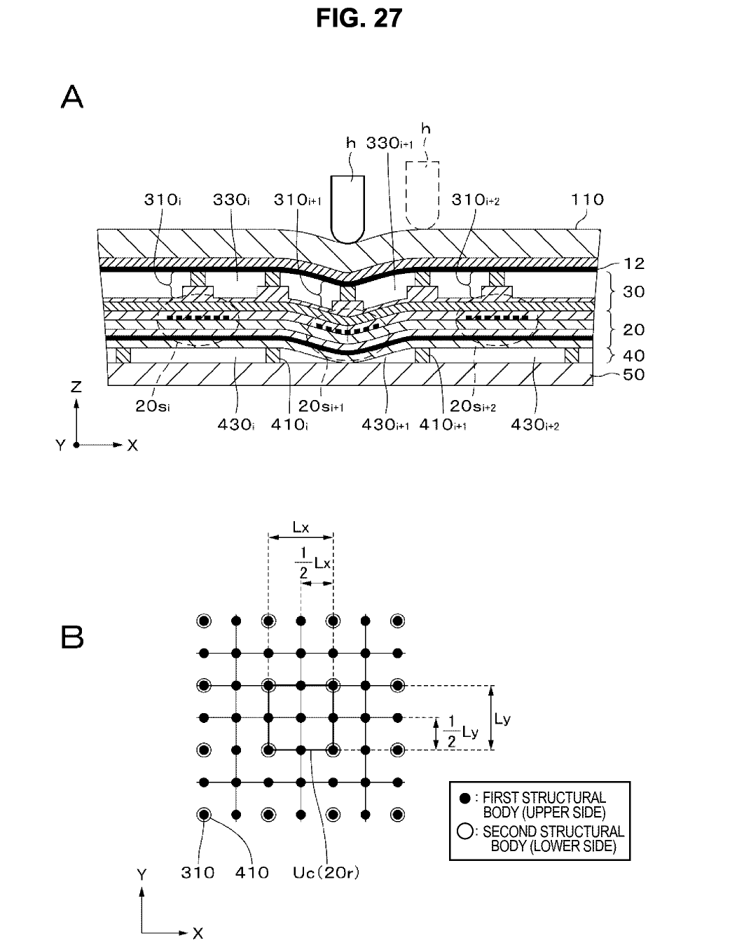

As illustrated in FIGS. 27A and 27B, when there is a part in which the first and second structural bodies 310 and 410 are arranged to overlap when viewed in the Z-axis direction, deformation of the operation member 10 and the electrode substrate 20 is suppressed, and thus sensitivity of the overlapping part tends to decrease. Therefore, when viewed in the Z-axis direction (that is, the thickness direction of the input device 100), it is preferable that the first and second structural bodies 310 and 410 be arranged such that none of the first and second structural bodies 310 and 410 overlap.

When the first structural body 310 and the second structural body 410 do not overlap when viewed in the Z-axis direction and the first structural body 310 is arranged above the second space portion 430, it is possible to deform the metal film 12 and the conductor layer 50 with a minute pressing force of, for example, about several tens of g when an operation is performed.

### Arrangement Example of Second Structural Bodies

Hereinafter, arrangement examples of the second structural bodies 410 will be described with reference to FIGS. 28, 29A to 29C, and 30A and 30B.

### First Arrangement Example

FIG. 28 is a plan view illustrating the first arrangement example of the second structural bodies 410. In the first arrangement example, the second structural body 410 is arranged at a position of each vertex of a unit cell (tetragonal grid) Uc having a square shape.

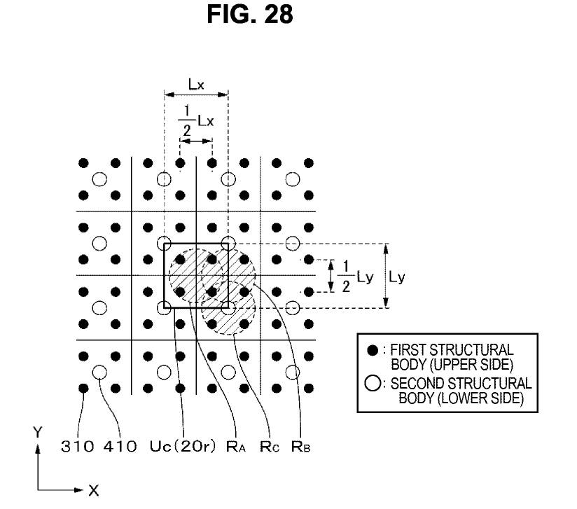

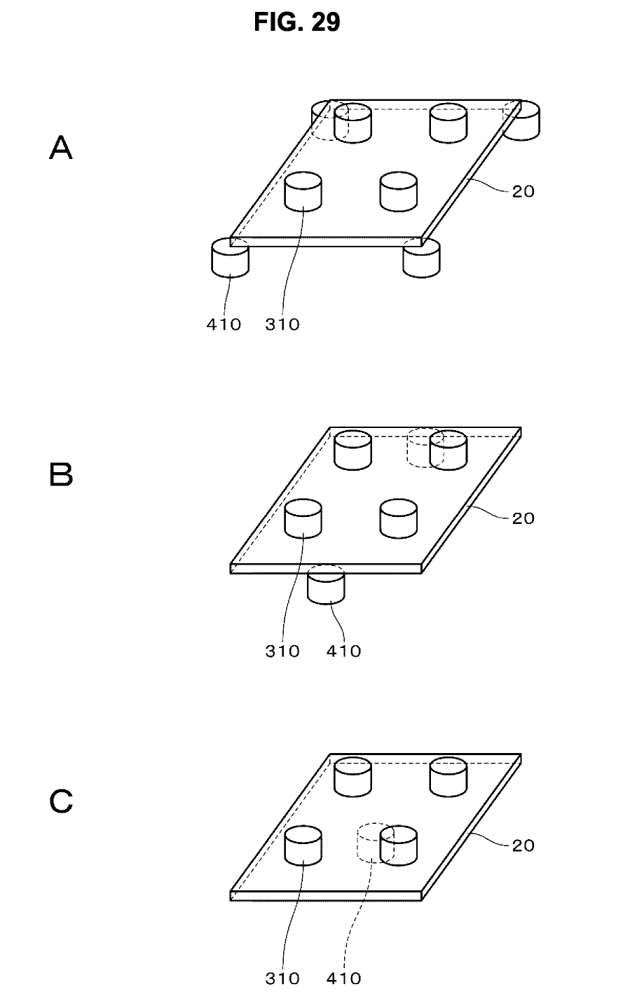

FIGS. 29A, 29B, and 29C are perspective views illustrating enlarged vicinities of a region R_{A}, a region R_{B}, and a region R_{c} illustrated in FIG. 28, respectively. The region R_{A}, the region R_{B}, and the region R_{c} have different sensitivities. The region R_{c} tends to have lower sensitivity than the region R_{A} and the region R_{B} whereas the region R_{A} and the region R_{B} have good sensitivity.

### Second Arrangement Example

FIG. 30A is a plan view illustrating the second arrangement example of the second structural bodies 410. In the second arrangement example, the second structural body 410 is arranged at a position of a midpoint of each side of a unit cell (tetragonal grid) Uc having a square shape.

### Third Arrangement Example

FIG. 30B is a plan view illustrating the third arrangement example of the second structural bodies 410. In the third arrangement example, the second structural body 410 is arranged at a position of each vertex of the unit cell (tetragonal grid) Uc having a square shape and a position of a midpoint of each side of the unit cell (tetragonal grid) Uc having a square shape.

Detection sensitivity of the detection unit 20s tends to decrease at a position in which the second structural body 410 is arranged. Therefore, from the viewpoint of decreasing an influence on coordinate calculation, it is preferable that the second structural body 410 be arranged in a direction between the X-axis direction and the Y-axis direction when viewed from the center of the unit cell Uc. Specifically, it is preferable that the second structural body 410 be arranged in a diagonal direction of the unit cell Uc when viewed from the center of the unit cell Uc. That is, when the unit cell Uc is a tetragonal grid, it is preferable that the second structural body 410 be arranged in directions of about 45°, about 135°, about 215° and about 305° relative to the X-axis direction.

When the second structural body 410 is arranged in the above-described first to third arrangement examples, a relation of detection sensitivity of the detection unit 20s in these arrangement examples is as follows.

(detection sensitivity of first arrangement example)>(detection sensitivity of second arrangement example)>(detection sensitivity of third arrangement example)

### [Increase of Load Sensitivity]

In the input device 100 according to the present embodiment, since the two or more first structural bodies 310 are included in the unit detection region 20r, it is possible to increase load sensitivity.

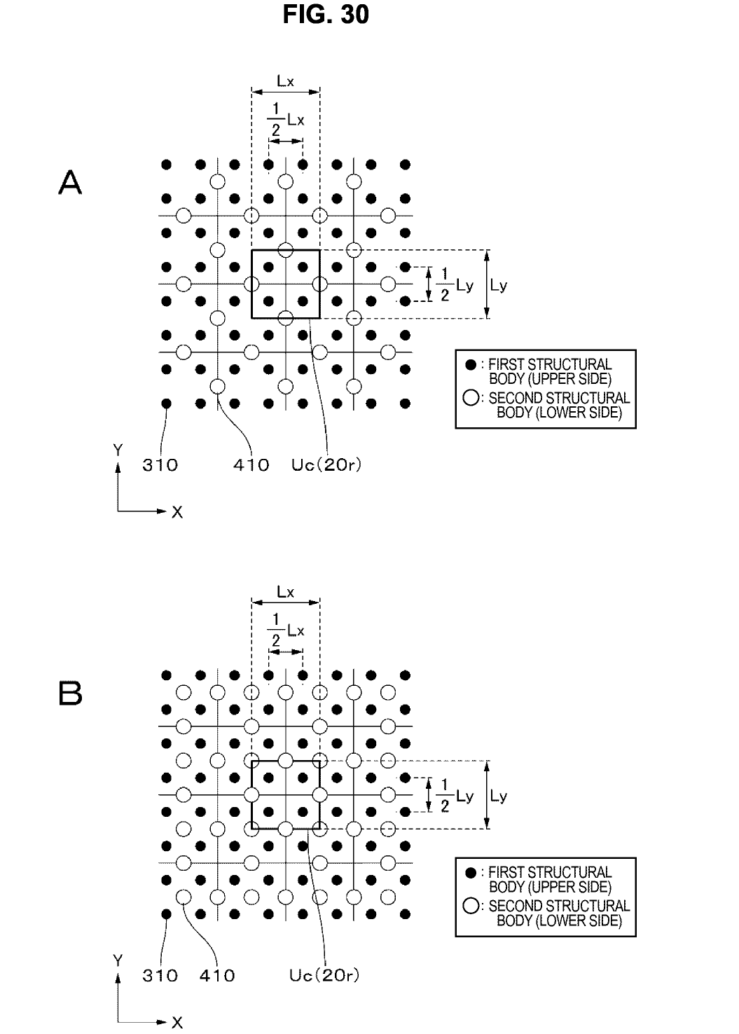

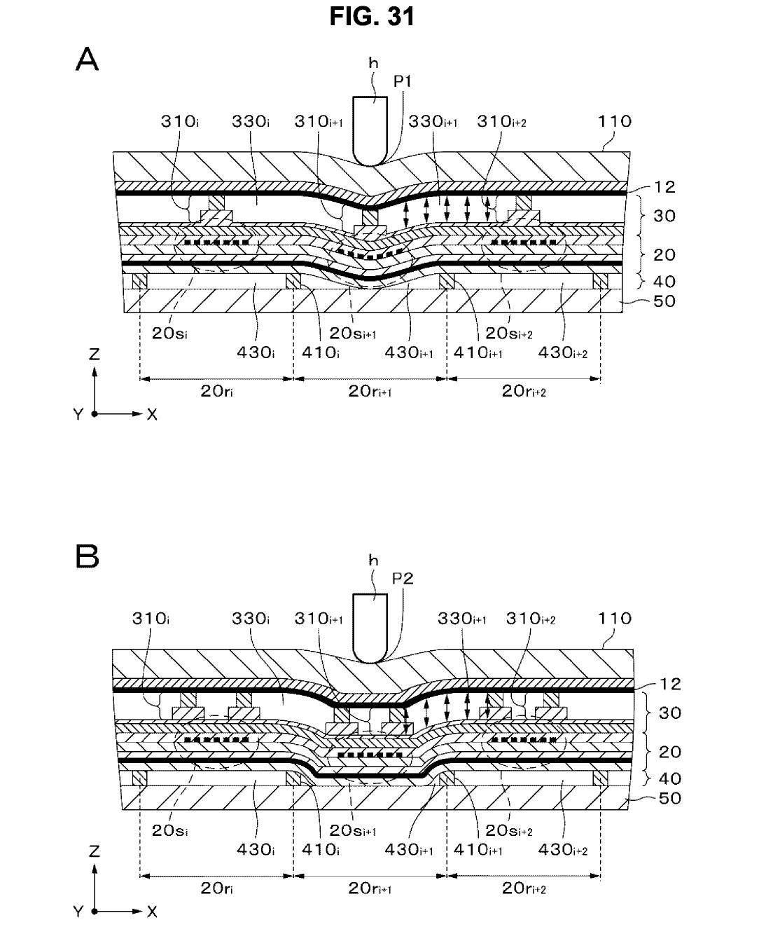

Here, the reason for which the increase in load sensitivity is possible when the two or more first structural bodies 310 are included in the unit detection region 20r will be described with reference to FIGS. 31A and 31B.

FIG. 31A illustrates an example of the input device 100 in which the one first structural body 310 is included in the unit detection region 20r. In the input device 100 illustrated in this example, when the position P1 corresponding to the center of the unit detection region 20rᵢ₊₁ within the first surface 110 is pressed by the operant h, as illustrated in FIG. 31A, only the electrode substrate 20 directly below the first structural body 310 is locally deformed toward the conductor layer 50.

On the other hand, FIG. 31B illustrates an example of the input device 100 in which the two or more first structural bodies 310 are included in the unit detection region 20r. In the input device 100 illustrated in this example, as illustrated in FIG. 31B, when the position P2 corresponding to the center of the unit detection region 20rᵢ₊₁ within the first surface 110 is pressed by the operant h, as illustrated in FIG. 31B, a wide range of the electrode substrate 20 surrounded by the first structural body 310 in the vicinity of the center of the unit detection region 20rᵢ₊₁ is deformed toward the conductor layer 50. As a result, an amount of change in capacitance when the position P2 corresponding to the center of the unit detection region 20rᵢ₊₁ is pressed by the operant h increases.

### Arrangement Position Examples of First Structural Body in Unit Detection Region

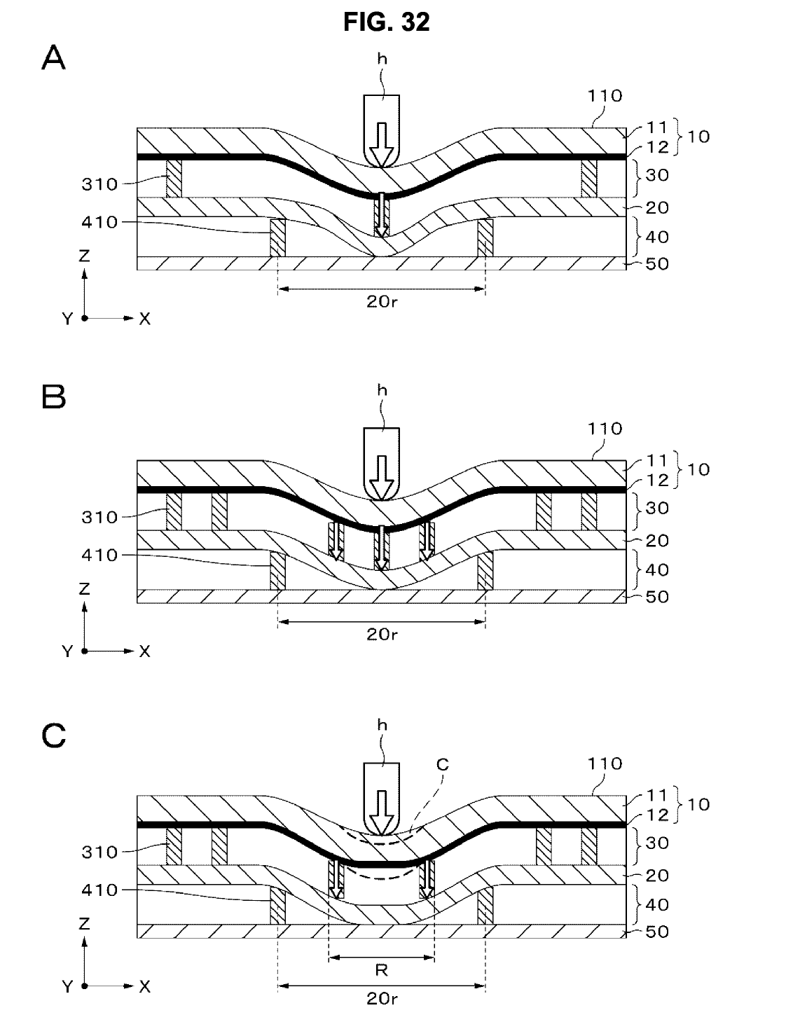

Hereinafter, arrangement position examples of the first structural body 310 in the unit detection region 20r will be described with reference to FIGS. 32A to 32C.

### First Arrangement Example

FIG. 32A is a schematic cross-sectional view illustrating the first arrangement example. Also, FIG. 26 corresponds to a plan view of the first arrangement example. The first example illustrates an example of the input device 100 in which the one first structural body 310 is arranged in the unit detection region 20r. In the input device 100 illustrated in the first arrangement example, when the first surface 110 is pressed by the operant h, a portion corresponding to the pressed position between the metal film 12 and the electrode substrate 20 is deformed downward (a direction of the conductor layer 50).

### Second Arrangement Example

FIG. 32B is a schematic cross-sectional view illustrating the second arrangement example. Also, FIG. 25B corresponds to a plan view of the second arrangement example. The second example illustrates an example of the input device 100 in which five of the first structural bodies 310 are arranged in the unit detection region 20r. When the first surface 110 is pressed by the operant h, the input device 100 illustrated in the second arrangement example can deform a wider range of the electrode substrate 20 than the input device 100 illustrated in the first example. However, when the first structural body 310 arranged at the center among the five first structural bodies 310 is pressed by the operant h, a great amount of load is applied to the first structural body 310 at the center. When the first structural body 310 at the center comes in contact with the conductor layer 50, deformation of the electrode substrate 20 stops, and a range of deformation decreases.

### Third Arrangement Example

FIG. 32C is a schematic cross-sectional view illustrating the third arrangement example. Also, FIG. 24A corresponds to a plan view of the third arrangement example. The third example illustrates an example of the input device 100 in which four of the first structural bodies 310 are arranged in the unit detection region 20r. When the first surface 110 is pressed by the operant h, the input device 100 illustrated in the third arrangement example can deform a wider range of the electrode substrate 20 than the input device 100 illustrated in the first example. In addition, as illustrated in a region R in FIG. 32C, it is possible to evenly distribute a load. Moreover, as illustrated in a virtual line (a dashed line) C in FIG. 32C, even after deformation of the electrode substrate 20 reaches saturation, the metal film 12 continues to deform. In order to obtain a maximum capacitance change rate at the center of the unit detection region 20r, as illustrated in the third arrangement example, it is preferable that the plurality of first structural bodies 310 be arranged in the unit detection region 20r and arranged to be shifted from the center of the unit detection region 20r.

### (Distance Between First Structural Bodies)

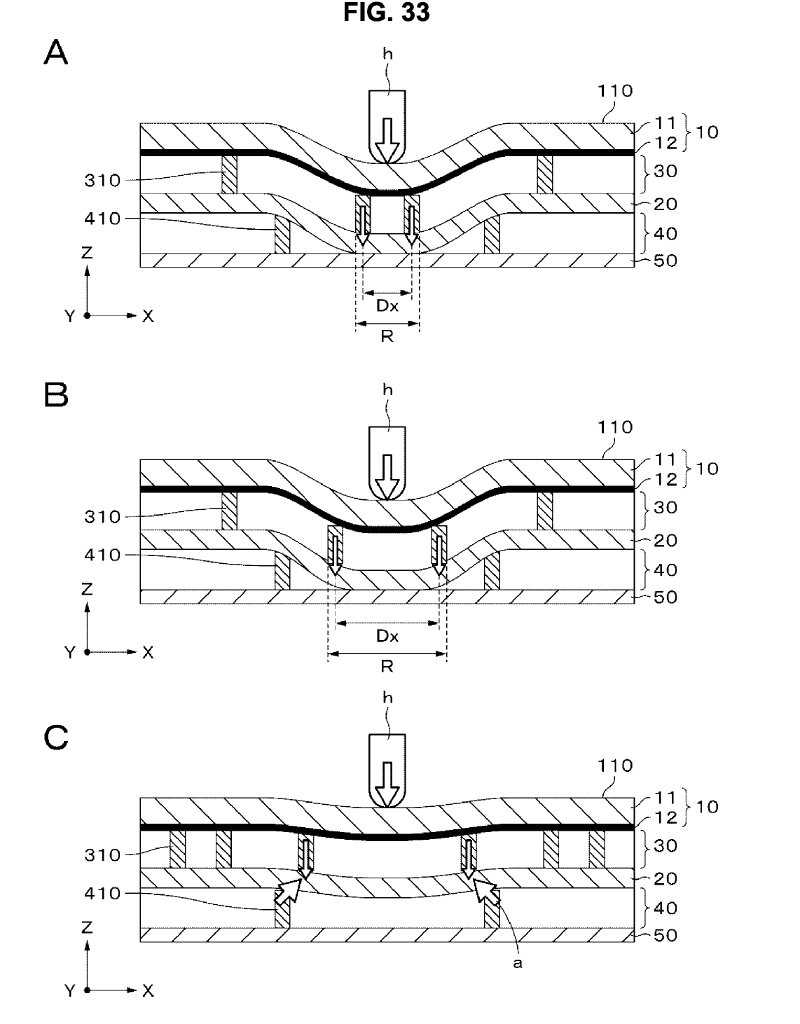

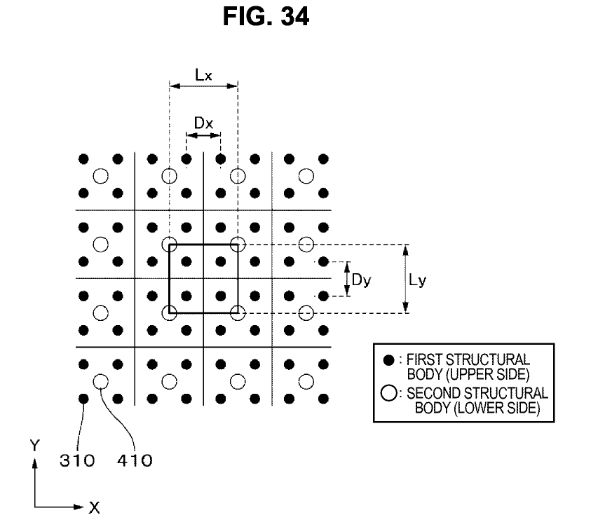

FIGS. 33A to 33C are schematic cross-sectional views describing distances Dx and Dy between the adjacent first structural bodies 310. FIG. 34 is a plan view for describing distances Dx and Dy between the adjacent first structural bodies 310. FIGS. 33A to 33C and 34 illustrate examples in which the four first structural bodies 310 are arranged in the one unit detection region 20r, a distance between the adjacent first structural bodies 310 in the X-axis direction is Dx, and a distance between the adjacent first structural bodies 310 in the Y-axis direction is Dy.

As illustrated in FIG. 33A, when distances Dx and Dy between the adjacent first structural bodies 310 are small, a deformation range R of the metal film 12 and the electrode substrate 20 decreases. In this manner, when the deformation range R is small, sensitivity of the detection unit 20s decreases. On the other hand, as illustrated in FIG. 33B, when the distances Dx and Dy between the adjacent first structural bodies 310 are large, the deformation range R of the metal film 12 and the electrode substrate 20 increases. In this manner, when the deformation range R increases, sensitivity of the detection unit 20s increases. However, as illustrated in FIG. 33C, when the distances Dx and Dy between the first structural bodies 310 are too large, as indicated by an arrow a in FIG. 33C, a reaction from the second structural body 410 increases, and the metal film 12 and the electrode substrate 20 are less likely to be deformed downward. Therefore, sensitivity of the detection unit 20s decreases.

The distance Dx is preferably (¼)×Lx≦Dx, more preferably (¼)×Lx≦Dx≦(¾)×Lx, and most preferably Lx/2. In this case, Lx is an arrangement pitch of the first structural body 310 in the X-axis direction. When Dx≦(¾)×Lx is established, it is possible to suppress sensitivity of the detection unit 20s from decreasing. When (¼)×Lx≦Dx is established, it is possible to further increase an effect of suppressing two peaks from occurring in the capacitance change rate distribution (refer to FIG. 19B).

The distance Dy is preferably (¼)×Ly≦Dy, more preferably (¼)×Ly≦Dy≦(¾)×Ly, and most preferably Ly/2. In this case, Ly is an arrangement pitch of the first structural body 310 in the Y-axis direction. When Dy≦(¾)×Ly is established, it is possible to suppress sensitivity of the detection unit 20s from decreasing. When (¼)×Ly≦Dy is established, it is possible to further increase an effect of suppressing two peaks from occurring in the position sensitivity distribution (refer to FIG. 19B).

### (Increase of Dynamic Drawing Characteristic)

Hereinafter, a drawing characteristic of the input device 100 in which the one first structural body 310 is included in the unit detection region 20r will be described with reference to FIGS. 35A and 35B. As indicated by an arrow a in FIG. 35B, when dynamic drawing for moving a load applied onto the first surface 110 in the X-axis direction is performed, the dynamic drawing characteristic shows a movement tendency to avoid the first structural body 310. This is because, when the one first structural body 310 is arranged in the unit detection region 20r, as illustrated in FIG. 35A, the operation member 10 (the metal film 12) significantly falls downward in the vicinity of a boundary between the unit detection regions 20r.

When the plurality of first structural bodies 310 are arranged in the unit detection region 20r, it is possible to suppress the above-described dynamic drawing characteristic from decreasing. Preferably, the plurality of first structural bodies 310 are two-dimensionally arranged in the X-axis direction (first direction) and the Y-axis direction (second direction) which are orthogonal to each other, and the first structural bodies 310 are arranged at equal intervals in both the X-axis direction and the Y-axis direction. Therefore, it is possible to obtain an excellent drawing characteristic. Deformation of the operation member 10 (the metal film 12) decreases by about a square of a distance between the first structural bodies 310. For example, when the four first structural bodies 310 are included in the unit detection region 20r, deformation of the operation member 10 is about (¼) of the case in which the one first structural body 310 is included in the unit detection region 20r.

As an arrangement example of the first structural bodies 310 in order to suppress such a dynamic drawing characteristic from decreasing, for example, the following arrangement examples are exemplified.

An arrangement example in which three of the first structural bodies 310 are arranged in the unit detection region 20r: the arrangement example illustrated in FIG. 23B
An arrangement example in which four of the first structural bodies 310 are arranged in the unit detection region 20r: the arrangement examples illustrated in FIGS. 24A, 24B, and 25A

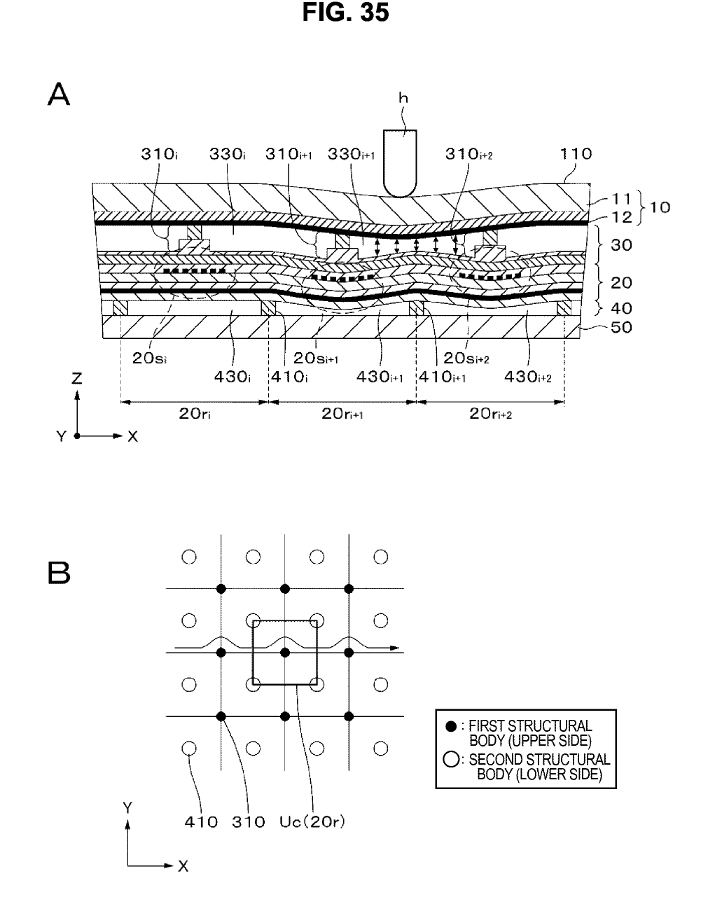

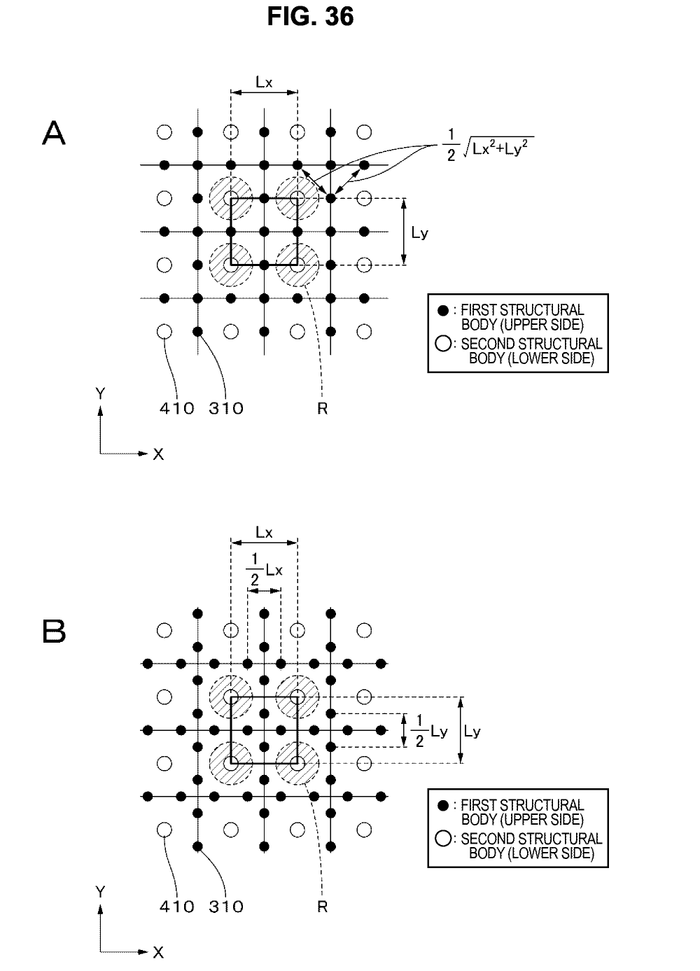

However, in the arrangement examples illustrated in FIGS. 23B and 25A, although a decrease in the dynamic drawing characteristic can be suppressed, there is a region in which slight sinking occurs. FIGS. 36A and 36B illustrate a region R in which slight sinking occurs in the arrangement examples illustrated in FIGS. 23B and 25A. Therefore, from the viewpoint of increasing the dynamic drawing characteristic, as the arrangement example of the first structural bodies 310, the arrangement example illustrated in FIG. 24B is preferable, and the arrangement example illustrated in FIG. 24A is more preferable.

### [Effects]

Since the input device 100 according to the present embodiment detects an amount of change in electrostatic capacitance based on both capacitive couplings between the detection unit 20s and each of the metal film 12 and the conductor layer 50 as described above, it is possible to cause a sufficient change in electrostatic capacitance even when an operant having a large contact area such as the finger f is used. In addition, when it is determined whether an operation is performed, it is possible to determine contact with high accuracy based on the pressing force of the entire first surface 110 even when the operation pressure is small, for example, using a total value of amounts of changes in electrostatic capacitance of all of the detection units 20sᵢ, 20sᵢ₊₁, and 20sᵢ₊₂ whose electrostatic capacitances are changed. Moreover, since the electrostatic capacitance is changed based on the operation pressure distribution in the first surface 110, it is possible to compute the operation position according to the user's intention based on a ratio of these change amounts or the like.

In addition, a general electrostatic capacitance sensor uses capacitive coupling between the operant and X and Y electrodes and detects the operation position or the like. That is, when a conductor was arranged between the operant and the X and Y electrodes, it was difficult to detect the input operation due to capacitive coupling between the conductor and the X and Y electrodes. In addition, a configuration in which a thickness between the operant and the X and Y electrodes is great has problems in that an amount of capacitive coupling therebetween decreases and detection sensitivity decreases. In view of these problems, there was a need to arrange a sensor device on a display surface of a display, and thus a problem of deterioration in display quality of the display was caused.

Here, since the input device 100 (the sensor device 1) according to the present embodiment uses capacitive coupling between the metal film 12 and the X electrodes 210 and between the conductor layer 50 and the Y electrodes 220, even when the conductor is arranged between the operant and the sensor device, there is no influence on detection sensitivity. In addition, when the metal film 12 is deformable under the pressing force of the operant, restriction of a thickness between the operant and the X and Y electrodes is small. Therefore, even when the sensor device 1 is arranged on a rear surface of the flexible display 11, it is possible to detect the operation position and the pressing force with high accuracy, and it is possible to suppress a display characteristic of the flexible display 11 from deteriorating.

Moreover, since restriction of a thickness of an insulator (dielectric material) provided between the operant and the X and Y electrodes is small, even when the user performs the operation while wearing, for example, an insulating glove, there is no decrease in detection sensitivity. Therefore, it can contribute to increasing user convenience.

### [Modifications]

### (Modification 1)

While the above-described first embodiment has been described as an example in which the first and second electrode lines 210 and 220 are configured as the plurality of linear electrode groups 21w and 22w (refer to FIG. 10B), the configuration of the first and second electrode lines 210 and 220 is not limited to this example.

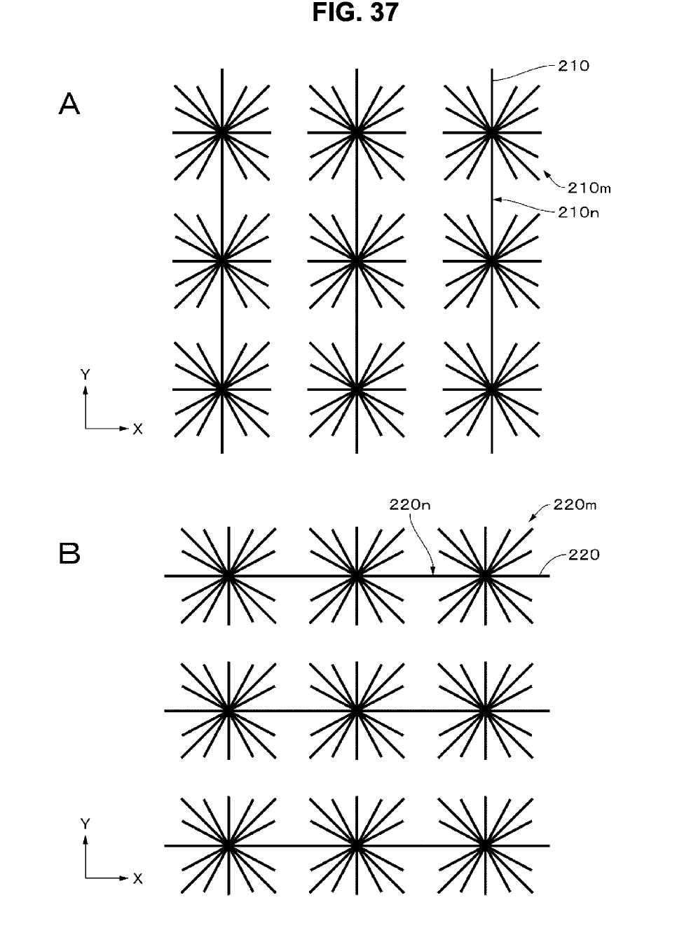

FIG. 37A is a plan view illustrating a modification of the first electrode line 210. The first electrode line 210 includes a plurality of unit electrode bodies 210m and a plurality of connecting portions 210n that connect the plurality of unit electrode bodies 210m to each other. The unit electrode body 210m is configured as an electrode group that includes a group of a plurality of sub-electrodes (electrode elements). These sub-electrodes have a regular or irregular pattern. In the example illustrated in FIG. 37A, the unit electrode body 210m is configured as an aggregate of a plurality of linear electrode patterns that radially extend from a center portion. The connecting portion 210n extends in the Y-axis direction and connects the adjacent unit electrode bodies 210m to each other.

FIG. 37B is a plan view illustrating a modification of the second electrode line 220. The second electrode line 220 includes a plurality of unit electrode bodies 220m and a plurality of connecting portions 220n that connect the plurality of unit electrode bodies 220m to each other. The unit electrode body 220m is configured as an electrode group that includes a group of a plurality of sub-electrodes (electrode elements). These sub-electrodes have a regular or irregular pattern. In the example illustrated in FIG. 37B, the unit electrode body 220m is configured as an aggregate of a plurality of linear electrode patterns that radially extend from a center portion. The connecting portion 220n extends in the X-axis direction and connects the adjacent unit electrode bodies 220m to each other.

The first and second electrode lines 210 and 220 are arranged to cross each other and overlap the unit electrode body 210m and the unit electrode body 220m when viewed in the Z-axis direction.

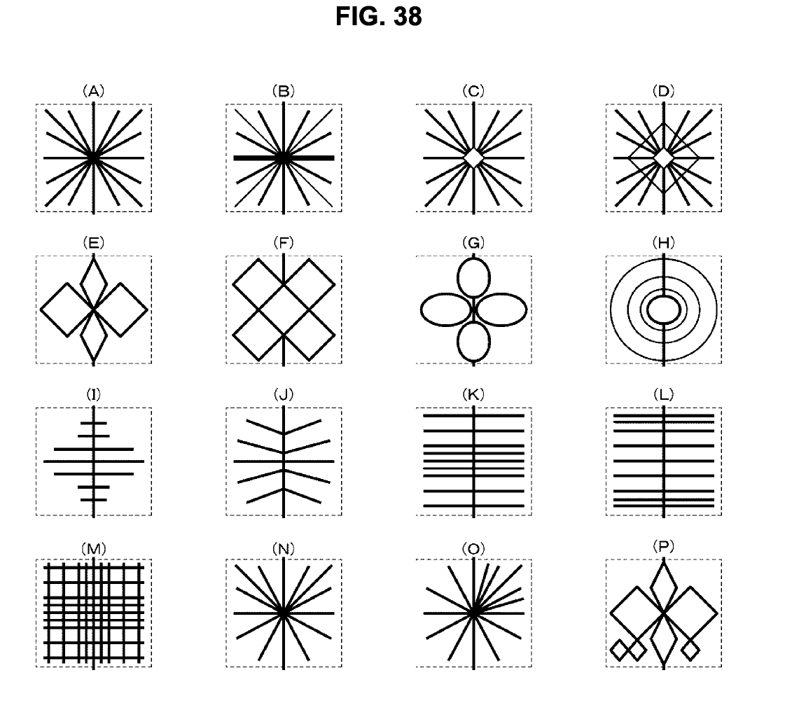

FIGS. 38(A) to 38(P) are schematic diagrams illustrating exemplary shapes of the unit electrode bodies 210m and 220m. Also, FIGS. 38(A) to 38(P) illustrate shapes in the intersecting section between the first and second electrode lines 210 and 220. Shapes of parts other than the intersecting section are not particularly limited, and may be, for example, linear. In addition, a combination of shapes of the unit electrode bodies 210m and 220m of the first and second electrode lines 210 and 220 may be FIG. 10(B) or two sets of the same shape or different shapes among FIGS. 38(A) to 38(P).

FIG. 38(A) corresponds to the unit electrode bodies 210m and 220m of FIGS. 37A and 37B. FIG. 38(B) illustrates an example in which one of radial line electrodes exemplified in FIG. 38(A) is formed to be greater than the other line electrodes. Accordingly, an amount of change in electrostatic capacitance on the greater line electrode can be greater than that on the other line electrodes. Moreover, FIGS. 38(C) and 38(D) illustrate examples in which a circular line electrode is arranged at substantially the center, and line electrodes are radially formed therefrom. Accordingly, concentration of the line electrodes at a center portion can be suppressed and generation of a region in which sensitivity decreases can be prevented.

FIGS. 38(E) to 38(H) illustrate examples in which all of a plurality of line electrodes formed in a circular or rectangular ring shape are combined to form an aggregate. Accordingly, it is possible to adjust a density of the electrodes, and suppress the region in which sensitivity decreases from being formed. In addition, FIG. 38(I) to FIG. 38(L) illustrate examples in which all of a plurality of line electrodes arranged in the X-axis direction or the Y-axis direction are combined to form an aggregate. When a shape, a length, a pitch or the like of the line electrode is adjusted, it is possible to obtain a desired electrode density. Moreover, FIGS. 38(M) to 38(P) illustrate examples in which line electrodes are asymmetrically arranged in the X-axis direction or the Y-axis direction.

### (Modification 2)

Interlayer arrangement positions (an arrangement position between the metal film 12 and the electrode substrate 20 and an arrangement position between the conductor layer 50 and the electrode substrate 20) of the first and second structural bodies 310 and 410 in the first embodiment may be interchanged. Hereinafter, the input device 100 having such an interchanged configuration will be described.

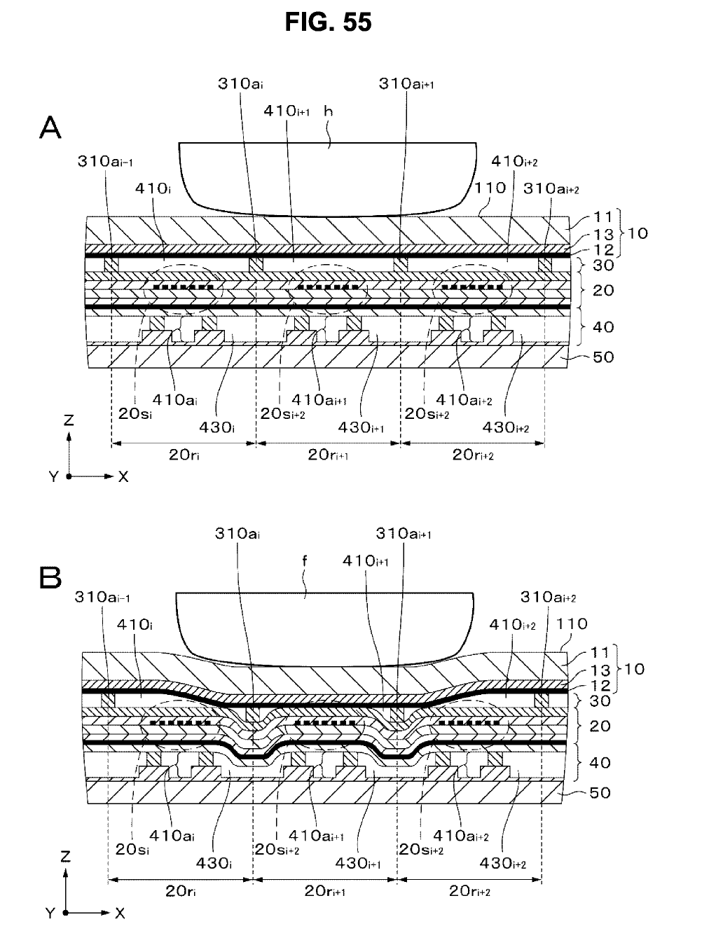

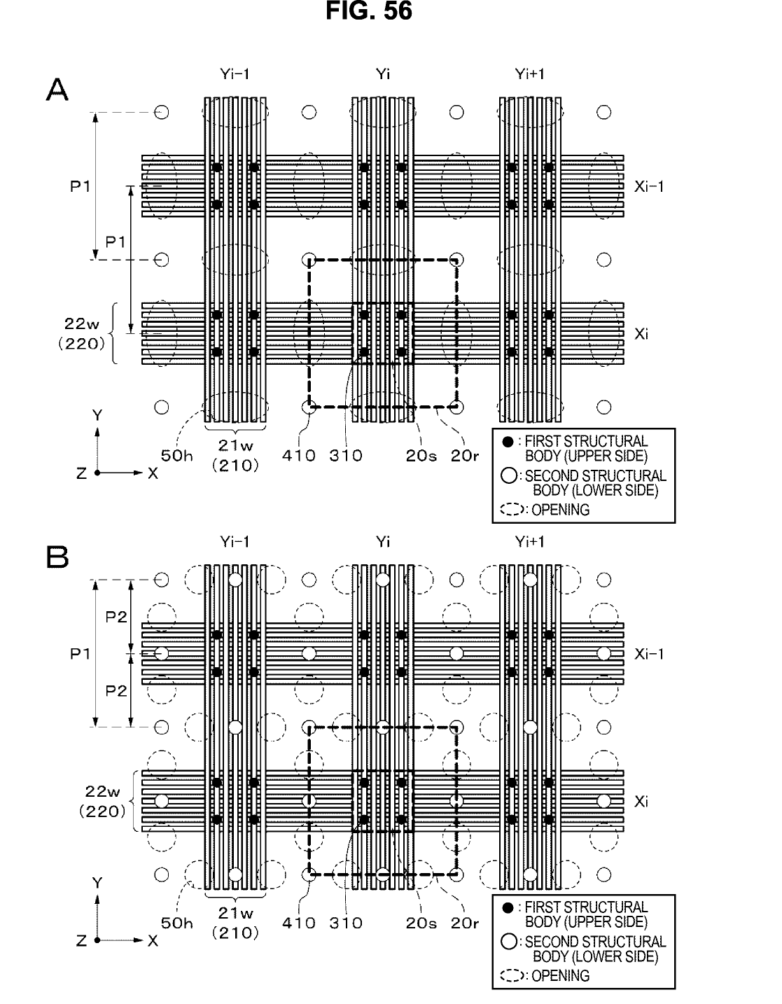

FIG. 55A is a schematic cross-sectional view illustrating a modification of the input device 100 according to the first embodiment of the present disclosure. The first structural body 310a is the same as the second structural body 410 in the first embodiment (that is, an arrangement position in the planar direction, a configuration, a material, a forming method and the like) except that the second structural body 410 in the first embodiment is provided between the metal film 12 and the electrode substrate 20. The second structural body 410a is the same as the first structural body 310 in the first embodiment (that is, an arrangement position in the planar direction, a configuration, a material, a forming method and the like) except that the first structural body 310 in the first embodiment is provided between the conductor layer 50 and the electrode substrate 20. In the input device 100 having such a configuration, the detection unit 20s or the unit detection region 20r may be arranged to face a group including the second structural body 410a or the second structural body 410 in the Z-axis direction. In addition, the two or more second structural bodies 410a are arranged in the unit detection region 20r.

FIG. 55B is a schematic main part cross-sectional view illustrating an aspect of the input device 100 when the first surface 110 receives an operation from the finger f. In FIG. 55B, the operation member 10 (the metal film 12) directly below the operation position receives the greatest force, and the operation member 10 (the metal film 12) directly below the operation position or in the vicinity thereof is deformed toward the electrode substrate 20, and becomes closer to or comes in contact with the electrode substrate 20. In addition, according to the deformation of the operation member 10, a force is applied to a portion corresponding to a gap between the unit detection regions 20rᵢ and 20rᵢ₊₁ and a gap between the unit detection regions 20rᵢ₊₁ and 20rᵢ₊₂ within the electrode substrate 20 through the first structural bodies 310aᵢ and 310aᵢ₊₁. The portion is deformed toward the conductor layer 50, and becomes closer to the conductor layer 50.

### (Modification 3)

While the first embodiment has been described as an example in which the input device 100 has a planar shape, the shape of the input device 100 is not limited thereto. The input device 100 may have, for example, a cylindrical shape, a curved shape, a belt shape, or an irregular shape. As the curved shape, a curved surface having a cross section that has, for example, an arc shape, an elliptical arc shape, or a parabolic shape is exemplified. In addition, the entire input device 100 may have rigidity or flexibility. When the entire input device 100 has flexibility, the input device 100 may also be a wearable device.

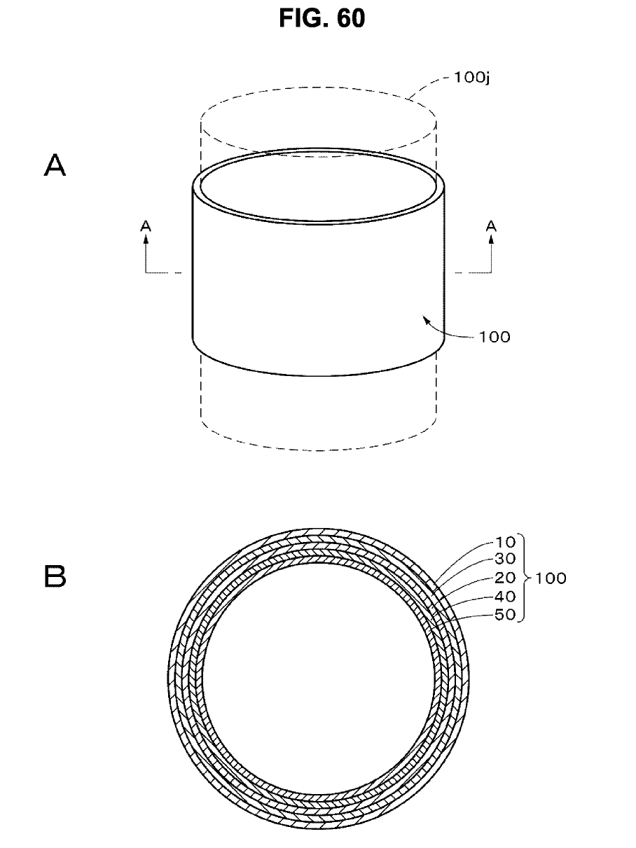

FIG. 60A is a perspective view illustrating an exemplary shape of the input device 100 having a cylindrical shape. FIG. 60B is a cross-sectional view taken along the line A-A of FIG. 60A. Also, in FIG. 60B, in order to facilitate understanding of a layer configuration of the input device 100, a thickness of the input device 100 is shown to be greater than that of FIG. 60A. The flexible display 11 is provided at an outer circumferential surface side of the input device 100, and the conductor layer 50 is provided at an inner circumferential surface side. Therefore, the outer circumferential surface side of the input device 100 functions as an input operation surface and a display surface. The input device 100 may be fitted to a columnar support 100j or a part of human body such as a wrist when used. In addition, the input device 100 having a belt shape may be wound on the columnar support 100j or a part of human body such as a wrist when used.

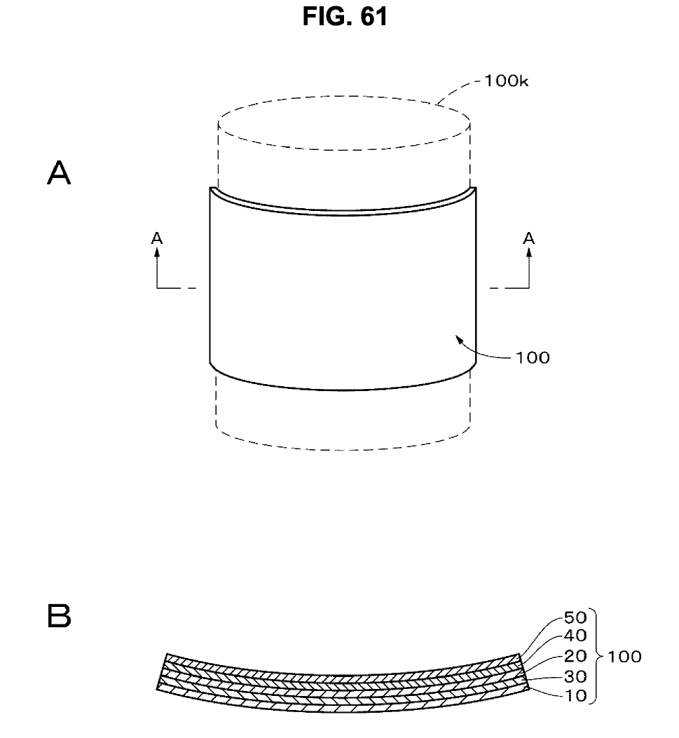

FIG. 61A is a perspective view illustrating an exemplary shape of the input device 100 having a curved shape. FIG. 61B is a cross-sectional view taken along the line A-A of FIG. 61A. Also, in FIG. 61B, in order to facilitate understanding of a layer configuration of the input device 100, a thickness of the input device 100 is shown to be greater than that of FIG. 61A. FIG. 61B illustrates an example in which, when the flexible display 11 is provided at a convex curved surface side and the conductor layer 50 is provided at a concave curved surface side, the convex curved surface side functions as an input operation surface and a display surface. Also, unlike this example, when the flexible display 11 is provided at the concave curved surface side and the conductor layer 50 is provided at the convex curved surface side, the concave curved surface side may function as an input operation surface and a display surface. The input device 100 may be fitted to a support 100k having a convex curved surface or a part of human body such as a wrist when used. In addition, the input device 100 having a belt shape may be put along the support 100k having a convex curved surface or a part of human body such as a wrist when used.

### [Electronic Apparatus]

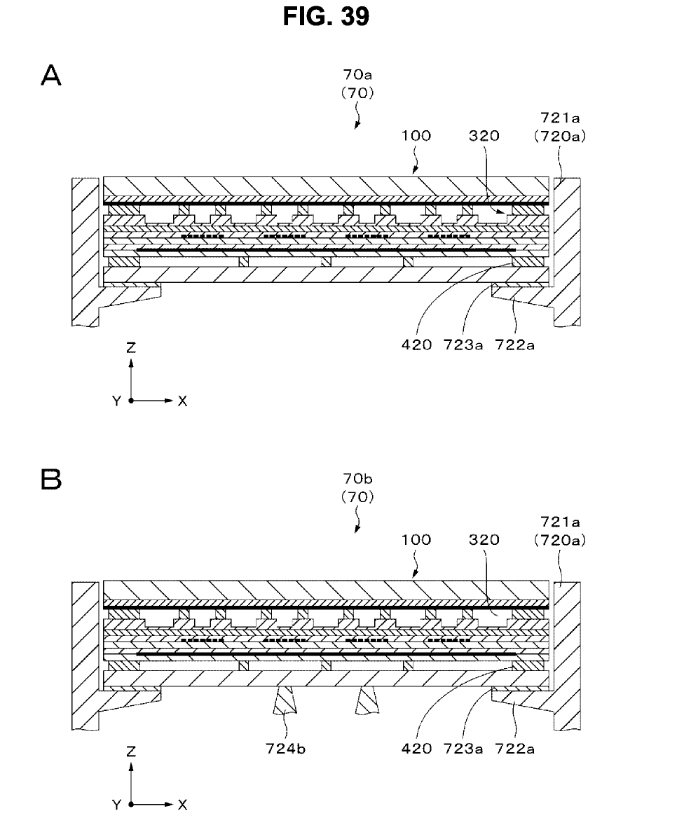

FIG. 39A and FIG. 39B are diagrams illustrating examples in which the input device 100 according to the present embodiment is implemented in the electronic apparatus 70. The electronic apparatus 70a according to FIG. 39A has a case 720a including an opening portion 721a in which the input device 100 is arranged. In addition, a support portion 722a is formed in the opening portion 721a, and supports a circumference portion of the conductor layer 50 through a bonding unit 723a such as a pressure sensitive adhesive tape. In addition, a method of bonding the conductor layer 50 and the support portion 722a is not limited thereto. For example, a screw may be used for fixation.

In addition, in the input device 100 according to the present embodiment, since the first and second frames 320 and 420 are formed along a circumference, it is possible to maintain strength stably even when implementation is performed.

The electronic apparatus 70b according to FIG. 39B has substantially the same configuration as the electronic apparatus 70a, and has a case 720b including the opening portion 721a and the support portion 722a. A difference is that at least one auxiliary support portion 724b supporting a rear surface of the conductor layer 50 is provided. The auxiliary support portion 724b may or may not be bonded to the conductor layer 50 by a pressure sensitive adhesive tape or the like. According to the configuration, it is possible to support the input device 100 more stably.

### 2. Second Embodiment

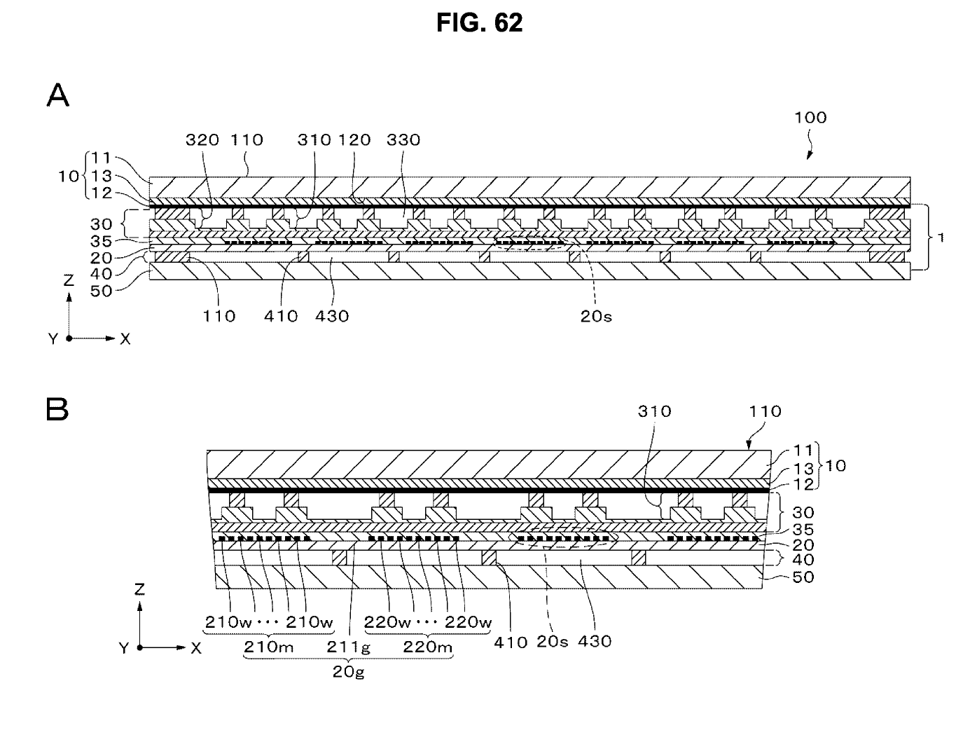

FIG. 62A is a cross-sectional view illustrating an exemplary configuration of the input device 100 according to the second embodiment of the present disclosure. FIG. 62B is a cross-sectional view illustrating an enlarged part of FIG. 62A. The second embodiment is different from the first embodiment in that the electrode substrate 20 includes a wiring substrate 20g. The wiring substrate 20g includes a base material 211g, and a plurality of first electrode lines (Y electrodes) 210s and a plurality of second electrode lines (X electrodes) 220s, which are provided on the same principal surface of the base material 211g.

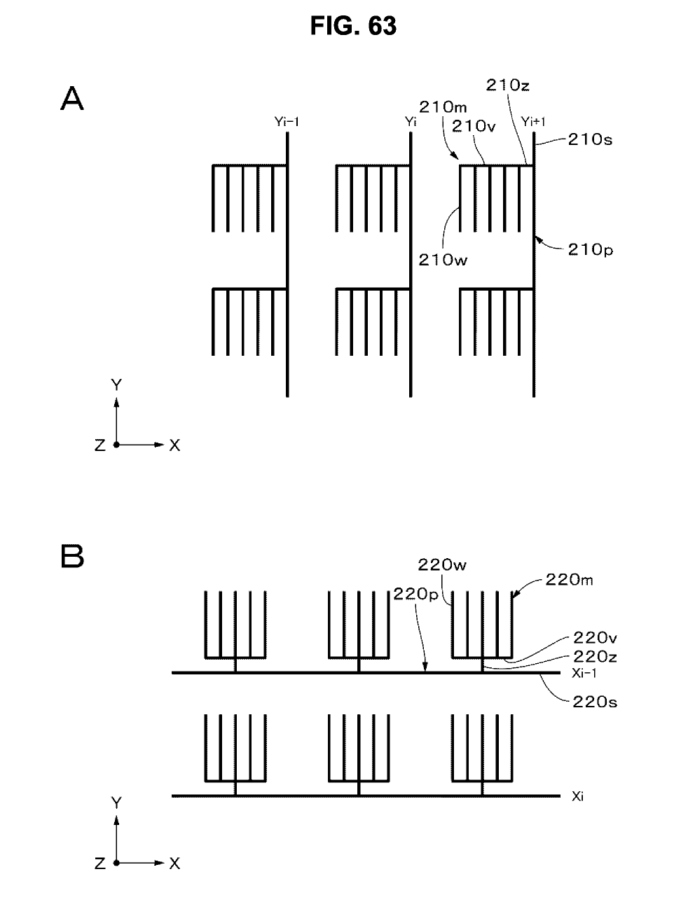

Here, an exemplary configuration of the first electrode line 210s and the second electrode line 220s will be described with reference to FIGS. 63A and 63B. As illustrated in FIG. 63A, the first electrode line 210s includes an electrode line portion 210p, the plurality of unit electrode bodies 210m, and a plurality of connecting portions 210z. The electrode line portion 210p extends in the Y-axis direction. The plurality of unit electrode bodies 210m are arranged in the Y-axis direction at constant intervals. The electrode line portion 210p and the unit electrode body 210m are arranged with a predetermined interval therebetween, and are connected by the connecting portion 210z. Alternatively, a configuration in which no connecting portion 210z is provided and the unit electrode body 210m is directly provided in the electrode line portion 210p may be used.

The unit electrode body 210m has a comb shape as a whole. Specifically, the unit electrode body 210m includes a plurality of sub-electrodes 210w and a coupling unit 210v. The plurality of sub-electrodes 210w extend in the Y-axis direction. The adjacent sub-electrodes 210w are provided with a predetermined interval therebetween. One end of the plurality of sub-electrodes 210w is connected to the coupling unit 210v that extends in the X-axis direction.

As illustrated in FIG. 63B, the second electrode line 220s includes an electrode line portion 220p, the plurality of unit electrode bodies 220m, and a plurality of connecting portions 220z. The electrode line portion 220p extends in the X-axis direction. The plurality of unit electrode bodies 220m are arranged in the X-axis direction at constant intervals. The electrode line portion 220p and the unit electrode body 220m are arranged with a predetermined interval therebetween, and are connected by the connecting portion 220z.

The unit electrode body 220m has a comb shape as a whole. Specifically, the unit electrode body 220m includes a plurality of sub-electrodes 220w and a coupling unit 220v. The plurality of sub-electrodes 210w extend in the Y-axis direction. The adjacent sub-electrodes 220w are provided with a predetermined interval therebetween. One end of the plurality of sub-electrodes 220w is connected to the coupling unit 220v that extends in the X-axis direction.

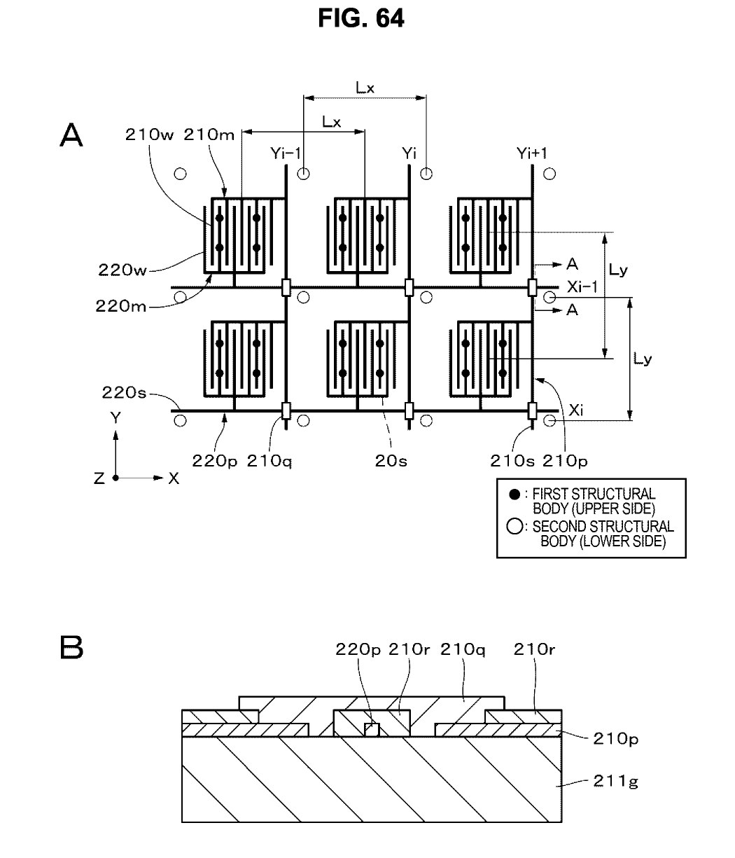

As illustrated in FIG. 64A, the unit electrode bodies 210m and 220m having a comb shape are arranged to face each other such that the sub-electrodes 210w and 220w corresponding to these comb parts are engaged. The plurality of sub-electrodes 210w of the unit electrode body 210m and the plurality of sub-electrodes 220w of the unit electrode body 220m are alternately arranged in the X-axis direction. The sub-electrodes 210w and 220w are provided with a predetermined interval therebetween.

As illustrated in FIG. 64B, an insulating layer 210r is provided on the electrode line portion 220p of the second electrode line 220s. Therefore, a jumper wire 210q is provided to jump the insulating layer 210r. The electrode line portion 210p is connected by the jumper wire 210q.

### 3. Third Embodiment

### 3.1 Configuration of Input Device

The third embodiment is the same as Modification 1 of the first embodiment except that a unit electrode body of one of the first electrode line 210 and the second electrode line 220 is configured as a sub-electrode, and the other unit electrode body is configured as a planar electrode in the input device 100 according to the third embodiment of the present disclosure.

### (First Exemplary Configuration)

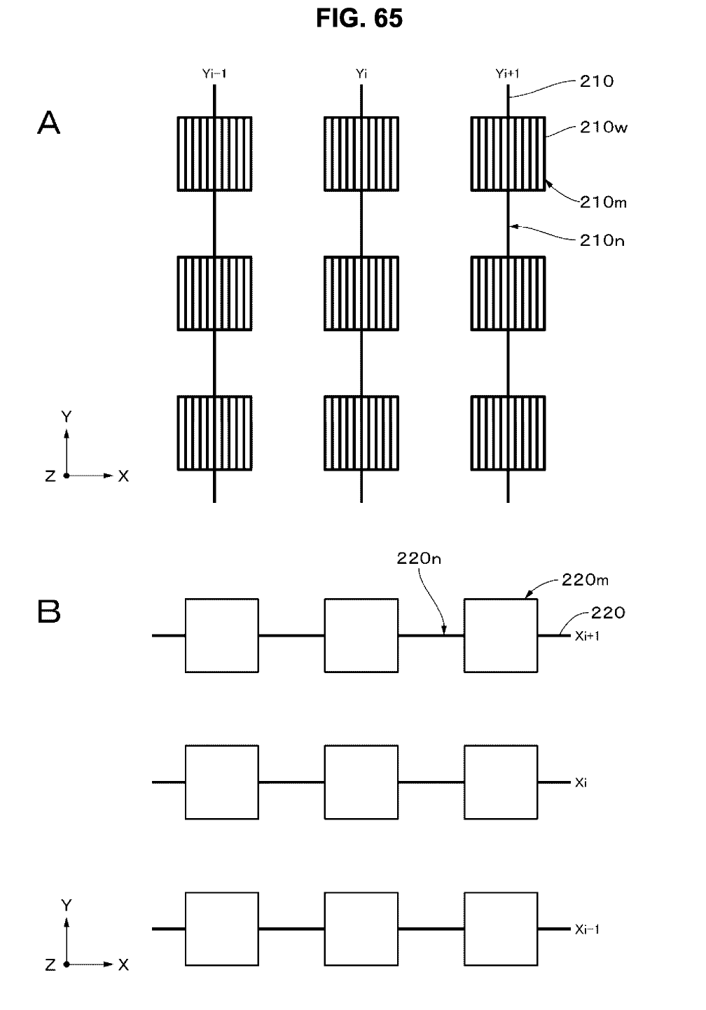

As illustrated in FIG. 65A, the unit electrode body 210m of the first electrode line 210 is configured as the plurality of sub-electrodes 210w. On the other hand, as illustrated in FIG. 65B, the unit electrode body 220m of the second electrode line 220 is configured as a planar electrode.

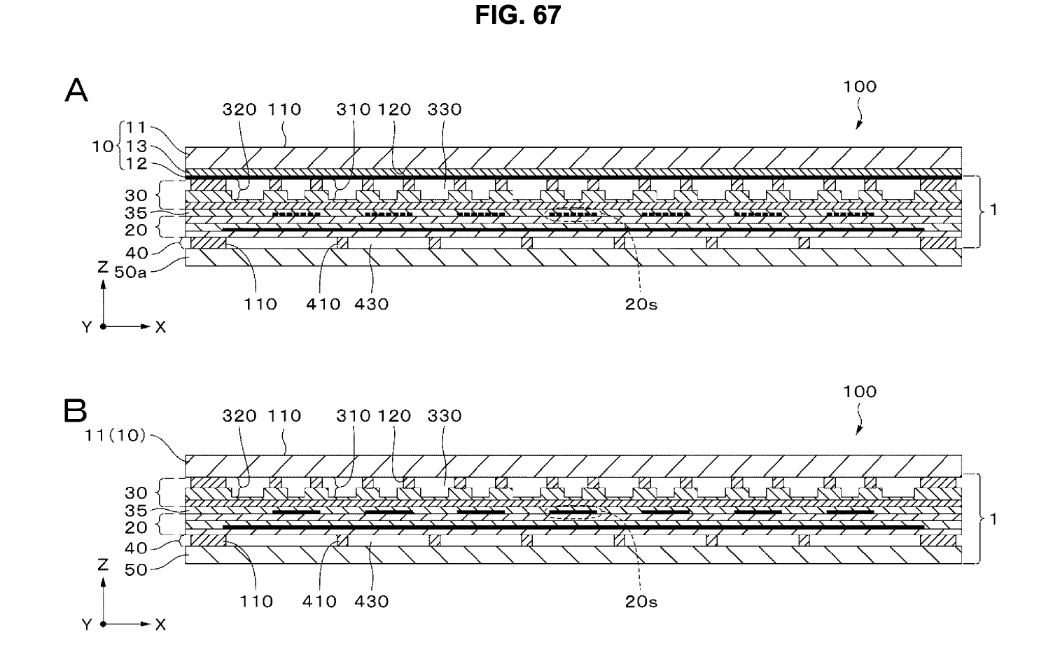

When the first exemplary configuration is used as the configuration of the first and second electrode lines 210 and 220, as illustrated in FIG. 67A, the conductor layer 50 (refer to FIG. 1) facing the second electrode line 220 through the second support 40 is omitted. Alternatively, a polymer resin layer 50a may be used in place of the conductor layer 50. The conductor layer 50 can be omitted in this manner so that the planar electrode (the unit electrode body 220m) included in the second electrode line 220 has an effect of shielding external noise (external electric field). On the other hand, when the conductor layer 50 is used in combination therewith, it is possible to provide a strong shielding effect and the detection unit 20s can be stable against external noise.

### (Second Exemplary Configuration)

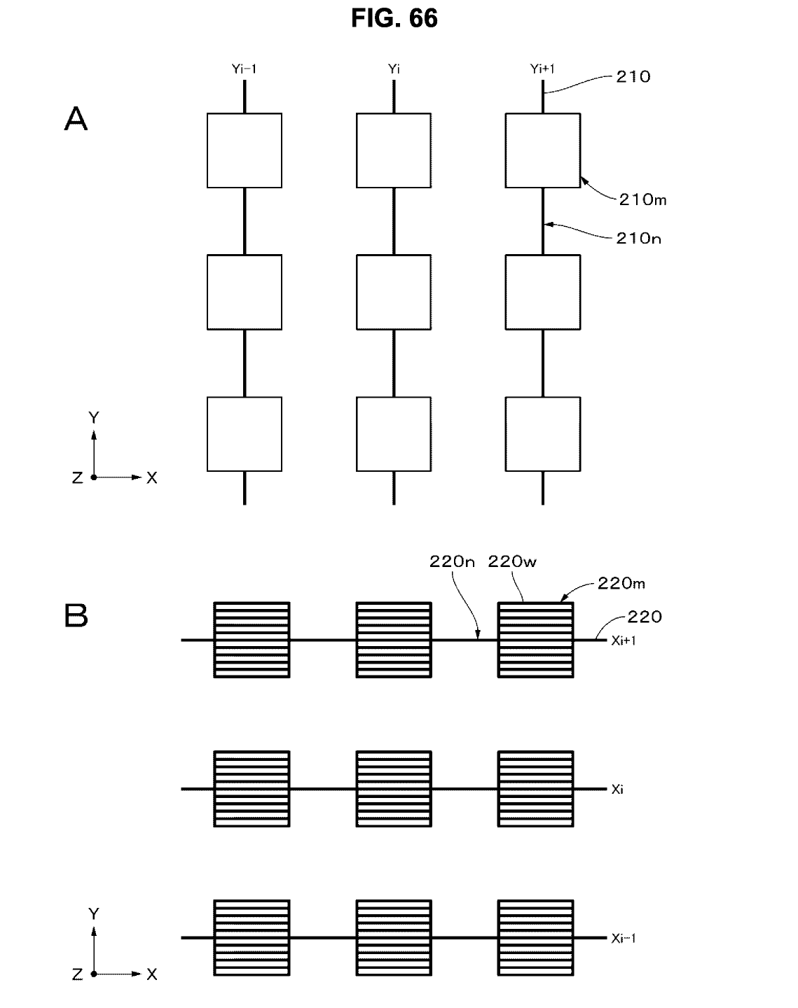

As illustrated in FIG. 66A, the unit electrode body 210m of the first electrode line 210 is configured as a planar electrode. On the other hand, as illustrated in FIG. 66B, the unit electrode body 220m of the second electrode line 220 is configured as the plurality of sub-electrodes 220w.

When the second exemplary configuration is used as the configuration of the first and second electrode lines 210 and 220, as illustrated in FIG. 67B, the metal film 12 (refer to FIG. 1) facing the first electrode line 210 through the first support 30 may be omitted. The metal film 12 can be omitted in this manner so that the planar electrode (the unit electrode body 210m) included in the first electrode line 210 has an effect of shielding external noise (external electric field). On the other hand, when the metal film 12 is used in combination therewith, it is possible to provide a strong shielding effect and the detection unit 20s can be stable against external noise.

Also, the configuration of the first and second electrode lines 210 and 220 is not limited to the above example. Both the unit electrode body 210m of the first electrode line 210 and the unit electrode body 42m of the second electrode line 220 may also be configured as the planar electrode.

### 3.2 Modifications

In the above-described first embodiment, one of the first electrode line 210 and the second electrode line 220 is configured as a plurality of sub-electrodes, and the other may be configured as one planar electrode.

### (First Exemplary Configuration)

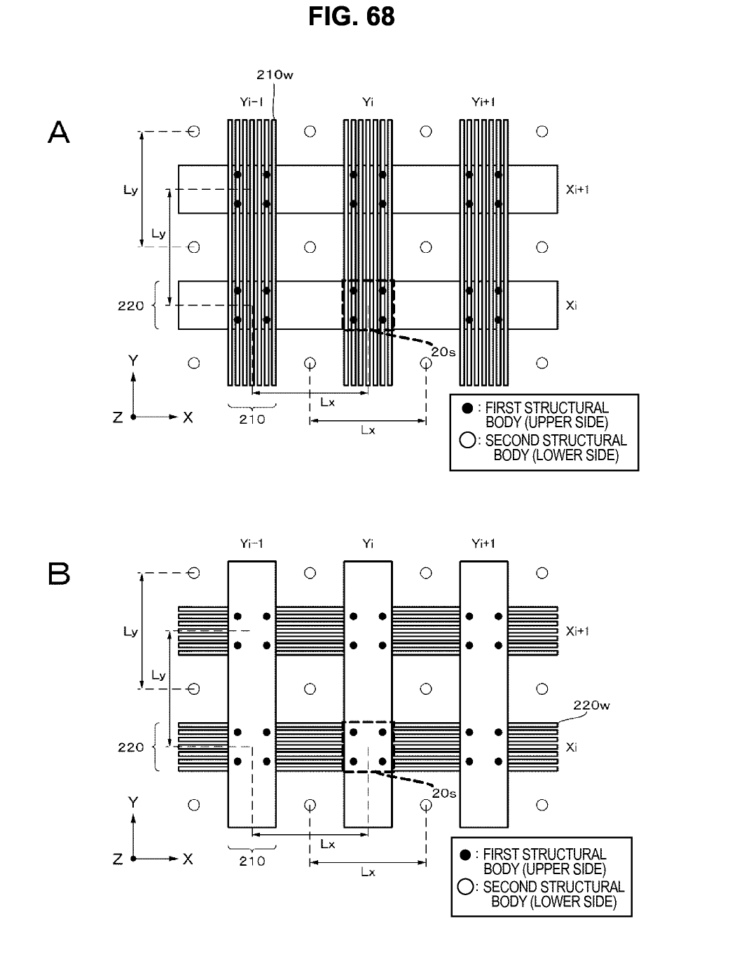

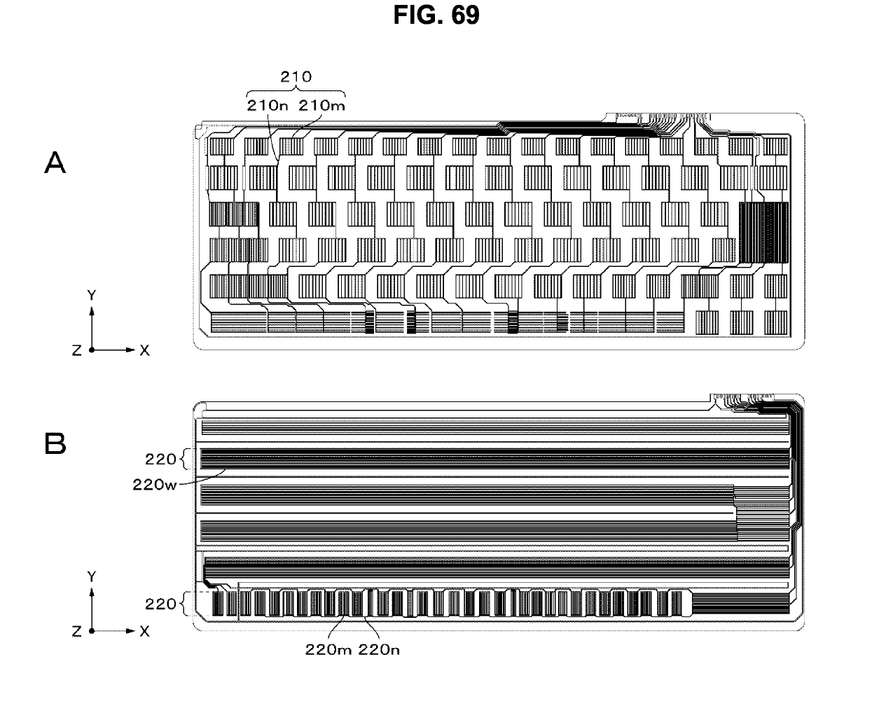

As illustrated in FIG. 68A, the first electrode line 210 is configured as a plurality of sub-electrodes 42w, and the second electrode line 220 is configured as a planar electrode. When such a configuration is used as the configuration of the first and second electrode lines 210 and 220, similar to the first exemplary configuration of the third embodiment, the conductor layer 50 (refer to FIG. 1) facing the second electrode line 220 through the second support 40 is omitted. Alternatively, the polymer resin layer 50a may be used in place of the conductor layer 50.

### (Second Exemplary Configuration)

As illustrated in FIG. 68B, the first electrode line 210 is configured as a planar electrode, and the second electrode line 220 is configured as the plurality of sub-electrodes 220w. When such a configuration is used as the configuration of the first and second electrode lines 210 and 220, similar to the second exemplary configuration of the third embodiment, the metal film 112 (refer to FIG. 1) facing the first electrode line 210 through the first support 30 may be omitted.

Also, the configuration of the first and second electrode lines 210 and 220 is not limited to the above example. Both the first and second electrode lines 210 and 220 may be configured as one electrode having a planar shape.

### 4 Fourth Embodiment

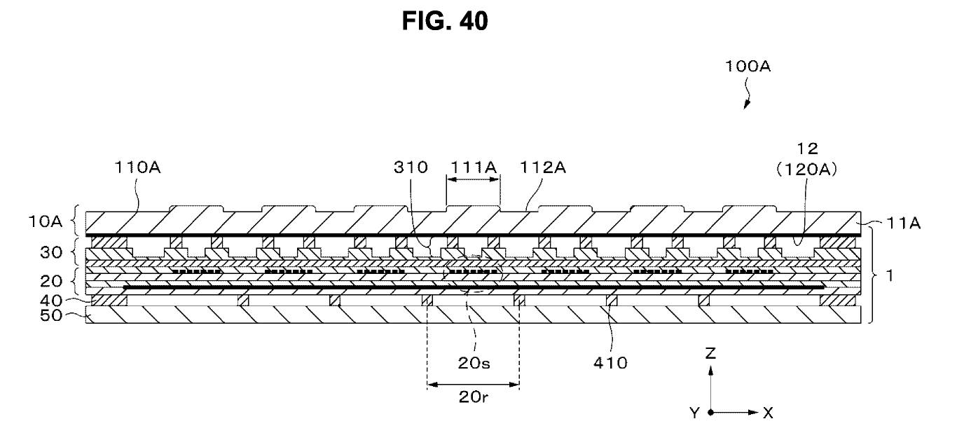

FIG. 40 is a schematic cross-sectional view illustrating one exemplary configuration of the input device 100A according to the fourth embodiment of the present disclosure. A configuration other than the operation member 10A of the input device 100A according to the present embodiment is similar to that of the first embodiment, and descriptions thereof will be appropriately omitted. FIG. 40 is a diagram corresponding to FIG. 1 according to the first embodiment.

### (Entire Configuration)

The input device 100A according to the present embodiment includes a flexible sheet 11A in place of the flexible display and the same sensor device 1 as in the first embodiment. As will be described below, a plurality of key regions 111A are arranged in the flexible sheet 11A, and the entire input device 100A is used as a keyboard device.

### (Input Device)

The flexible sheet 11A is configured as an insulating plastic sheet having flexibility, for example, polyethylene terephthalate (PET), polyethylene naphthalate (PEN), polymethylmethacrylate (PMMA), polycarbonate (PC), or polyimide (PI). A thickness of the flexible sheet 11A is not particularly limited, and is, for example, 0.1 mm to 1 mm.

Also, the flexible sheet 11A is not limited to a single layer structure, but may be configured as a lamination of sheets of two or more layers. In this case, in addition to the plastic sheet, for example, an insulating plastic sheet having flexibility such as PET, PEN, PMMA, PC, or PI may be laminated as a base material.

The flexible sheet 11A includes the first surface 110A serving as an operation surface and the second surface 120A that is a rear surface of the first surface 110A. The plurality of key regions 111A are arranged in the first surface 110A. On the other hand, the metal film 12 may be laminated on the second surface 120A.

The flexible sheet 11A and the metal film 12 may be configured as a composite sheet in which a metallic foil is attached to a surface of a resin sheet in advance, or may be configured as a vapor deposited film or a sputtering film formed on a surface of the second surface 120A. Alternatively, a coating film such as a conductive paste printed on the second surface 120A may be used.

Each of the key regions 111A corresponds to a keytop that is pressed by the user, and has a shape and a size according to a type of key. A key display may be appropriately performed on each of the key regions 111A. The key display may include either or both of display of a type of key and display of a position (outline) of an individual key. An appropriate printing method, for example, screen printing, flexographic printing, or gravure printing, may be used for display.

The first surface 110A has a form in which a groove portion 112A is formed in the periphery of the key region 111A. An appropriate processing technique such as press molding, etching or laser processing can be used to form an uneven surface corresponding to the key region 111A. Alternatively, the flexible sheet 11A having an uneven surface may be formed by a molding technique such as injection molding.

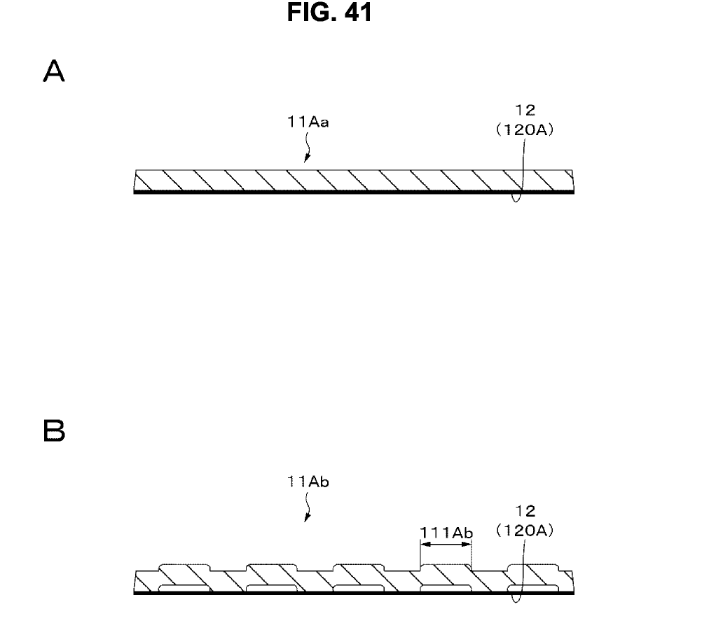

In addition, the configuration of the flexible sheet 11A is not limited to the above example. For example, FIGS. 41A and 41B are diagrams schematically illustrating modifications of the flexible sheet 11A. The flexible sheet 11Aa illustrated in FIG. 41A shows an example in which the first surface 110A is configured as a flat surface. In this case, each of the key regions (not illustrated) may be indicated by printing or the like or the surface may be used as a touch sensor with no key regions. In addition, in the flexible sheet 11Ab illustrated in FIG. 41B, respective key regions 111Ab formed by press molding the flexible sheet 11A are independently and deformably formed in a vertical direction (a sheet thickness direction).

Further, the flexible sheet 11A may be made of a material having conductivity such as a metal. Accordingly, the metal film 12 is unnecessary, and a thickness of the operation member 10A can decrease. In this case, the flexible sheet 11A also functions as the metal film 12, and is connected to, for example, a ground potential.

As illustrated in FIG. 10B, the first electrode line 210 may be configured as the electrode group 21w that includes a group of the plurality of first electrode elements 21z. The first electrode element 21z is, for example, a linear conductive member (sub-electrode) that extends in the Y-axis direction. As illustrated in FIG. 10B, the second electrode line 220 may be configured as the electrode group 22w that includes a group of the plurality of second electrode elements 22z. The second electrode element 22z is, for example, a linear conductive member (sub-electrode) that extends in the X-axis direction. When the flexible sheet 11A has no metal film 12, the plurality of first electrode lines 210 may be configured as a single electrode element (that is, one thick electrode that is not included in a group of the plurality of first electrode elements 21z). Therefore, electrical noise from the outside (external) of the flexible sheet 11A is shielded.

In the present embodiment, the user presses a middle portion of the key region 111A in order to perform a key input operation. Here, the first and second structural bodies 310 and 410 and the detection unit 20s can be arranged as follows.

### Arrangement Example

For example, as illustrated in FIG. 40, the second structural body 410 of the second support 40 may be arranged below the groove portion 112A. In this case, the detection unit 20s is arranged at a position that the first structural body 310 overlaps when viewed in the Z-axis direction and two or more first structural bodies 310 are arranged in the unit detection region 20r. The second structural body 410 is arranged between the unit detection regions 20r.

In Arrangement Example 1, as described in FIG. 12, when a key input operation is performed, a position on the first structural body 310 is pressed, the plurality of first structural bodies 310 below the operation position are displaced downward, and the electrode substrate 20 is deflected. Therefore, the second structural body 410 is also slightly elastically deformed. Accordingly, the metal film 12 and the conductor layer 50 both become closer to the detection unit 20s and it is possible to obtain a change in electrostatic capacitance of the detection unit 20s.

In addition, the shape of the second structural body 410 is not limited to the cylindrical body illustrated in FIGS. 22A and 22B, and may be arranged, for example, in a wall shape along the groove portion 112A. In this case, the respective second structural bodies 410 are arranged along a boundary between the plurality of key regions 111A.

Also, the arrangement of the detection unit 20s is not limited to the above example. For example, the detection unit 20s may be arranged to overlap the second structural body 410.

FIG. 69A is a plan view illustrating an arrangement example of the first electrode lines (Y electrodes) 210. The first electrode line 210 includes the plurality of unit electrode bodies 210m and the plurality of connecting portions 210n that connect the plurality of unit electrode bodies 210m to each other. The unit electrode body 210m is configured as an electrode group that includes a group of the plurality of sub-electrodes (electrode elements) 210w. The plurality of sub-electrodes 210w have a regular or irregular pattern corresponding to the key layout. FIG. 69A illustrates an example in which the plurality of sub-electrodes 210w have an irregular pattern corresponding to the key layout. In this example, specifically, the plurality of sub-electrodes 210w are linear conductive members that extend in the Y-axis direction, and these conductive members are arranged in a stripe shape.

FIG. 69B is a plan view illustrating an arrangement example of the second electrode lines (X electrodes) 220. The second electrode line (X electrode) 220 is an elongated rectangular electrode that extends in the X-axis direction and has a substantially constant width. The rectangular electrode is configured as an electrode group that includes a group of the plurality of sub-electrodes (electrode elements) 220w. The sub-electrode 220w is, for example, a linear conductive member that extends in the X-axis direction.

In addition, as illustrated in FIG. 69B, some of the plurality of second electrode lines (X electrode) 220 may include the plurality of unit electrode bodies 220m and the plurality of connecting portions 220n that connect the plurality of unit electrode bodies 220m to each other.

Here, while the example in which the first electrode line (Y electrode) 210 is provided at a side (upper side) of the metal film 12 and the second electrode line (X electrode) 220 is provided at a side (lower side) of the conductor layer 50 has been described, the second electrode line 220 may be provided at a side (upper side) of the metal film 12 and the first electrode line 210 may be provided at a side of the conductor layer 50.

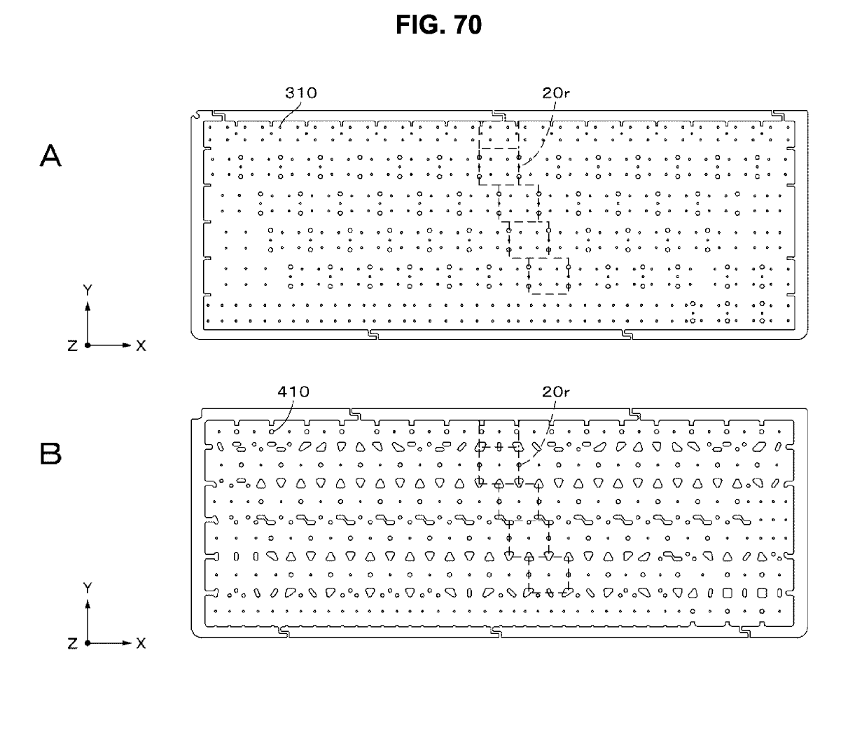

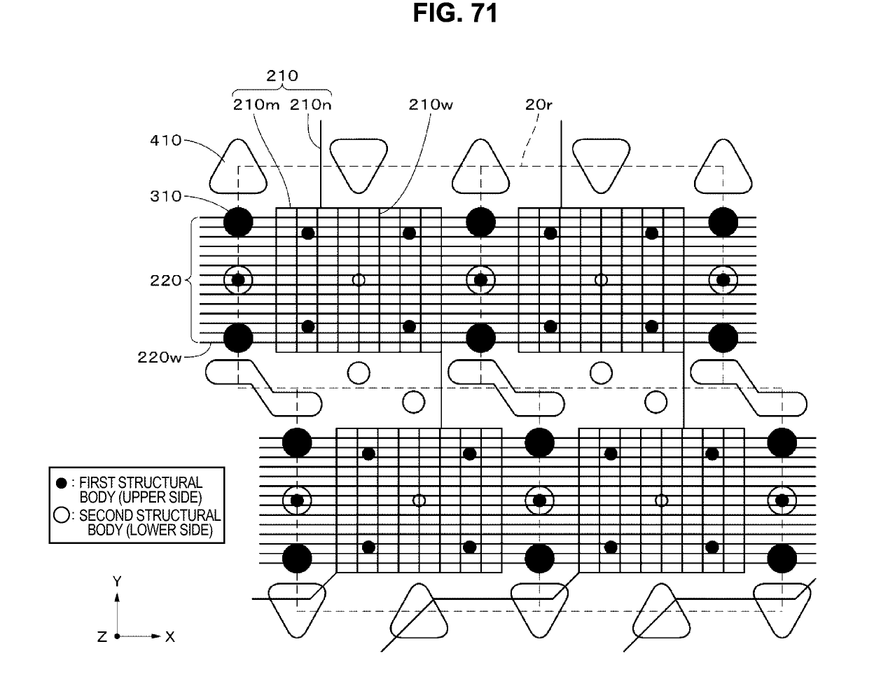

FIG. 70A is a plan view illustrating an arrangement example of the first structural bodies 310. FIG. 70B is a plan view illustrating an arrangement example of the second structural bodies 410. The plurality of first and second structural bodies 310 and 410 are two-dimensionally arranged in a predetermined pattern corresponding to the key layout. The first structural body 310 has a size, a shape or the like that may be changed according to an arrangement position. The size, the shape or the like may be changed according to the arrangement position, similar to the second structural body 410.

FIG. 71 is a plan view illustrating an arrangement relation between the first and second electrode lines 210 and 220 and the first and second structural bodies 310 and 410. The plurality of unit electrode bodies 210m of the first electrode line (Y electrode) 210 are provided to overlap the rectangular second electrode line (X electrode) 220 when viewed in the Z-axis direction.

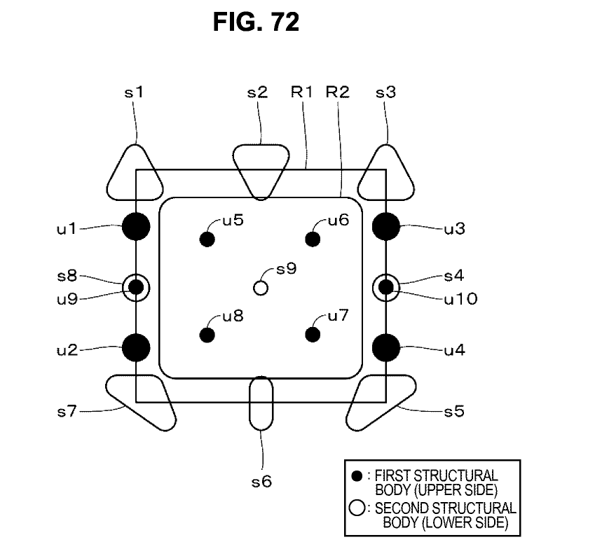

Hereinafter, an arrangement example of the first and second structural bodies 310 and 410 will be described in detail with reference to FIG. 72. Unlike drawing by the operant such as a stylus, when the keyboard device is used, it is preferable that deformation of the metal film 12 and the electrode substrate 20 when the key region 111A is pressed not spread to the adjacent key region 111A.

It is preferable that first and second structural bodies s4 and u10 and first and second structural bodies s8 and u9 be provided to overlap when viewed in the Z-axis direction in a part (that is, the groove portion 112A) between the key regions 111A in the X-axis direction (lateral direction). Therefore, in the parts in which the first and second structural bodies s4 and u10 and the first and second structural bodies s8 and u9 overlap, sensitivity decreases, and spread of deformation in the X-axis direction (lateral direction) decreases.

Also, in a part between the key regions 111A in the Y-axis direction (upper limit direction), a first structural body may be provided on second structural bodies s2 and s6 to overlap when viewed in the Z-axis direction. In this case, spread of deformation in the Y-axis direction (upper limit direction) also decreases.

Also, in a part between the key regions 111A in a direction (diagonal direction) between the X-axis direction and the Y-axis direction, a first structural body may be provided on second structural bodies s1, s3, s5, and s7 to overlap when viewed in the Z-axis direction. In this case, spread of deformation in a direction (diagonal direction) between the X-axis direction and the Y-axis direction also decreases.

It is preferable that a plurality of first structural bodies u5 to u8 be provided in the unit detection region 20r. Accordingly, since a portion corresponding to the unit detection region 20r within the electrode substrate 20 is deformed by the plurality of first structural bodies u5 to u8, sensitivity when the key region 111A is pressed increases. Therefore, a difference between sensitivities when the key region 111A is pressed by a finger and when the key region 111A is pressed by a nail decreases.

It is preferable that intersecting points between the sub-electrodes 210w and 220w be collected in a vicinity of a middle portion of the unit detection region 20r and be inside a region defined by the first structural bodies u5 to u8. Therefore, it is possible to increase load sensitivity.

When the keyboard device is used, it is preferable that a difference between sensitivities when a center of the key region 111A is pressed and when an end of the key region 111A is pressed be small. When first structural bodies u1 to u4, u9, and u10 and second structural bodies s1 to s8 are arranged in a peripheral part of the unit detection region 20r, an amount of deformation of a middle portion of the unit detection region 20r increases and sensitivity tends to increase. In this case, when a second structural body s9 is arranged in a middle portion of the unit detection region 20r, sensitivity in the middle portion of the unit detection region 20r relatively decreases, and a difference between sensitivities of the center of the key region 111A and the end of the key region 111A preferably decreases. Moreover, it is preferable that the intersecting point between the sub-electrodes 210w and 220w be outside of the key region 111A such that sufficient sensitivity is also obtained in the end of the key region 111A.

It is preferable that the first structural bodies u1 to u4, u9, and u10 and the second structural bodies s1 to s8 provided in the peripheral part of the unit detection region 20r be greater than the first structural bodies u4 to u7 and the second structural body s9 provided in the middle portion of the unit detection region 20r. Therefore, it is possible to increase an adhesive force between the metal film 12 and the electrode substrate 20 and between the conductor layer 50 and the electrode substrate 20.

It is preferable that the respective key regions 111A (the unit detection region 20r) not be isolated and that air be able to sufficiently flow between the respective key regions 111A without resistance. Therefore, an internal pressure of the input device 100A in the respective key regions 111A increases, and it is possible to suppress a decrease in sensitivity or occurrence of a return delay.

As described above, the control unit 60 includes the arithmetic operation unit 61 and the signal generating unit 62 and is electrically connected to the electrode substrate 20. In addition, in the present embodiment, the control unit 60 is able to generate a signal corresponding to an input operation with respect to each of the plurality of key regions 111A based on a change in electrostatic capacitance of the plurality of detection units 20s. More specifically, the control unit 60 is able to generate information on the input operation with respect to each of the plurality of key regions 111A based on outputs of the plurality of detection units 20s. That is, the arithmetic operation unit 61 computes the operation position in an XY coordinate system on the first surface 110 based on an electrical signal (input signal) output from each of the first and second electrode lines 210 and 220 of the electrode substrate 20, and determines the key region 111A assigned to the operation position. The signal generating unit 62 generates an operation signal corresponding to the key region 111A in which the pressing is detected.

When the input device 100A is embedded in the electronic apparatus such as a notebook personal computer or a cellular phone, it can be applied as the keyboard device as described above. In addition, the input device 100A includes a communication unit (not illustrated), is electrically connected to other electronic apparatuses such as a personal computer through wired or wireless communication, and is able to perform an input operation for controlling the electronic apparatus.

Moreover, as described in the first embodiment, the input device 100A can also be used as a pointing device. That is, when two or more threshold values are set with respect to an output of each detection unit 20s and the arithmetic operation unit 61 determines a touch operation and a push operation, it is possible to provide the input device in which the pointing device and the keyboard are integrated.

### 5 Fifth Embodiment

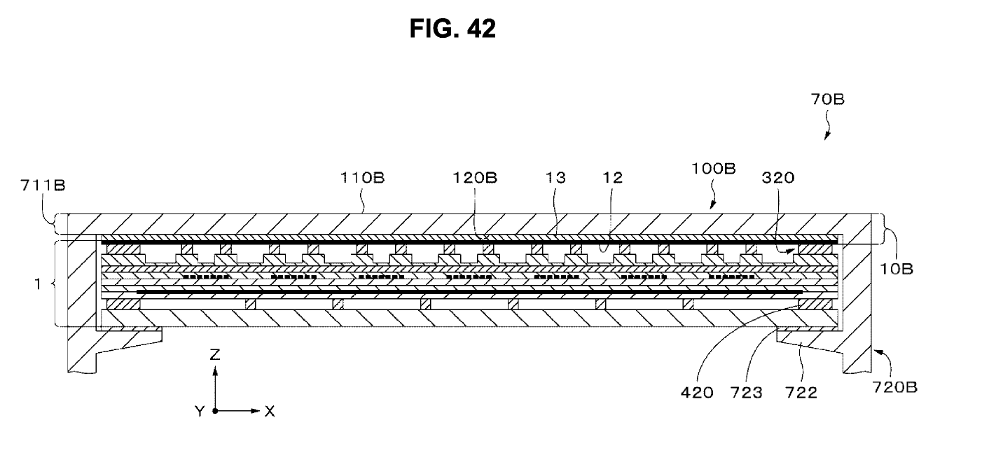

FIG. 42 is a schematic cross-sectional view illustrating one exemplary configuration of the electronic apparatus 70B in which the input device 100B according to the fifth embodiment of the present disclosure is embedded. A configuration other than the operation member 10B of the input device 100B according to the present embodiment is similar to that of the first embodiment, and descriptions thereof will be appropriately omitted.

In the input device 100B according to the present embodiment, a part of a case 720B of the electronic apparatus 70B forms a part of the operation member 10B. That is, the input device 100B includes an operation region 711B forming a part of the case 720B and the same sensor device 1 as in the first embodiment. As the electronic apparatus 70B, for example, a personal computer in which a touch sensor is mounted is applicable.

The operation member 10B has a structure in which the deformable operation region 711B including the first surface 110B and the second surface 120B, and the metal film 12 are laminated. That is, the first surface 110B is one surface of the case 720B, and the second surface 120B is a rear surface (inner surface) of the one surface.

The operation region 711B may be made of, for example, the same material as other regions of the case 720B, for example, a conductor material such as an aluminum alloy or a magnesium alloy, or a plastic material, and has a thickness that is deformable when the user performs a touch operation or a push operation in this case. Alternatively, the operation region 711B may be made of a different material from other regions of the case 720B. In this case, it is possible to use a material having less rigidity than that of the other regions.

In addition, the metal film 12 such as a metallic foil formed in the adhesive layer 13 such as a pressure sensitive adhesive resin film is formed on the second surface 120B. Also, when the operation region 711B is made of a conductor material, the metal film 12 is unnecessary, and a thickness of the operation member 10B can decrease. In this case, the operation region 711B also functions as the metal film 12, and is connected to, for example, a ground potential.

As described above, a part of the case 720B made of a conductor material or the like is used, and thereby the input device 100B according to the present embodiment may be configured. This is because, as described above, the input device 100B detects the input operation using capacitive coupling between the detection unit 20s and each of the metal film 12 pressed by the operant and the conductor layer 50 facing it rather than using capacitive coupling between the operant and the X and Y electrodes. Therefore, according to the input device 100B, it is possible to decrease the number of components of the electronic apparatus 70B and further increase productivity.

In addition, since the input device 100B according to the present embodiment includes the same sensor device 1 as in the above-described first embodiment, it is possible to detect the operation position and the pressing force with high accuracy even with a minute pressing force. Therefore, according to the present embodiment, a limitation on a material of the operation region 711B decreases, and it is possible to provide the input device 100B with high detection sensitivity.

### EXAMPLE

Hereinafter, the present disclosure will be described in detail with reference to test examples, but the present disclosure is not limited to these test examples.

In the following simulations, stress analysis and electrostatic analysis were performed using a finite element method. As a specific program, FEMTET (product name, commercially available from Murata Software Co., Ltd.) was used.

Table 1 shows simulation conditions of the detection unit. In the following simulations, configurations of detection units were set as shown in Table 1. Also, in Table 1, mesh (electrode element) widths Wₓ and W_{y}, mesh (electrode element) intervals dₓ and d_{y}, and electrode widths Eₓ and E_{y} are set as shown in FIGS. 10A and 10B. The mesh intervals dₓ and d_{y} refer to center-to-center intervals of electrode elements forming the mesh.

TABLE 1

| | | | | Detection unit 2 | |
|---|---|---|---|---|---|
| | | Detection unit 1 | | (dense) | |
| Configuration | | Two-layer type | | Two-layer type | |
| | | vertical and | | vertical and | |
| | | horizontal mesh | | horizontal mesh | |
| Sizes of unit detection region | | Lx = 5.6 mm | | Lx = 5.6 mm | |
| | | Ly = 5.8 mm | | Ly = 5.8 mm | |
| Distance between X and Y electrodes | | 0.125 | mm | 0.125 | mm |
| X electrode | Mesh width Wₓ | 0.1 | mm | 0.1 | mm |
| configuration | Number of meshes | 13 meshes | | 10 meshes | |
| | Mesh interval d_{X} | Irregular interval | | 0.3 | mm |
| | | 0.3 mm~0.6 mm | | | |
| | Electrode width E_{X} | 5.14 | mm | 2.8 | mm |
| Y electrode | Mesh width W_{y} | 0.1 | mm | 0.1 | mm |
| configuration | Number of meshes | 14 meshes | | 10 meshes | |
| | Mesh interval d_{y} | Irregular interval | | 0.32 | mm |
| | | 0.28 mm~0.62 mm | | | |
| | Electrode width E_{y} | 5.28 | mm | 2.98 | mm |

Table 2 shows simulation conditions of the input device. In the following simulations, configurations of input devices were set as shown in Table 2.

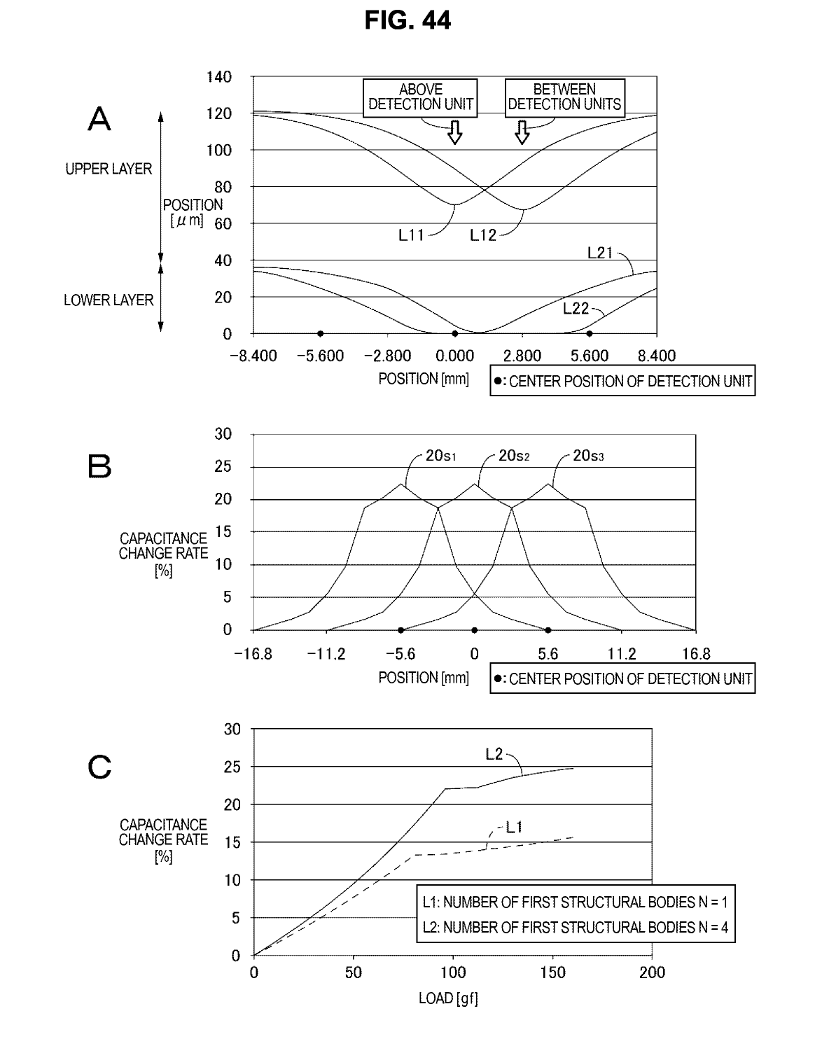

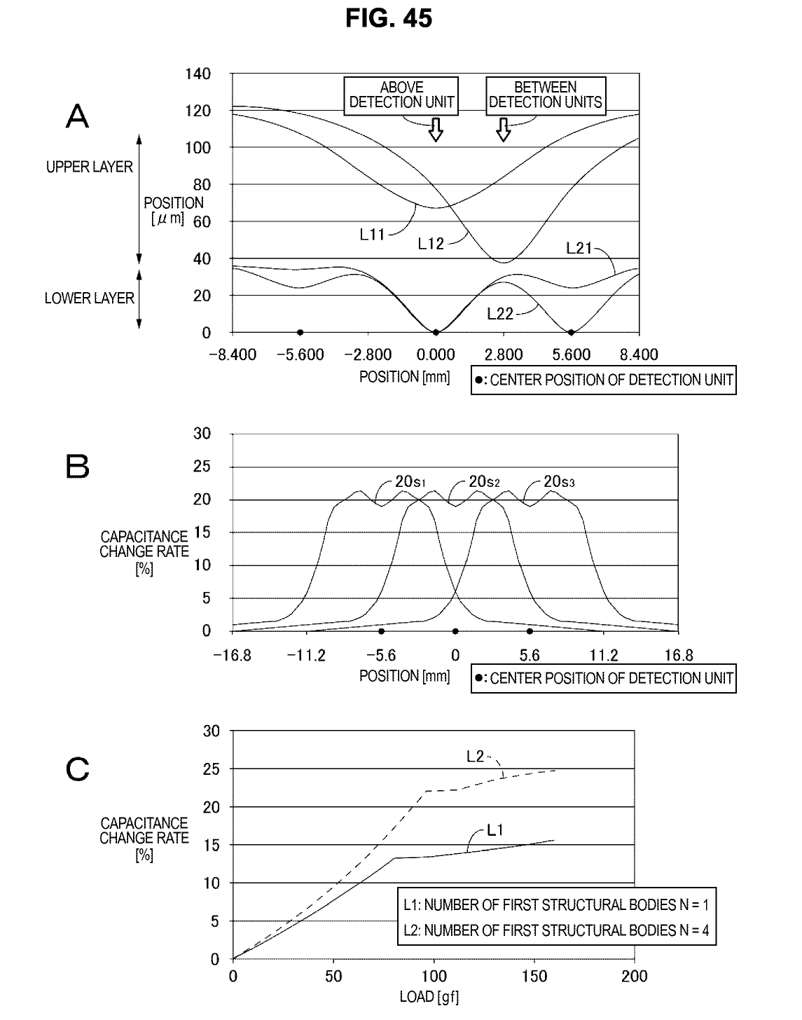

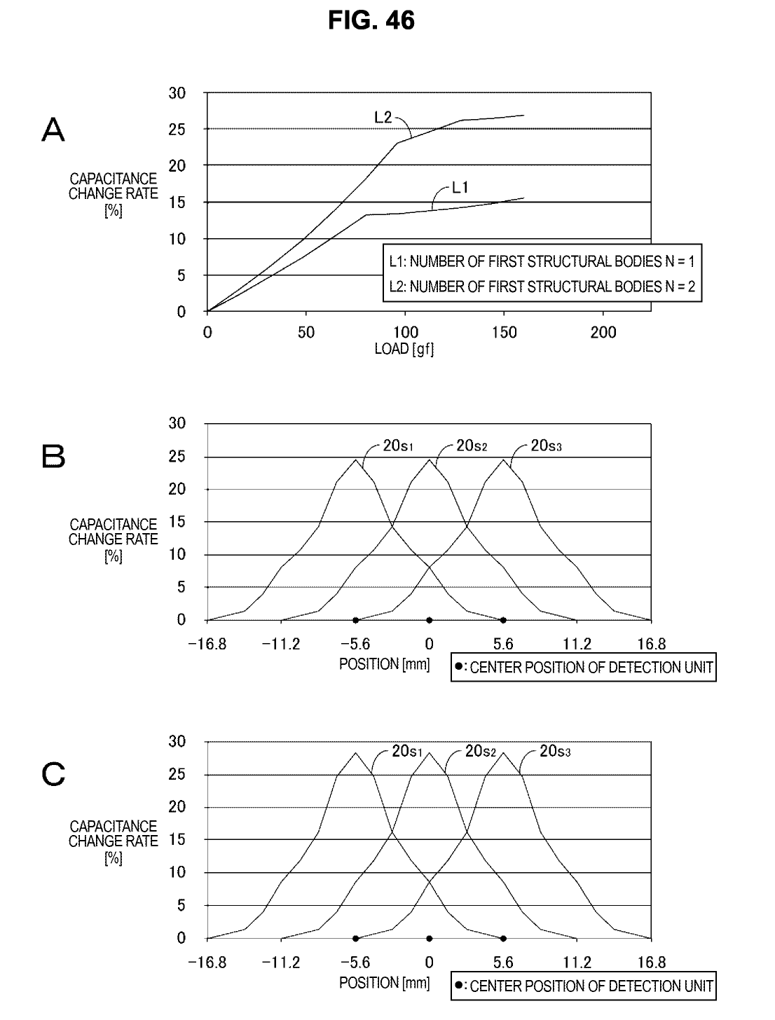

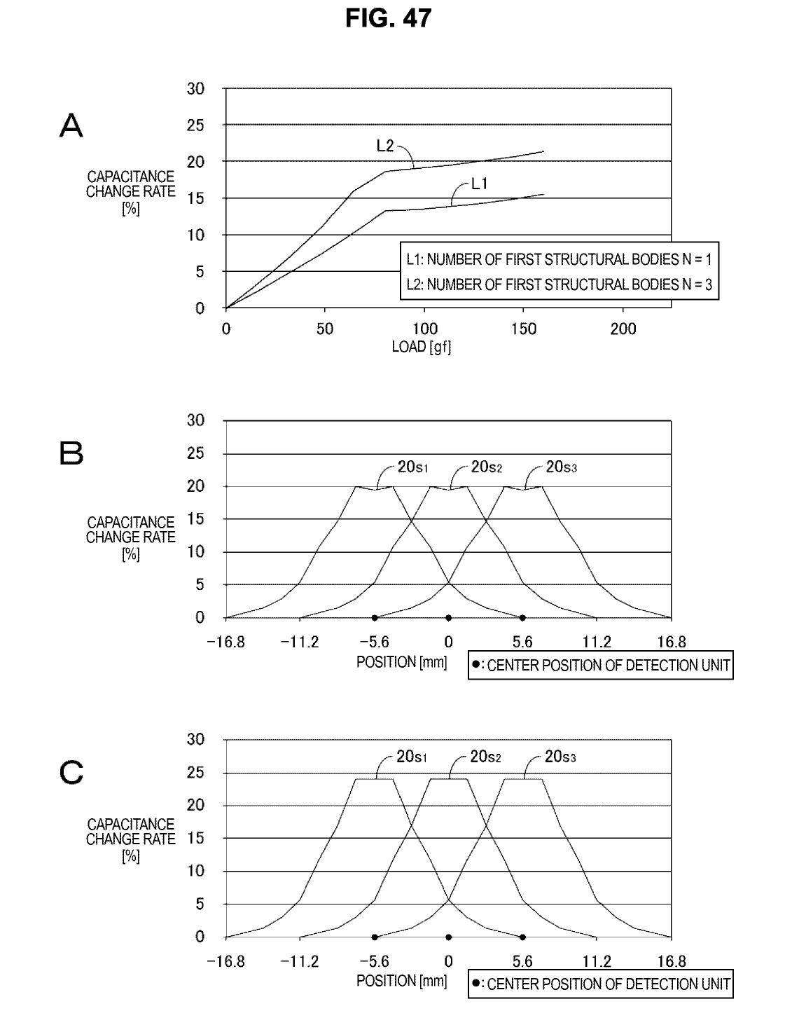

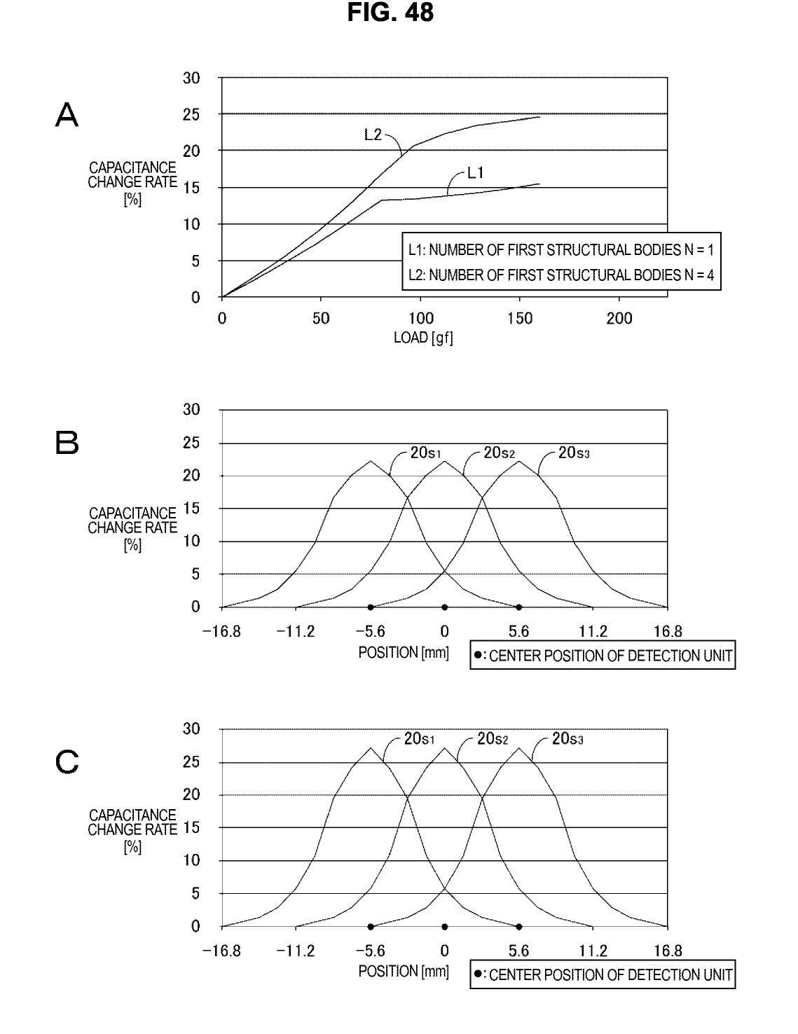

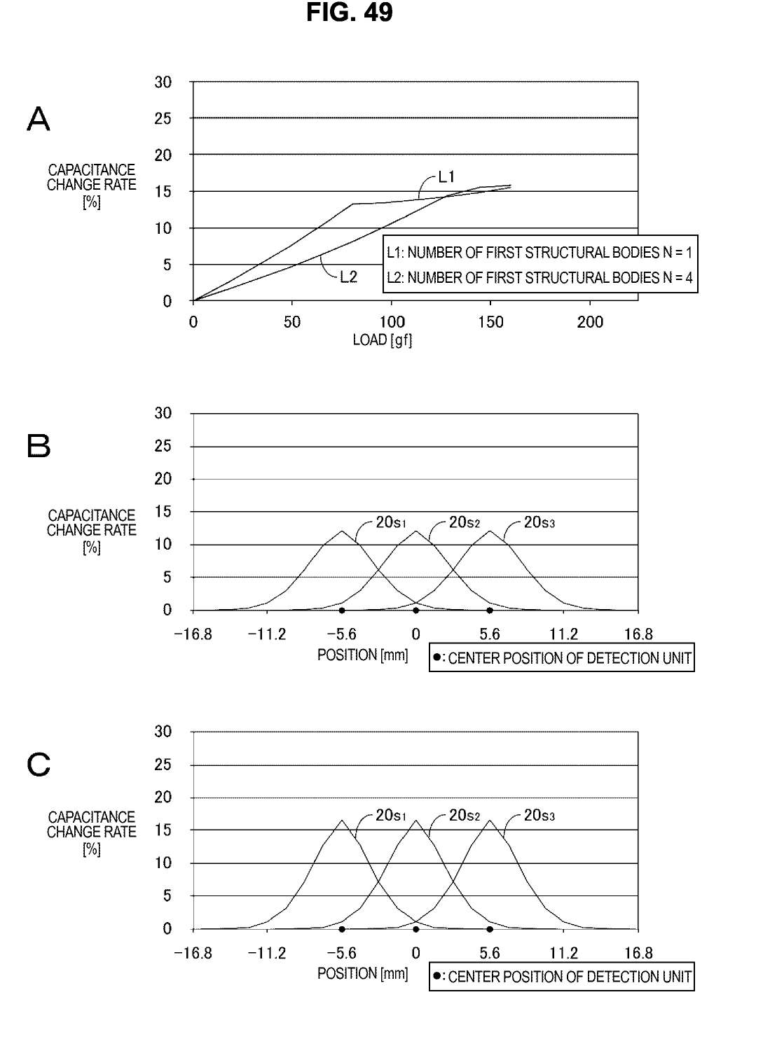

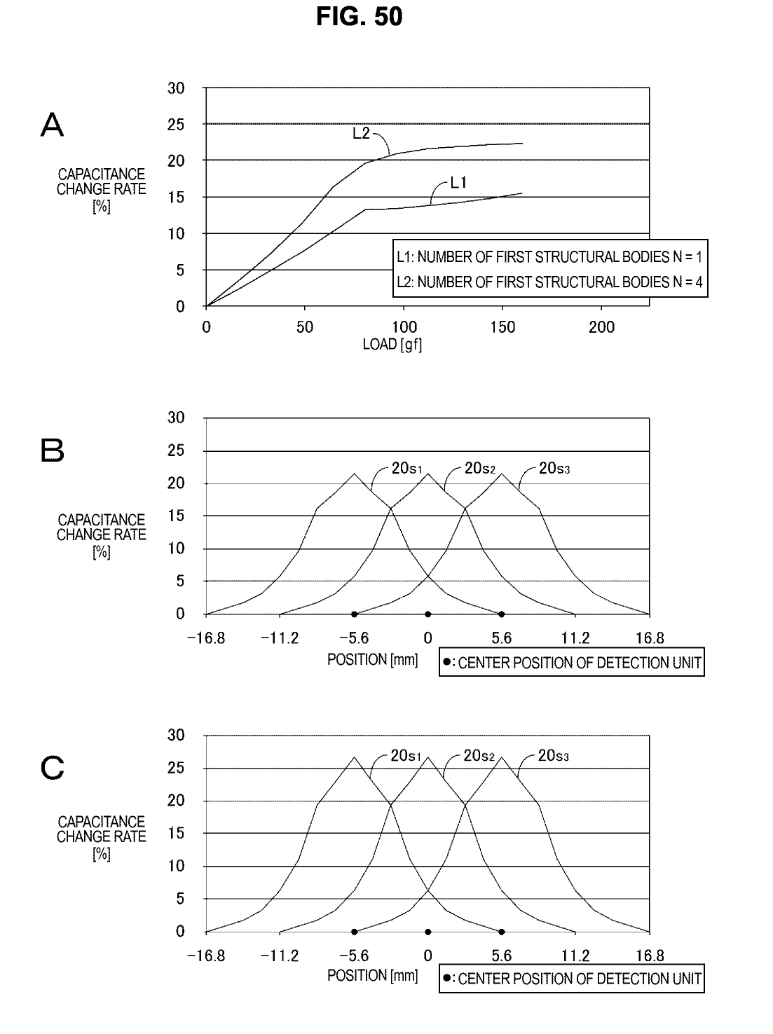

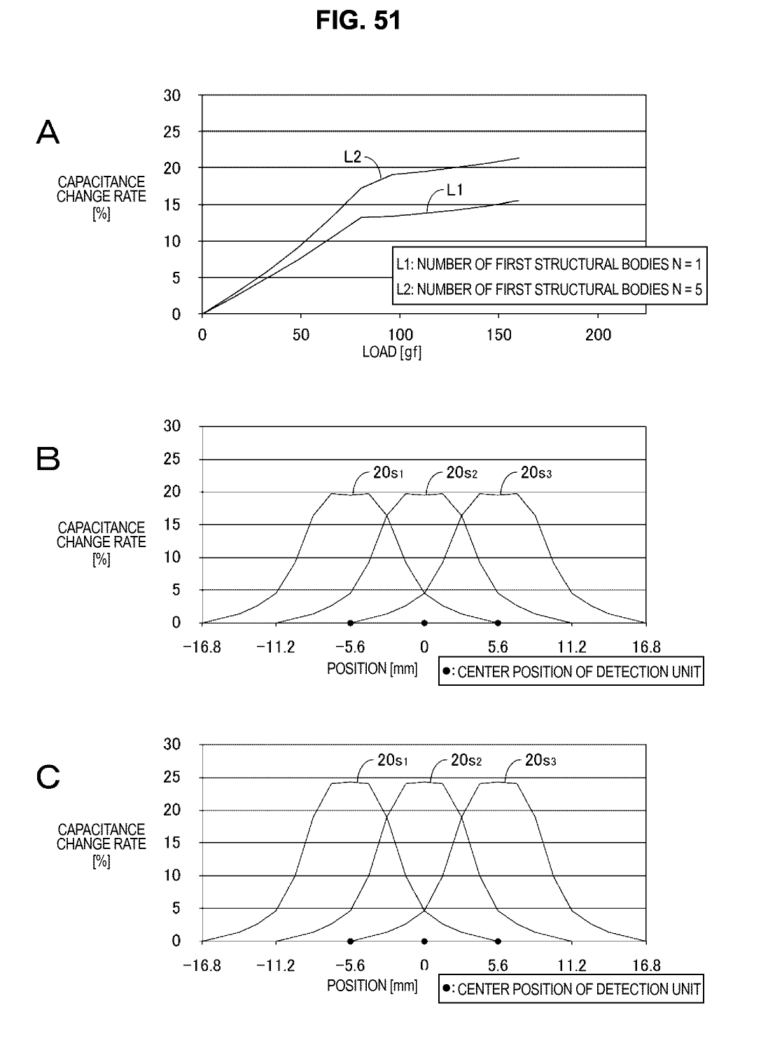

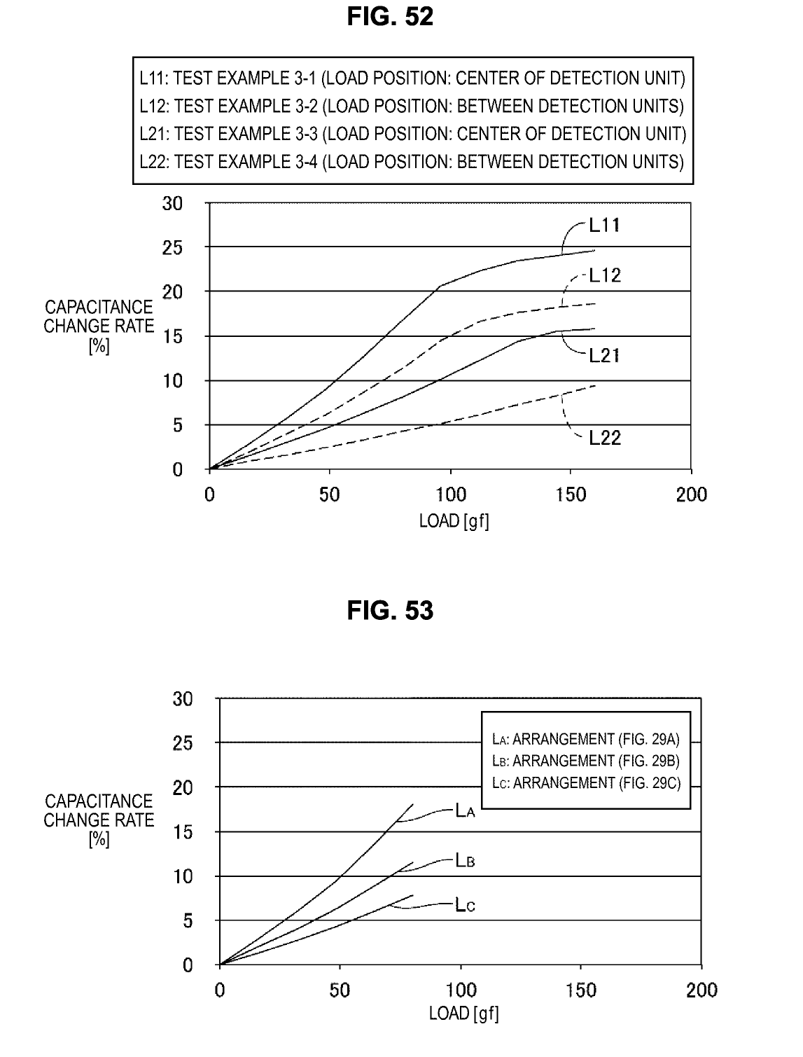

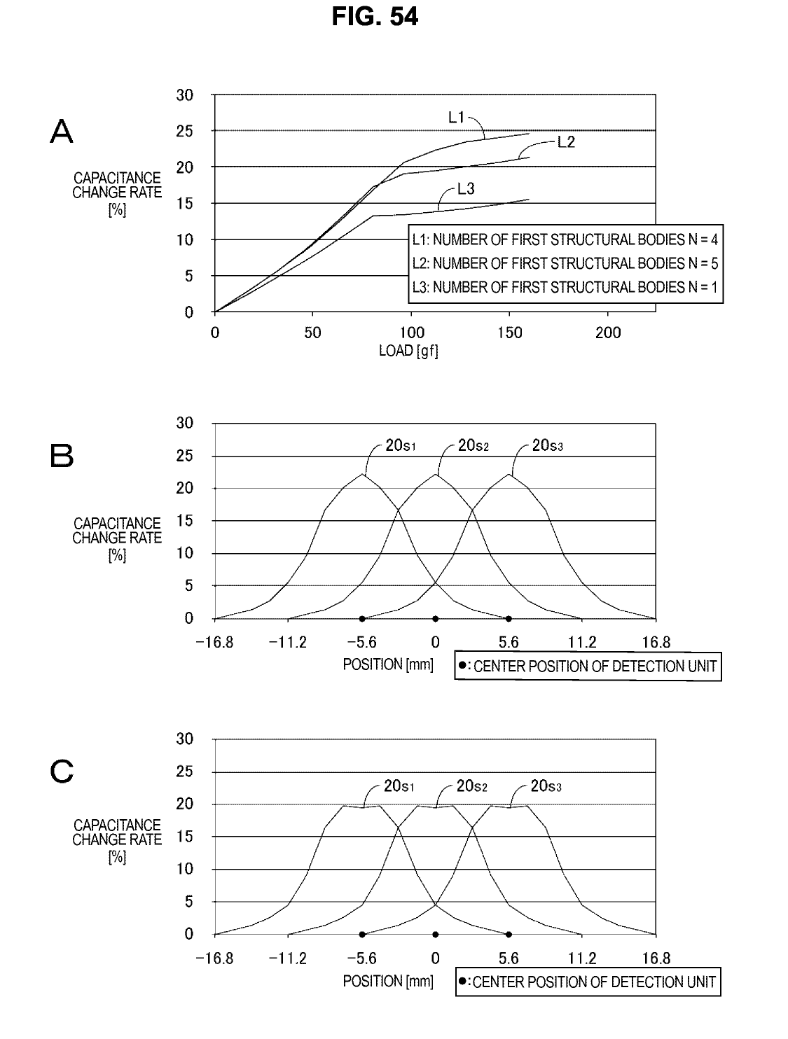

TABLE 2

| | | Number of | | |
|---|---|---|---|---|
| | | first structural | | |
| | | bodies | Arrangement of | |
| | Configuration of | (number/unit | first and second | |
| | detection unit | detection region) | structural bodies | Analysis results |
| Test Example 1-1 | Detection unit 1 | 4 | FIG. 24A | FIG. 44A, FIG. 44B, |
| | | | | and FIG. 44C |
| Test Example 1-2 | Detection unit 1 | 1 | FIG. 26 | FIG. 45A, FIG. 45B, |
| | | | | and FIG. 45C |
| Test Example 2-1 | Detection unit 1 | 2 | FIG. 23A | FIG. 46A and FIG. 46B |
| Test Example 2-2 | Detection unit 2 | 2 | FIG. 23A | FIG. 46C |
| Test Example 2-3 | Detection unit 1 | 3 | FIG. 23B | FIG. 47A and FIG. 47B |
| Test Example 2-4 | Detection unit 2 | 3 | FIG. 23B | FIG. 47C |
| Test Example 2-5 | Detection unit 1 | 4 | FIG. 24A | FIG. 48A and FIG. 48B |
| Test Example 2-6 | Detection unit 2 | 4 | FIG. 24A | FIG. 48C |
| Test Example 2-7 | Detection unit 1 | 4 | FIG. 24B | FIG. 49A and 49B |
| Test Example 2-8 | Detection unit 2 | 4 | FIG. 24B | FIG. 49C |
| Test Example 2-9 | Detection unit 1 | 4 | FIG. 25A | FIG. 50A and FIG. 50B |
| Test Example 2-10 | Detection unit 2 | 4 | FIG. 25A | FIG. 50C |
| Test Example 2-11 | Detection unit 1 | 5 | FIG. 25B | FIG. 51A and FIG. 51B |
| Test Example 2-12 | Detection unit 2 | 5 | FIG. 25B | FIG. 51C |
| Test Example 3-1 | Detection unit 1 | 4 | FIG. 24A | FIG. 52 |
| Test Example 3-2 | Detection unit 1 | 4 | FIG. 24A | FIG. 52 |
| Test Example 3-3 | Detection unit 1 | 4 | FIG. 24B | FIG. 52 |
| Test Example 3-4 | Detection unit 1 | 4 | FIG. 24B | FIG. 52 |
| Test Example 4-1 | Detection unit 1 | 4 | FIG. 28(FIG. 29A) | FIG. 53 |
| Test Example 4-2 | Detection unit 1 | 4 | FIG. 28(FIG. 29B) | FIG. 53 |
| Test Example 4-3 | Detection unit 1 | 4 | FIG. 28(FIG. 29C) | FIG. 53 |
| Test Example 5-1 | Detection unit 1 | 4 | FIG. 24A | FIG. 54A and FIG. 54B |
| Test Example 5-2 | Detection unit 1 | 5 | FIG. 25B | FIG. 54A and FIG. 54C |

Examples of the present disclosure will be described in the following order.

1 Number of first structural bodies arranged in unit detection region
2 Number and arrangement of first structural bodies arranged in unit detection region
3 Arrangement relation between first and second structural bodies
4 Arrangement of second structural bodies
5 Arrangement position of first structural body in unit detection region

### <1 Number of First Structural Bodies Arranged in Unit Detection Region>

First, a difference between characteristics of an input device in which four first structural bodies are arranged in a unit detection region and an input device in which one first structural body is arranged in a unit detection region was examined through simulations.

### Test Example 1-1

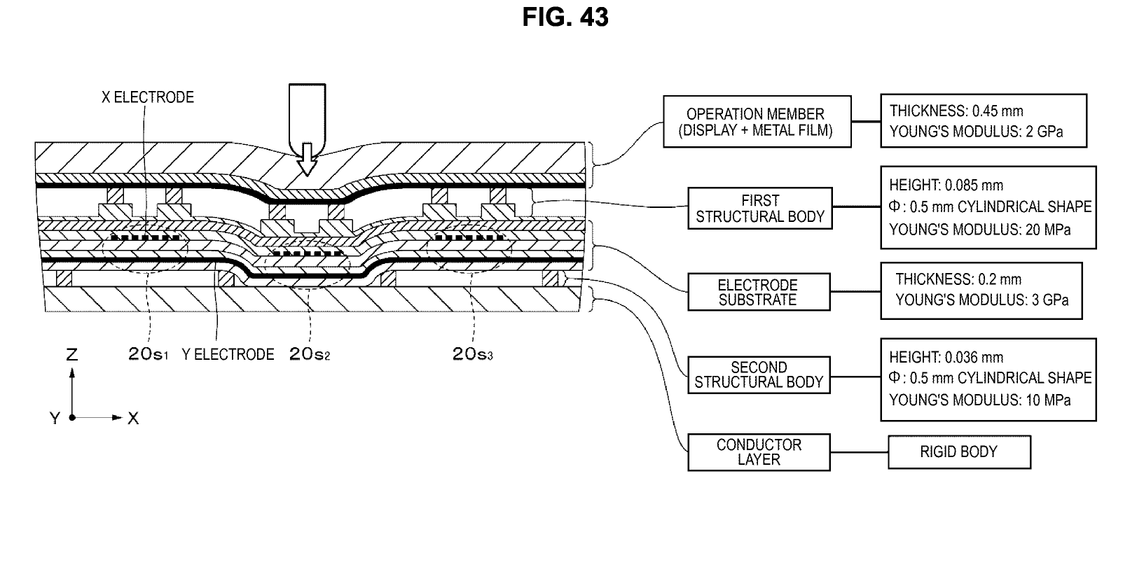

FIG. 43 is a schematic diagram illustrating simulation conditions in Test Example 1. Values of an operation member, a first structural body, an electrode substrate, a second structural body, and a conductor layer which constitute the input device were set as illustrated in FIG. 43. As a configuration of the detection unit included in the electrode substrate, the configuration of the detection unit 1 shown in Table 1 was used. The first structural body and the second structural body were arranged as illustrated in FIG. 24A.

The following (1) to (3) analyses of the input devices in which the above-described conditions were set were performed through simulations. Results thereof are shown in FIGS. 44A to 44C.

(1) A deformation position of the operation member and the electrode substrate when a weight is applied to a position corresponding to a center of the unit detection region within a surface of the operation member (FIG. 43: a deformation position in an XZ cross section)
A deformation position of the operation member and the electrode substrate when a weight is applied to a position corresponding to a gap between unit detection regions within a surface of the operation member (FIG. 43: a deformation position in an XZ cross section)
(2) A change in capacitance change rate distribution of the detection units 20s₁, 20s₂, and 20s₃ corresponding to the weighted position.
(3) Load dependency on the capacitance change rate when a weight is applied to a position corresponding to a center of the unit detection region within a surface of the operation member.

Here, the capacitance change rate was computed by the following formula.

(capacitance change rate)[%]=[(initial capacitance C₀)−(changed capacity C₁)]/(initial capacitance C₀)

In the formula, the terms “initial capacitance C₀” and “changed capacity C₁” specifically indicate the following values.
initial capacitance C₀: an electrostatic capacitance of the input device when no weight is applied to a surface of the operation member.
changed capacity C₁: an electrostatic capacitance of the input device after a weight is applied to a surface of the operation member.

### Test Example 1-2

The first structural body and the second structural body were arranged as illustrated in FIG. 26. Conditions other than the arrangement were the same as those of Test Example 1-1 and the above-described (1) to (3) analyses were performed through simulations. Results thereof are shown in FIGS. 45A to 45C.

### (Simulation Results)

FIGS. 44A to 44C are diagrams illustrating the simulation results of Test Example 1-1. FIGS. 45A to 45C are diagrams illustrating the simulation results of Test Example 1-2. In FIGS. 44A and 45A, the reference numeral “L11” indicates a deformation position of the operation member when a weight is applied to a center of the unit detection region, and the reference numeral “L12” indicates a deformation position of the operation member when a weight is applied between unit detection regions. In FIGS. 44A and 45A, the reference numeral “L21” indicates a deformation position of the electrode substrate when a weight is applied to a center of the unit detection region, and the reference numeral “L22” indicates a deformation position of the electrode substrate when a weight is applied between unit detection regions.

The following can be understood based on comparison of FIGS. 44A and 45A.

When one first structural body is arranged in the unit detection region and a load is applied to a center of the unit detection region, only a portion corresponding to the center of the unit detection region within the electrode substrate is locally deformed downward. On the other hand, when four first structural bodies are arranged in the unit detection region, a wide range of a region surrounded by the four first structural bodies within the electrode substrate is deformed downward.

When one first structural body is arranged in the unit detection region and a load is applied between unit detection regions, a part of the operation member to which the load is applied is locally greatly deformed. On the other hand, when the four first structural bodies are arranged in the unit detection region, even if a load is applied between unit detection regions, great deformation of the part of the operation member to which the load is applied is suppressed.

The following can be understood based on comparison of FIGS. 44B and 45B.

When one first structural body is arranged in the unit detection region, two peaks occur in the capacitance change rate distribution. Therefore, an ideal capacitance change rate distribution in which a capacitance change rate distribution monotonically decreases as a load position is away from the center of the unit detection region is not obtained.

On the other hand, when the four first structural bodies are arranged in the unit detection region, only one peak occurs in the capacitance change rate distribution. Therefore, an ideal capacitance change rate distribution in which a capacitance change rate distribution monotonically decreases as a load position is away from the center of the unit detection region is obtained.

The following can be understood based on comparison of FIGS. 44C and 45C.

When the four first structural bodies are arranged in the unit detection region, it is possible to further increase the capacitance change rate than when one first structural body is arranged in the unit detection region. In addition, when the four first structural bodies are arranged in the unit detection region, it is possible to further increase load sensitivity of the input device than when one first structural body is arranged in the unit detection region. Here, the term “load sensitivity” refers to a slope of a curved line of the capacitance change rate distribution in the vicinity of the load “0 gf.”

### <2 Number and Arrangement of First Structural Bodies Arranged in Unit Detection Region>

Next, while the number and arrangement of first structural bodies arranged in the unit detection region were variously changed, a difference of these characteristics was examined through simulations.

### Test Example 2-1

The first structural bodies and the second structural bodies were arranged as illustrated in FIG. 23A. Conditions other than the arrangement were the same as those of Test Example 1-1 and the above-described (2) and (3) analyses were performed through simulations. Results thereof are shown in FIGS. 46A and 46B.

### Test Example 2-2

As a configuration of the detection unit included in the electrode substrate, the configuration of the detection unit 2 shown in Table 1 was used. Conditions other than the configuration were the same as those of Test Example 2-1 and the above-described (2) analysis was performed through simulations. Results thereof are shown in FIG. 46C.

### Test Example 2-3

The first structural bodies and the second structural bodies were arranged as illustrated in FIG. 23B. Conditions other than the arrangement were the same as those of Test Example 1-1 and the above-described (2) and (3) analyses were performed through simulations. Results thereof are shown in FIGS. 47A and 47B.

### Test Example 2-4

As a configuration of the detection unit included in the electrode substrate, the configuration of the detection unit 2 shown in Table 1 was used. Conditions other than the configuration were the same as those of Test Example 2-3 and the above-described (2) analysis was performed through simulations. Results thereof are shown in FIG. 47C.

### Test Example 2-5

The first structural bodies and the second structural bodies were arranged as illustrated in FIG. 24A. Conditions other than the arrangement were the same as those of Test Example 1-1 and the above-described (2) and (3) analyses were performed through simulations. Results thereof are shown in FIGS. 48A and 48B.

### Test Example 2-6

As a configuration of the detection unit included in the electrode substrate, the configuration of the detection unit 2 shown in Table 1 was used. Conditions other than the configuration were the same as those of Test Example 2-5 and the above-described (2) analysis was performed through simulations. Results thereof are shown in FIG. 48C.

### Test Example 2-7

The first structural bodies and the second structural bodies were arranged as illustrated in FIG. 24B. Conditions other than the arrangement were the same as those of Test Example 1-1 and the above-described (2) and (3) analyses were performed through simulations. Results thereof are shown in FIGS. 49A and 49B.

### Test Example 2-8

As a configuration of the detection unit included in the electrode substrate, the configuration of the detection unit 2 shown in Table 1 was used. Conditions other than the configuration were the same as those of Test Example 2-7 and the above-described (2) analysis was performed through simulations. Results thereof are shown in FIG. 49C.

### Test Example 2-9

The first structural bodies and the second structural bodies were arranged as illustrated in FIG. 25A. Conditions other than the arrangement were the same as those of Test Example 1-1 and the above-described (2) and (3) analyses were performed through simulations. Results thereof are shown in FIGS. 50A and 50B.

### Test Example 2-10

As a configuration of the detection unit included in the electrode substrate, the configuration of the detection unit 2 shown in Table 1 was used. Conditions other than the configuration were the same as those of Test Example 2-9 and the above-described (2) analysis was performed through simulations. Results thereof are shown in FIG. 50C.

### Test Example 2-11

The first structural bodies and the second structural bodies were arranged as illustrated in FIG. 25B. Conditions other than the arrangement were the same as those of Test Example 1-1 and the above-described (2) and (3) analyses were performed through simulations. Results thereof are shown in FIGS. 51A and 51B.

### Test Example 2-12

As a configuration of the detection unit included in the electrode substrate, the configuration of the detection unit 2 shown in Table 1 was used. Conditions other than the configuration were the same as those of Test Example 2-11 and the above-described (2) analysis was performed through simulations. Results thereof are shown in FIG. 51C.

### (Simulation Results)

FIGS. 46A to 46C, 47A to 47C, 48A to 48C, 49A to 49C, 50A to 50C, and 51A to 51C are diagrams illustrating the simulation results of Test Examples 2-1 and 2-2, Test Examples 2-3 and 2-4, Test Examples 2-5 and 2-6, Test Examples 2-7 and 2-8, Test Examples 2-9 and 2-10, and Test Examples 2-11 and 2-12, respectively. In FIGS. 47A, 48A, 49A, 50A and 51A, the simulation result (a curved line L1) of Test Example 1-2 is shown for comparison. In addition, as described above, the simulation of Test Example 1-2 was performed on the input device in which one first structural body was arranged in the unit detection region.

Based on FIGS. 46A to 46C (Test Examples 2-1 and 2-2), when two first structural bodies are symmetrically arranged in the unit detection region as illustrated in FIG. 23A, it can be understood that the following characteristics are obtained as characteristics of the input device.

In the capacitance change rate distribution, one peak may occur at the center of the unit detection region. That is, it is possible to prevent two peaks from occurring in the capacitance change rate distribution. The capacitance change rate distribution has a substantially triangular shape having a center position of the unit detection region as a vertex.

An ideal capacitance change rate distribution in which a capacitance change rate distribution monotonically decreases as the load position is away from the center of the unit detection region is obtained.

Even when the configuration of the detection unit is changed from a detection unit 1 to the detection unit 2 (dense type electrode), the capacitance change rate distribution shows substantially the same tendency. However, when the detection unit 2 is used as the configuration of the detection unit, a peak value of the capacitance change rate distribution is higher than when the detection unit 1 is used as the configuration of the detection unit.

Therefore, in order to increase the peak value of the capacitance change rate distribution, it is preferable that an outer circumference of the detection unit be in an outer circumference of the unit region, and the first structural body included in the unit detection region be arranged between the outer circumference of the detection unit and the outer circumference of the unit region.

Compared to the case in which one first structural body is arranged in the unit detection region, it is possible to increase the capacitance change rate. In addition, compared to the case in which one first structural body is arranged in the unit detection region, it is possible to increase load sensitivity of the input device.

Based on FIGS. 47A to 47C (Test Examples 2-3 and 2-4), when four first structural bodies are symmetrically arranged in the unit detection region as illustrated in FIG. 23B, it can be understood that the following characteristics are obtained as characteristics of the input device.

The capacitance change rate distribution has a substantially trapezoidal shape that is symmetrical to a perpendicular line that passes the center of the unit detection region. Characteristics other than the shape are substantially the same as those of Test Examples 2-1 and 2-2 (FIGS. 46A to 46C). Also, even when the capacitance change rate distribution has the substantially trapezoidal shape, it is possible to perform coordinate calculation based on the capacitance change.

Based on FIGS. 48A to 48C (Test Examples 2-5 and 2-6), when four first structural bodies are symmetrically arranged in the unit detection region as illustrated in FIG. 24A, it can be understood that substantially the same characteristics as those of Test Examples 2-1 and 2-2 (FIGS. 46A to 46C) are obtained.

Based on FIGS. 49A to 49C (Test Examples 2-7 and 2-8), when four first structural bodies are symmetrically arranged in the unit detection region as illustrated in FIG. 24B, it can be understood that the following characteristics are obtained as characteristics of the input device.

Compared to the case in which one first structural body is arranged in the unit detection region, an effect of increasing the capacitance change rate is not obtained. In addition, compared to the case in which one first structural body is arranged in the unit detection region, an effect of increasing load sensitivity of the input device is not obtained. Characteristics other than these characteristics are substantially the same as those of Test Examples 2-1 and 2-2 (FIGS. 46A to 46C).

In view of the above characteristics, it can be understood that both structural bodies are preferably arranged such that the first structural body and the second structural body do not overlap in the thickness direction of the input device. In addition, this will be examined in further detail in test examples to be described below.

Based on FIGS. 50A to 50C (Test Examples 2-9 and 2-10), when four first structural bodies are symmetrically arranged in the unit detection region as illustrated in FIG. 25A, it can be understood that substantially the same characteristics as those of Test Examples 2-1 and 2-2 (FIGS. 46A to 46C) are obtained.

Based on FIGS. 51A to 51C (Test Examples 2-11 and 2-12), when five first structural bodies are symmetrically arranged in the unit detection region as illustrated in FIG. 25B, it can be understood that substantially the same characteristics as those of Test Examples 2-3 and 2-4 (FIGS. 47A to 47C) are obtained.

### <3 Arrangement Relation Between First and Second Structural Bodies>

A difference between characteristics of the input device in which the first and second structural bodies are arranged to overlap in a thickness direction and the input device in which the first and second structural bodies are arranged such that they do not overlap in a thickness direction was examined through simulations.

### Test Example 3-1

The first structural bodies and the second structural bodies were arranged as illustrated in FIG. 24A. Conditions other than the arrangement were the same as those of Test Example 1-1 and the above-described (3) analysis was performed through simulations. Results thereof are shown in FIG. 52.

### Test Example 3-2

The following (4) analysis of the input device in which the same conditions as those of Test Example 3-1 were set was performed through simulations. Results thereof are shown in FIG. 52.

(4) Load dependency on the capacitance change rate when a weight is applied to a position corresponding to a gap between unit detection regions within a surface of the operation member.

### Test Example 3-3

The first structural bodies and the second structural bodies were arranged as illustrated in FIG. 24B. Conditions other than the arrangement were the same as those of Test Example 1-1 and the above-described (3) analysis was performed through simulations. Results thereof are shown in FIG. 52.

### Test Example 3-4

The following (4) analysis of the input device in which the same conditions as those of Test Example 3-3 were set was performed through simulations. Results thereof are shown in FIG. 52.

(4) Load dependency on the capacitance change rate when a weight is applied to a position corresponding to a gap between unit detection regions within a surface of the operation member.

### (Simulation Results)

FIG. 52 is a diagram illustrating the simulation results of Test Examples 3-1 to 3-4. In FIG. 52, curved lines L11, L12, L21, and L22 indicate simulation results of Test Examples 3-1, 3-2, 3-3, and 3-4, respectively.

The following can be understood based on FIG. 52.

The input device having a region in which the first structural body and the second structural body overlap in a thickness direction has a tendency in which the capacitance change rate decreases more than in the input device with no region in which the first structural body and the second structural body overlap in a thickness direction. In particular, the decrease tendency is more significant in the gap between unit detection regions than the center of the unit detection region.

The input device having a region in which the first structural body and the second structural body overlap in a thickness direction has a tendency in which load sensitivity decreases more than in the input device with no region in which the first structural body and the second structural body overlap in a thickness direction. Also, the term “load sensitivity” refers to a slope of a curved line of the capacitance change rate in the vicinity of the load “0 gf” as described above.

### <4 Arrangement of Second Structural Bodies>

While an arrangement position of the second structural body was variously changed, a difference of these characteristics was examined through simulations.

### Test Example 4-1

The first structural body and the second structural body were arranged as illustrated in FIG. 28, and a positional relation with first and second electrode lines was defined such that the region R_{A} (refer to FIG. 29A) became a center portion of the unit detection region. Conditions other than the arrangement were the same as those of Test Example 1-1, and the above-described (3) analysis was performed through simulations. Results thereof are shown in FIG. 53.

### Test Example 4-2

A positional relation with first and second electrode lines was defined such that the region R_{B} (refer to FIG. 29B) became a center portion of the unit detection region. Conditions other than the positional relation were the same as those of Test Example 4-1 and the above-described (3) analysis was performed through simulations. Results thereof are shown in FIG. 53.

### Test Example 4-3

A positional relation with first and second electrode lines was defined such that the region R_{c} (refer to FIG. 29C) became a center portion of the unit detection region. Conditions other than the positional relation were the same as those of Test Example 4-1 and the above-described (3) analysis was performed through simulations. Results thereof are shown in FIG. 53.

FIG. 53 is a diagram illustrating the simulation results of Test Examples 4-1 to 4-3.

According to which of the region R_{A} (FIG. 29A), the region R_{B} (FIG. 29B) and the region R_{c} (FIG. 29C) is set as the center portion of the unit detection region, there is a difference in the capacitance change rate and the load sensitivity.

When the region R_{A} (FIG. 29A) is set as the center portion of the unit detection region, the capacitance change rate and the load sensitivity have the highest values. When the region R_{c} (FIG. 29C) is set as the center portion of the unit detection region, the capacitance change rate and the load sensitivity have the lowest values. When the region R_{B} (FIG. 29B) is set as the center portion of the unit detection region, intermediate values of the capacitance change rates and the load sensitivities of the above two cases are obtained.

Therefore, from the viewpoint of increasing the capacitance change rate and the load sensitivity, it is preferable that the second structural body be arranged between adjacent unit detection regions. That is, it is preferable that the second structural body be arranged such that one entire second structural body is not included in the unit detection region.

In addition, a direction in which the second structural body is arranged is preferably the X-axis direction and/or the Y-axis direction when viewed in the center of the unit detection region, and more preferably a direction (for example, a diagonal direction in the unit detection region) between the X-axis direction and the Y-axis direction.

### <5 Arrangement Position of the First Structural Body in the Unit Detection Region>

A difference between characteristics of the input device in which the first structural body is arranged at the center of the unit detection region and the input device in which the first structural body is arranged to be shifted from the center of the unit detection region was examined through simulations.

### Test Example 5-1

The first structural bodies and the second structural bodies were arranged as illustrated in FIG. 24A. Conditions other than the arrangement were the same as those of Test Example 1-1 and the above-described (2) and (3) analyses were performed through simulations. Results thereof are shown in FIGS. 54A and 54B.

### Test Example 5-2

The first structural bodies and the second structural bodies were arranged as illustrated in FIG. 25B. Conditions other than the arrangement were the same as those of Test Example 1-1 and the above-described (2) and (3) analyses were performed through simulations. Results thereof are shown in FIGS. 54A and 54C.

FIG. 54A is a diagram illustrating the simulation results of Test Examples 5-1 and 5-2. FIG. 54B is a diagram illustrating the simulation results of Test Example 5-1. FIG. 54C is a diagram illustrating the simulation results of Test Example 5-2. Also, in FIG. 54A, curved lines L1 and L2 indicate the simulation results of Test Examples 5-1 and 5-2, respectively. In addition, in FIG. 54A, the simulation result (a curved line L3) of Test Example 1-2 is also shown for comparison.

When the first structural body is arranged to be shifted from the center of the unit detection region, the capacitance change rate distribution has a substantially triangular shape having a peak at a center position of the unit detection region. On the other hand, when the first structural body is arranged at the center of the unit detection region, the capacitance change rate distribution has a substantially trapezoidal shape that is symmetrical to a perpendicular line that passes through the center of the unit detection region. These different shapes of distributions are considered to be caused by the fact that cases in which the first structural body is not in the center of the unit detection region are likely to have the capacitance change rate distribution shape in which the capacitance change rate increases in the center of the unit detection region and the capacitance change rate monotonically decreases from the center of the unit detection region.

When the first structural body is arranged to be shifted from the center of the unit detection region, a maximum capacitance change rate (a capacitance change rate at the center position of the unit detection region) is higher than when the first structural body is symmetrically arranged at the center of the unit detection region. This increased characteristic is considered to be caused by a load being evenly distributed on the symmetrically arranged first structural bodies and a wide range of the electrode substrate being deformed when the first structural body is arranged to be shifted from the center of the unit detection region (refer to FIGS. 32B and 32C). In addition, further deformation of the operation member even after a shape change of the electrode substrate reaches saturation is considered to be one cause of the characteristic increase (refer to FIG. 32C).

While the embodiments of the present disclosure have been described above in detail, the present disclosure is not limited to the above-described embodiments, and various modifications are possible based on technical concepts of the present disclosure.

For example, configurations, methods, processes, shapes, materials and numeric values exemplified in the above-described embodiments are only examples. Different configurations, methods, processes, shapes, materials and numeric values may be used as necessary.

In addition, it is possible to combine configurations, methods, processes, shapes, materials and numeric values of the above-described embodiments with one another without departing from the sprit and scope of the present disclosure.

In addition, the input device may have no metal film, and a change in electrostatic capacitance of the detection unit may be detected by capacitive coupling between the operant and the X electrodes and between the conductor layer and the Y electrodes. In this case, a flexible sheet (refer to the second embodiment) made of an insulating material can be used as the operation member. Even in such a configuration, it is possible to obtain the input device in which first and second supports change distances of the operant and the conductor layer from the detection unit and the operation position and the pressing force are detected with high accuracy.

While it has been described in the above-described embodiments that the detection unit includes the capacity element using the mutual capacitance method, a capacity element using a self-capacitance method may be used. In this case, it is possible to detect the input operation based on an amount of change in electrostatic capacitance of each of the metal film and the conductor layer and an electrode layer included in the detection unit.

In addition, the configuration of the input device is not limited to a planar shape configuration. For example, the input device may be embedded in the electronic apparatus such that the first surface becomes a curved surface. That is, the sensor device of the present disclosure has a flexible configuration as a whole and thus an implementation method with a high degree of freedom is possible.

Additionally, the present technology may also be configured as below.

(1)

A sensor device including:

a first conductor layer having flexibility;

a second conductor layer that is provided to face the first conductor layer;

an electrode substrate that is provided between the first conductor layer and the second conductor layer and has flexibility;

a plurality of first structural bodies that separate the first conductor layer and the electrode substrate; and

a plurality of second structural bodies that separate the electrode substrate and the second conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies are included in each unit region.

(2)

The sensor device according to (1),

wherein the first structural bodies and the second structural bodies are arranged symmetrically with respect to a center of the intersection.

(3)

The sensor device according to (1) or (2),

wherein the first structural bodies and the second structural bodies are provided without overlapping in a thickness direction.

(4)

The sensor device according to any of (1) to (3),

wherein the second structural bodies are provided between the unit regions.

(5)

The sensor device according to any of (1) to (4),

wherein the unit regions are two-dimensionally arranged in a first direction and a second direction, and

wherein the second structural bodies are provided between the unit regions adjacent in a direction between the first direction and the second direction.

(6)

The sensor device according to any of (1) to (5),

wherein the unit region has a square shape or a rectangular shape.

(7)

The sensor device according to any of (1) to (6),

wherein the first structural bodies are provided to be shifted from centers of the unit regions.

(8)

The sensor device according to any of (1) to (7),

wherein the plurality of first structural bodies are two-dimensionally arranged in a first direction and a second direction which are orthogonal to each other, and

wherein the first structural bodies are arranged at equal intervals in both the first direction and the second direction.

(9)

The sensor device according to any of (1) to (8),

wherein the electrode substrate includes a plurality of detection units that are formed in respective intersecting regions between the plurality of first electrodes and the plurality of second electrodes and have a capacity that is variable according to a relative distance to each of the first conductor layer and the second conductor layer.

(10)

The sensor device according to any of (1) to (9), further including:

a first frame that is provided between the first conductor layer and the electrode substrate and provided along a circumference of the electrode substrate; and

a second frame that is provided between the second conductor layer and the electrode substrate and provided to face the first frame.

(11)

The sensor device according to (9),

wherein an outer circumference of the detection unit is inside an outer circumference of one of the unit regions, and at least two of the first structural bodies included in the unit region are arranged between the outer circumference of the detection unit and the outer circumference of the unit region.

(12)

The sensor device according to any of (1) to (11),

wherein four of the first structural bodies are included in each unit region.

(13)

The sensor device according to any of (1) to (12),

wherein the electrode substrate is capable of electrostatically detecting a change in a distance to each of the first conductor layer and the second conductor layer.

(14)

An input device including:

an operation member having flexibility;

a conductor layer that is provided to face the operation member;

an electrode substrate that is provided between the operation member and the conductor layer and has flexibility;

a plurality of first structural bodies that separate the operation member and the electrode substrate; and

a second structural body that separates the conductor layer and the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies are included in each unit region.

(15)

The input device according to (14),

wherein the operation member includes a conductor layer that is provided in a surface facing the conductor layer.

(16)

The input device according to (14) or (15),

wherein the operation member includes a display unit.

(17)

The input device according to any of (14) to (16),

wherein the operation member includes a plurality of key regions.

(18)

The input device according to (17),

wherein the electrode substrate includes a plurality of detection units that are formed in respective intersecting regions between the plurality of first electrodes and the plurality of second electrodes and have a capacity that is variable according to a relative distance to each of the conductor layer and the operation member.

(19)

The input device according to (18), further including:

a control unit configured to generate a signal according to an input operation with respect to each of the plurality of key regions based on a change in electrostatic capacitance of the plurality of detection units.

(20)

The input device according to any of (17) to (19),

wherein the plurality of first structural bodies are provided along a boundary between the plurality of key regions.

(21)

An electronic apparatus including:

an operation member having flexibility;

a conductor layer that is provided to face the operation member;

an electrode substrate that is provided between the operation member and the conductor layer and has flexibility;

a plurality of first structural bodies that separate the operation member and the electrode substrate;

a plurality of second structural bodies that separate the conductor layer and the electrode substrate; and

a control unit configured to generate a signal according to an input operation with respect to the operation member based on a change in electrostatic capacitance of the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(23)

A sensor device including:

a first conductor layer having flexibility;

a second conductor layer that is provided to face the first conductor layer;

an electrode substrate that is provided between the first conductor layer and the second conductor layer and has flexibility;

a plurality of first structural bodies that separate the first conductor layer and the electrode substrate; and

a plurality of second structural bodies that separate the electrode substrate and the second conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies or at least two of the second structural bodies are included in each unit region.

(24)

An input device comprising:

an operation member having flexibility;

a conductor layer that is provided to face the operation member;

an electrode substrate that is provided between the operation member and the conductor layer and has flexibility;

a plurality of first structural bodies that separate the operation member and the electrode substrate; and

a second structural body that separates the conductor layer and the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies or at least two of the second structural bodies are included in each unit region.

(25)

An electronic apparatus including:

an operation member having flexibility;

a conductor layer that is provided to face the operation member;

an electrode substrate that is provided between the operation member and the conductor layer and has flexibility;

a plurality of first structural bodies that separate the operation member and the electrode substrate;

a second structural body that separates the conductor layer and the electrode substrate; and

a control unit configured to generate a signal according to an input operation with respect to the operation member based on a change in electrostatic capacitance of the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies or at least two of the second structural bodies are included in each unit region.

Additionally, the present technology may also be configured as below.

(1)

A sensor device including:

a first conductor layer having flexibility;

a second conductor layer;

an electrode substrate that is provided between the first conductor layer and the second conductor layer and has flexibility;

a plurality of first structural bodies that separate the first conductor layer and the electrode substrate; and

a plurality of second structural bodies that separate the electrode substrate and the second conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(2)

The sensor device according to (1),

wherein at least two of the first structural bodies are included in each unit region.

(3)

The sensor device according to (1) or (2),

wherein the first structural bodies and the second structural bodies are arranged symmetrically with respect to a center of the intersection.

(4)

The sensor device according to any of (1) to (3),

wherein the first structural bodies and the second structural bodies are provided without overlapping in a thickness direction.

(5)

The sensor device according to (2),

wherein the second structural bodies are provided between the unit regions.

(6)

The sensor device according to (2),

wherein the unit regions are two-dimensionally arranged in a first direction and a second direction, and

wherein the second structural bodies are provided between the unit regions adjacent in a direction between the first direction and the second direction.

(7)

The sensor device according to (2),

wherein the first structural bodies are provided to be shifted from centers of the unit regions.

(8)

The sensor device according to (2),

wherein the plurality of first structural bodies are two-dimensionally arranged in a first direction and a second direction which are orthogonal to each other, and

wherein the first structural bodies are arranged at equal intervals in both the first direction and the second direction.

(9)

The sensor device according to any of (1) to (8),

wherein the electrode substrate includes a plurality of detection units that are formed in respective intersecting regions between the plurality of first electrodes and the plurality of second electrodes and have a capacity that is variable according to a relative distance to each of the first conductor layer and the second conductor layer.

(10)

The sensor device according to any of (1) to (9), further including:

a first frame that is provided between the first conductor layer and the electrode substrate and provided along a circumference of the electrode substrate; and

a second frame that is provided between the second conductor layer and the electrode substrate and provided to face the first frame.

(11)

The sensor device according to (9),

wherein an outer circumference of the detection unit is inside an outer circumference of one of the unit regions, and at least two of the first structural bodies included in the unit region are arranged between the outer circumference of the detection unit and the outer circumference of the unit region.

(12)

The sensor device according to any of (1) to (11),

wherein four of the first structural bodies are included in each unit region.

(13)

The sensor device according to any of (1) to (12),

wherein the electrode substrate is capable of electrostatically detecting a change in a distance to each of the first conductor layer and the second conductor layer.

(14)

An input device including:

an operation member having flexibility;

a conductor layer;

an electrode substrate that is provided between the operation member and the conductor layer and has flexibility;

a plurality of first structural bodies that separate the operation member and the electrode substrate; and

a plurality of second structural bodies that separate the conductor layer and the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(15)

The input device according to (14),

wherein the operation member includes a conductor layer that is provided in a surface facing the conductor layer.

(16)

The input device according to (14) or (15),

wherein the operation member includes a display unit.

(17)

The input device according to any of (14) to (16),

wherein the operation member includes a plurality of key regions.

(18)

The input device according to (17),

wherein the electrode substrate includes a plurality of detection units that are formed in respective intersecting regions between the plurality of first electrodes and the plurality of second electrodes and have a capacity that is variable according to a relative distance to each of the conductor layer and the operation member.

(19)

The input device according to (18), further including:

a control unit configured to generate a signal according to an input operation with respect to each of the plurality of key regions based on a change in electrostatic capacitance of the plurality of detection units.

(20)

The input device according to any of (17) to (19),

wherein the plurality of second structural bodies are provided along a boundary between the plurality of key regions.

(21)

The input device according to any of (17) to (20),

wherein some of the plurality of first structural bodies and the plurality of second structural bodies are provided to overlap in a thickness direction in a boundary between the plurality of key regions.

(22)

An electronic apparatus including:

an operation member having flexibility;

a conductor layer;

an electrode substrate that is provided between the operation member and the conductor layer and has flexibility;

a plurality of first structural bodies that separate the operation member and the electrode substrate;

a plurality of second structural bodies that separate the conductor layer and the electrode substrate; and

a control unit configured to generate a signal according to an input operation with respect to the operation member based on a change in electrostatic capacitance of the electrode substrate,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(23)

A sensor device including:

a first conductor layer having flexibility;

a second conductor layer that is provided to face the first conductor layer;

an electrode substrate that is provided between the first conductor layer and the second conductor layer and has flexibility;

a plurality of first structural bodies that separate the first conductor layer and the electrode substrate; and

a plurality of second structural bodies that separate the electrode substrate and the second conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies are included in each unit region.

(24)

A sensor device including:

a first layer having flexibility;

a second layer;

an electrode substrate that is provided between the first layer and the second layer and has flexibility;

a plurality of first structural bodies that separate the first layer and the electrode substrate; and

a plurality of second structural bodies that separate the electrode substrate and the second layer,

wherein at least one of the first layer and the second layer includes a conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(25)

The sensor device according to (24),

wherein at least two of the first structural bodies are included in each unit region, and

wherein the first layer and the second layer include a conductor layer.

(26)

An input device including:

a first layer that includes an operation member and has flexibility;

a second layer;

an electrode substrate that is provided between the first layer and the second layer and has flexibility;

a plurality of first structural bodies that separate the first layer and the electrode substrate; and

a plurality of second structural bodies that separate the electrode substrate and the second layer,

wherein at least one of the first layer and the second layer includes a conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(27)

An electronic apparatus including:

a first layer that includes an operation member and has flexibility;

a second layer;

an electrode substrate that is provided between the first layer and the second layer and has flexibility;

a plurality of first structural bodies that separate the first layer and the electrode substrate;

a plurality of second structural bodies that separate the second layer and the electrode substrate; and

a control unit configured to generate a signal according to an input operation with respect to the operation member based on a change in electrostatic capacitance of the electrode substrate,

wherein at least one of the first layer and the second layer includes a conductor layer,

wherein the electrode substrate includes a plurality of first electrodes and a plurality of second electrodes that intersect the plurality of first electrodes,

wherein a plurality of unit regions are provided to correspond to respective intersections between the first electrodes and the second electrodes, and

wherein at least two of the first structural bodies and/or at least two of the second structural bodies are included in each unit region.

(28)

A sensor device including:

a first layer having flexibility;

a second layer;

an electrode substrate that is provided between the first layer and the second layer and has flexibility;

a plurality of first structural bodies that separate the first layer and the electrode substrate; and

a plurality of second structural bodies that separate the electrode substrate and the second layer,

wherein at least one of the first layer and the second layer includes a conductor layer,

wherein the electrode substrate includes a plurality of first electrodes having a plurality of first unit electrode bodies and a plurality of second electrodes having a plurality of second unit electrode bodies,

wherein a detection unit is configured as a combination of the first electrode bodies and the second electrode bodies,

wherein a plurality of unit regions are provided to correspond to the detection unit, and

wherein at least two of the first structural bodies and/or at least two of the second structural bodies are included in each unit region.

(29)

The sensor device according to (28),

wherein the first electrode bodies and the second electrode bodies are arranged to face each other.

(30)

The sensor device according to (28) or (29),

wherein the plurality of first electrodes and the plurality of second electrodes intersect each other.

(31)

The sensor device according to (28),

wherein the first unit electrode body includes a plurality of first sub-electrodes,

wherein the second unit electrode body includes a plurality of second sub-electrodes, and

wherein the detection unit includes the plurality of first sub-electrodes and the plurality of second sub-electrodes which are alternately arranged on the same plane.

### REFERENCE SIGNS LIST

1 sensor device
100, 100A, 100B input device
10, 10A, 10B operation member
11 flexible display (display unit)
12 metal film (first conductor layer)
20 electrode substrate
20s detection unit
20r unit detection region
210 first electrode line
220 second electrode line
30 first support
310 first structural body
320 first frame
330 first space portion
40 second support
410 second structural body
420 second frame
430 second space portion
50 conductor layer (second conductor layer)
51 step portion
60 control unit
70, 70B electronic apparatus
710 controller

1. A sensor device comprising:
a first conductor layer having flexibility;
a second conductor layer;
an electrode substrate that is provided between the first conductor layer and the second conductor layer and has flexibility;
a plurality of first structural bodies that separate the first conductor layer and the electrode substrate; and
a plurality of second structural bodies that separate the electrode substrate and the second conductor layer,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

2. The sensor device according to claim 1,
wherein at least two of the first structural bodies are included in each unit region.

3. The sensor device according to claim 1,
wherein the first structural bodies and the second structural bodies are arranged symmetrically with respect to a center of the intersection.

4. The sensor device according to claim 1,
wherein the first structural bodies and the second structural bodies are provided without overlapping in a thickness direction.

5. The sensor device according to claim 2,
wherein the second structural bodies are provided between the unit regions.

6. The sensor device according to claim 2,
wherein the unit regions are two-dimensionally arranged in a first direction and a second direction, and
wherein the second structural bodies are provided between the unit regions adjacent in a direction between the first direction and the second direction.

7. The sensor device according to claim 2,
wherein the first structural bodies are provided to be shifted from centers of the unit regions.

8. The sensor device according to claim 2,
wherein the plurality of first structural bodies are two-dimensionally arranged in a first direction and a second direction which are orthogonal to each other, and
wherein the first structural bodies are arranged at equal intervals in both the first direction and the second direction.

9. The sensor device according to claim 1,
wherein the electrode substrate includes a plurality of detection units that are formed in respective intersecting regions between the plurality of first electrodes and the plurality of second electrodes and have a capacity that is variable according to a relative distance to each of the first conductor layer and the second conductor layer.

10. The sensor device according to claim 1, further comprising:
a first frame that is provided between the first conductor layer and the electrode substrate and provided along a circumference of the electrode substrate; and
a second frame that is provided between the second conductor layer and the electrode substrate and provided to face the first frame.

11. The sensor device according to claim 9,
wherein an outer circumference of the detection unit is inside an outer circumference of one of the unit regions, and at least two of the first structural bodies included in the unit region are arranged between the outer circumference of the detection unit and the outer circumference of the unit region.

12. The sensor device according to claim 2,
wherein four of the first structural bodies are included in each unit region.

13. The sensor device according to claim 1,
wherein the electrode substrate is capable of electrostatically detecting a change in a distance to each of the first conductor layer and the second conductor layer.

14. An input device comprising:
an operation member having flexibility;
a conductor layer;
an electrode substrate that is provided between the operation member and the conductor layer and has flexibility;
a plurality of first structural bodies that separate the operation member and the electrode substrate; and
a plurality of second structural bodies that separate the conductor layer and the electrode substrate,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

15. The input device according to claim 14,
wherein the operation member includes a conductor layer that is provided in a surface facing the conductor layer.

16. The input device according to claim 14,
wherein the operation member includes a display unit.

17. The input device according to claim 14,
wherein the operation member includes a plurality of key regions.

18. The input device according to claim 17,
wherein the electrode substrate includes a plurality of detection units that are formed in respective intersecting regions between the plurality of first electrodes and the plurality of second electrodes and have a capacity that is variable according to a relative distance to each of the conductor layer and the operation member.

19. The input device according to claim 18, further comprising:
a control unit configured to generate a signal according to an input operation with respect to each of the plurality of key regions based on a change in electrostatic capacitance of the plurality of detection units.

20. The input device according to claim 17,
wherein the plurality of second structural bodies are provided along a boundary between the plurality of key regions.

21. The input device according to claim 17,
wherein some of the plurality of first structural bodies and the plurality of second structural bodies are provided to overlap in a thickness direction in a boundary between the plurality of key regions.

22. An electronic apparatus comprising:
an operation member having flexibility;
a conductor layer;
an electrode substrate that is provided between the operation member and the conductor layer and has flexibility;
a plurality of first structural bodies that separate the operation member and the electrode substrate;
a plurality of second structural bodies that separate the conductor layer and the electrode substrate; and
a control unit configured to generate a signal according to an input operation with respect to the operation member based on a change in electrostatic capacitance of the electrode substrate,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

23. A sensor device comprising:
a first conductor layer having flexibility;
a second conductor layer that is provided to face the first conductor layer;
an electrode substrate that is provided between the first conductor layer and the second conductor layer and has flexibility;
a plurality of first structural bodies that separate the first conductor layer and the electrode substrate; and
a plurality of second structural bodies that separate the electrode substrate and the second conductor layer,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies are included in each unit region.

24. A sensor device comprising:
a first layer having flexibility;
a second layer;
an electrode substrate that is provided between the first layer and the second layer and has flexibility;
a plurality of first structural bodies that separate the first layer and the electrode substrate; and
a plurality of second structural bodies that separate the electrode substrate and the second layer,
wherein at least one of the first layer and the second layer includes a conductor layer,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

25. The sensor device according to claim 24,
wherein at least two of the first structural bodies are included in each unit region, and
wherein the first layer and the second layer include a conductor layer.

26. An input device comprising:
a first layer that includes an operation member and has flexibility;
a second layer;
an electrode substrate that is provided between the first layer and the second layer and has flexibility;
a plurality of first structural bodies that separate the first layer and the electrode substrate; and
a plurality of second structural bodies that separate the electrode substrate and the second layer,
wherein at least one of the first layer and the second layer includes a conductor layer,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

27. An electronic apparatus comprising:
a first layer that includes an operation member and has flexibility;
a second layer;
an electrode substrate that is provided between the first layer and the second layer and has flexibility;
a plurality of first structural bodies that separate the first layer and the electrode substrate;
a plurality of second structural bodies that separate the second layer and the electrode substrate; and
a control unit configured to generate a signal according to an input operation with respect to the operation member based on a change in electrostatic capacitance of the electrode substrate,
wherein at least one of the first layer and the second layer includes a conductor layer,
wherein the electrode substrate includes a plurality of first electrodes and a plurality of second electrodes that intersect the plurality of first electrodes,
wherein a plurality of unit regions are provided to correspond to respective intersections between the first electrodes and the second electrodes, and
wherein at least two of the first structural bodies and/or at least two of the second structural bodies are included in each unit region.

28. A sensor device comprising:
a first layer having flexibility;
a second layer;
an electrode substrate that is provided between the first layer and the second layer and has flexibility;
a plurality of first structural bodies that separate the first layer and the electrode substrate; and
a plurality of second structural bodies that separate the electrode substrate and the second layer,
wherein at least one of the first layer and the second layer includes a conductor layer,
wherein the electrode substrate includes a plurality of first electrodes having a plurality of first unit electrode bodies and a plurality of second electrodes having a plurality of second unit electrode bodies,
wherein a detection unit is configured as a combination of the first electrode bodies and the second electrode bodies,
wherein a plurality of unit regions are provided to correspond to the detection unit, and
wherein at least two of the first structural bodies and/or at least two of the second structural bodies are included in each unit region.

29. The sensor device according to claim 28,
wherein the first electrode bodies and the second electrode bodies are arranged to face each other.

30. The sensor device according to claim 29,
wherein the plurality of first electrodes and the plurality of second electrodes intersect each other.

31. The sensor device according to claim 28,
wherein the first unit electrode body includes a plurality of first sub-electrodes,
wherein the second unit electrode body includes a plurality of second sub-electrodes, and
wherein the detection unit includes the plurality of first sub-electrodes and the plurality of second sub-electrodes which are alternately arranged on the same plane.
